(19) United States
(12) Patent Application Publication
(10) Pub. No.: US 2006/0286006 A1
(43) Pub. Date: Dec. 21, 2006

(54) Method and apparatus for the treatment of fluid waste streams

(76) Inventors: C. Steven McDaniel, Austin, TX (US); Marvin Z. Woskow, Houston, TX (US); Bernhard Kalis, Houston, TX (US)

Correspondence Address: DAFFER MCDANIEL, LLP, P.O. BOX 684908, AUSTIN, TX, 78768-4908, US

(21) Appl. No.: 11/344,582

(22) Filed: Jan. 30, 2006

Related U.S. Application Data
(60) Provisional application No. 60/648,576, filed on Jun. 21, 2005.

(51) Int. Cl. B01J 16/00

(52) U.S. Cl. 422/129; 435/262.5; 366/241; 422/168

(57) ABSTRACT

This invention relates generally to methods and apparatus for the detoxification of fluid streams, for example, wastewater contaminated with neurotoxins, particularly organophosphorous compounds, and comprises contacting the fluid stream with a bioactive coating. More particularly, the invention relates to chemical reactors for detoxifying fluid streams and also, bioactive coated support components comprising rigid, semi-rigid, or flexible support materials coated with a bioactive coating compriseing dessicated whole cells, whole cell fragments, enzymes, and combinations thereof that are capable of hydrolizing neurotoxic organophosphorous chemical compounds. Organophosphorus hydrolases that are capable of detoxifying organophosphorus compounds that are: chemical weapons agents, in particular, tabun (“GA”), sarin (“GB”), soman (“GD”), cyclosarin, VX, and its isometric analog Russian VX (“VR” or “R-VX”); chemical weapons agent analogs, chemical weapons surrogates; and pesticides are most preferred. The process and apparatus embodiments of the present invention are designed to detoxify organophosphorus compounds continuously, semi-continuously and and in batch operation.

### PRIORITY CLAIM

This application claims benefit to provisional application No. 60/648,576 entitled “Method And Apparatus For The Treatment Of fluid Waste Streams,” filed Jan. 31, 2005 and incorporated herein in its entirety.

### BACKGROUND OF THE INVENTION

1. Field of the Invention

This invention relates generally to processes and apparatus for the detoxification of fluid waste streams, for example, wastewater contaminated with neurotoxins, particularly organophosphorous compounds, comprising a surface coated with a bioactive coating. More particularly, the present invention relates to a bioactive coated support, which comprises a rigid, semi-rigid, or flexible support material that is coated with a bioactive coating. In preferred embodiments the bioactive coating comprises dessicated whole cells, whole cell fragments, enzymes, and combinations thereof that are capable of hydrolizing neurotoxic organophosphorous chemical compounds. In most preferred embodiments the enzymes are organophosphorus hydrolases that are capable of detoxifying organophosphorus compounds that are: chemical weapons agents, in particular, tabun (“GA”), sarin (“GB”), soman (“GD”), cyclosarin, VX, and its isometric analog Russian VX (“VR” or “R-VX”); chemical weapons agent analogs, chemical weapons surrogates; and pesticides. The process and apparatus embodiments of the present invention are designed to detoxify organophosphorus compounds continuously and in batches using commercially available coatings and chemical reaction vessels and reactor designs.

2. Description of the Related Art

Organophosphorus compounds (“organophosphate compounds” or “OP compounds”) and organosulfur (“OS”) compounds are used extensively as insecticides and are highly toxic to many organisms, including humans. OP compounds function as nerve agents. The primary effects of exposure to these agents are very similar, including inhibition of acetylcholinesterase and butyrylcholinesterase, with the subsequent breakdown of the normal operation of the autonomic and central nervous systems (Gallo and Lawryk, 1991).

Over 40 million kilograms of OP pesticides are used in the United States annually (Mulchandani, A. et al., 1999a). The number of people accidentally poisoned by OP pesticides has been estimated to be upwards of 500,000 persons a year (LeJeune, K. E. et al., 1998). Depending on the toxicity to the organism (e.g., humans), repeated, prolonged and/or low-dose exposure to an OP compound can cause neurotoxicity and delayed cholinergic toxicity. High-dose exposure can produces a fatal response (Tuovinen, K. et al., 1994).

Arguably of greater danger to humans, however, is the fact that some of the most toxic OP compounds are used as chemical warfare agents (“CWA”). Chemical warfare agents are classified into G agents, such as GD (“soman”), GB (“sarin”), GF (“cyclosarin”) and GA (“tabun”), and the methyl phosphonothioates, commonly known as V agents, such as VX and Russian VX (“R-VX” or “VR”). The most important CWAs are as follows:
tabun (O-methyl dimethylamidophosphorylcyanide), which is the easiest to manufacture;
sarin (“isopropyl methylphosphonofluoridate”), which is a volatile substance mainly taken up through inhalation;
soman (“pinacolyl methylphosphonofluoridate”), a moderately volatile substance that can be taken up by inhalation or skin contact;
cyclosarin (“cyclohexyl methylphosphonofluoridate”), a substance with low volatility that is taken up through skin contact and inhalation of the substance as a gas or aerosol;
VX (“O-ethyl S-diisopropylaminomethyl methylphosphonothioate”), which can remain on material, equipment and terrain for long periods, such as weeks; and
R-VX [“O-isobutyl S-(2-diethylamino)-methylphosphonothioate, or VR”], an isomeric analog of VX, which can remain on material, equipment and terrain for long periods, such as weeks, and is an especially persistent substance.

All CWAs are colorless liquids with volatility varying from VX to sarin. VX is an involatile oil-like liquid, while sarin is a water-like, easily volatilized liquid. By addition of a thickener (e.g., a variety of carbon polymers), soman or other more volatile agents may be made to be less volatile and more persistent.

The CWAs are extremely toxic and have a rapid effect. Such agents enter the body through any of the following manners: inhalation, direct contact to the skin with a gas or with a contaminated surface, or through ingestion of contaminated food or drink. The poisoning effect takes longer when the agents enter through the skin, but is much faster when they are inhaled because of the rapid diffusion in the blood from the lungs. These toxins are fat-soluble and can penetrate the skin, but take longer to reach the deep blood vessels. Because of this, the first symptoms may not appear for 20-30 minutes after initial contact with a contaminated surface. This increases the danger for personnel entering a contaminated area, because the contamination may not be detected for 30 minutes or more (depending on concentrations) after the contaminated area is entered.

The United States and other countries around the world have begun the difficult and complicated task of destroying their chemical weapon stockpiles. In addition to requirements established by federal law, the US became a signatory to the 1997 UN-Sponsored Chemical Weapons Convention (CWC). The CWC is a multilateral treaty that prohibits the production of chemical weapons and requires the destruction of existing chemical weapons stockpiles. The US is facing a deadline, already extended to the year 2012, to complete the destruction of its chemical weapons stockpile.

The disposal of CWAs is a challenging problem in the United States, Russia, and other nations. Many of these weapons have been stored since World War II and the Cold War and prove sensitive to handling. Because of public opposition to the use of incineration for the destruction of these agents due to the suspected production of undesirable byproducts (e.g. dioxins), Congress and the Chemical Weapons Convention Treaty have mandated that the United States destroy its stockpile of aging chemical warfare agents using alternative methods. The Program Manager for Assembled Chemical Weapons Assessment (PM ACWA) is chartered with the mission to demonstrate viable alternative technologies to “baseline” incineration for the disposal of assembled chemical weapons.

Additionally, disposal of the secondary wastes (e.g., solid wastes—activated carbon filters byproduct of incineration program; contaminated chemical protection garments byproduct of handling, storage, and transportation of chemical weapons; liquid wastes—aqueous mixtures contaminated with CWA are a great concern because the secondary wastes must also be disposed of and the effluent wastes must be treated to meet current Federal EPA and State environmental regulations prior to discharge into the environment.

Incineration and caustic neutralization methods have been used to destroy CWAs however these technologies still pose significant challenges.

Historically, most approaches to chemical agent decontamination have focused on the treatment of surfaces after chemical exposure, whether real or merely suspected, has occurred. There are several current methods of decontamination of surfaces. One method is post-exposure washing with hot water with or without addition of detergents or organic solvents, such as caustic solutions (e.g., DS2, bleach) or foams (e.g., Eco, Sandia, Decon Green). Additional types of methods are anapplication of use of intensive heat and carbon dioxide applied for sustained periods, and incorporation of oxidizing materials (e.g., TiO₂ and porphyrins) into coatings that, when exposed to sustained high levels of UV light, degrade chemical agents (Buchanan, J. H. et al., 1989; Fox, M. A., 1983).

Caustic solutions degrade surfaces, create personnel handling and environmental risks, and require transport and mixing logistics. Additionally, alkaline solutions, such as a bleaching agent, is both relatively slow in chemically degrading VX OPs and can produce decontamination products nearly as toxic as the OP itself (Yang, Y. C. et al., 1990). When VX is treated with hypochlorite bleach slurries, dilute alkalis, or DS2 decontaminating solution it produces VX hydrolysate, which containes water, EMPA (ethylmethylphosphonic acid), MPA (methylphosphonic acid), and EA2192. It must be noted that EA2192 is reported to be almost as toxic as VX itself (intravenous LD₅₀ of 17 mg kg⁻¹ in rabbits compared to 8.4 mg kg⁻¹ for VX itself in the same species by the same route). Under comparable conditions (22° C., pH 13-14), EA2192 has a hydrolysis half-life 3,700 times greater than that of VX. (Yang, Y. C.; et al., Perhydrolysis of nerve agent VX, J. Org. Chem., 1993, 58, 6964-6965). EA2192 is thus a particularly long-lived toxic by-product of VX hydrolysis.

Further, the VX hydrolysate, like all hydrolysates produced using caustic treatments, is very corrosive, typically 13.5 pH and requires extensive further treatment before it is acceptable for discharge into the environment.

While foams may have both non-specific biocidal and chemical decontamination properties, they require transport and mixing logistics, may have personnel handling and environmental risks, and are not effective on sensitive electronic equipment or interior spaces. Decontamination with heat and carbon dioxide presents logistical requirements and does not allow rapid reclamation of equipment. UV-based approaches can be costly and have logistical requirements, including access to UV-generating equipment and power, as well as the production of toxic byproducts of degradation (Yang, Y. C. et al., 1992; Buchanan, J. H. et al., 1989; Fox, M. A., 1983).

Various enzymes have been identified that detoxify OP compounds, such as organophosphorus hydrolase (“OPH”), organophosphorus acid anhydrolase (“OPAA”), and DFPase, which detoxifies O,O-dilsopropyl phosphorofluoridate (“DFP”). A number of civilian (e.g., Texas A&M University, private sector), and military laboratories [e.g., the Army research facilities at Edgewood (SBCCOM)] have worked on enzyme-based detection or decontamination systems for OP compounds. Various approaches taken in such laboratories include dispersion systems or immobilization systems of one or more OP degrading enzymes for use in detection or decontamination of OP compounds, as well as for convenience of handling of the enzyme preparation.

Sensors of OP compounds using an OP compound degrading enzyme have been described primarily for the detection of OP pesticides. OP compound sensors have been described that detect pH changes upon OP compound degradation using recombinant Escherichia coli cells expressing OPH cryoimmobilized in poly(vinyl)alcohol gel spheres (Rainina, E. I. et al., 1996). Endogenously expressed OPH from whole Flavobacterium sp. cells or cell membranes have been described as immobilized to glass membrane using poly(carbamoyl sulfonate) and poly(ethyleneimine) to produce a sensor of pH changes due to OP compound degradation (Gaberlein, S. et al., 2000a). OP compound sensors have been described that detect pH changes upon OP compound degradation using recombinant Escherichia coli cells, expressing OPH cytosolically or at the cell surface, that were fixed behind a polycarbonate membrane (Mulchandani, A. et al., 1998a; Mulchandani, A. et al., 1998b). An OP compound sensor has been described that detects optical changes upon OP compound degradation using recombinant Escherichia coli cells, expressing OPH at the cell surface, that were admixed in low melting point agarose and applied to membrane that was affixed to a fiber optic sensor (Mulchandani, A. et al., 1998c).

An OP compound sensor has been described that detects pH changes upon OP compound degradation using purified OPH chemically cross-linked with bovine serum albumin by glutaraldehyde on an electrode's glass membrane and covered with a dialysis membrane (Mulchandani, P. et al., 1999). Such chemically cross-linked OPH has been placed on a nylon membrane, and the membrane affixed to a fiber optic sensor to detect optical changes upon OP compound degradation (Mulchandani, A. et al., 1999a). Purified OPH has been immobilized by glutaraldehyde to glass-beads having aminopropyl groups in the construction of an OP compound degradation sensor (Mulchandani, P. et al., 2001 a). An OP compound sensor has been described that detects optical changes upon OP compound degradation using recombinant Moraxella sp. cells, expressing OPH at the cell surface, that were admixed in 75% (w/w) graphite powder and 25% (w/w) mineral oil and placed into an electrode cavity (Mulchandani, P. et al., 2001). Purified OPH was attached to silica beads by glutaraldehyde or N-γ-maleimidobutyrylozy succinimide ester linkages, and the beads placed as a layer on a glass slide to construct a sensor (Singh, A. K. et al., 1999). Purified OPH has been labeled with fluorescein isothiocyanate and absorbed to poly(methyl methacrylate) beads that were placed on a nylon membrane to construct a sensor that detects OP compound cleavage by decreased fluorescence (Rogers, K. R. et al., 1999). Purified OPH has been immobilized by placement within a poly(carbamoyl sulfonate) prepolymer that was allowed to polymerize on a heat-sealing film in the construction of a sensor (Gaberlein, S. et al., 2000). A purified fusion protein comprising OPH and a FLAG octapeptide sequence was immobilized to magnetic particles (Wang, J. et al., 2001). Additional sensors using OPH have been described (Mulchandani, A. et al., 2001).

Different OP compound degrading enzyme compositions have been described, primarily for the detoxification of OP pesticides (Chen, W. and Mulchandani, A., 1998; LeJeune, K. E. et al., 1998a). A parathion hydrolase enzyme degrading cell extract has been immobilized onto silica beads and porous glass (Munnecke, D. M., 1979; Munnecke, D. M., 1978). OPH has also been immobilized onto porous glass and silica beads (Caldwell, S. R. and Raushel, F. M., 1991b). Purified OPH has been mixed with fire fighting foams in an attempt to create a readily dispersible decontamination composition (LeJeune, K. E., and Russell, A. J., 1999; LeJeune, K. E. et al., 1998b). Purified OPH has been incorporated into micelles in an OP compound degradation device (Komives, C. et al., 1994). Purified OPH has been encapsulated in a liposome for use in OP compound degradation (Pei, L. et al., 1994; Petrikovics, I. et al., 1999). OPH enzyme supported by glass wool in a biphasic solvent and gas phase reactor for OP compound detoxification has been described (Yang, F. et al., 1995). Purified OPH has also been immobilized onto trityl agarose and nylon (Caldwell, S. R. and Raushel, F. M., 1991 a). Recombinant Escherichia coli cells co-expressing OPH and a surface expressed cellulose-binding domain have been immobilized to cellulose supports (Wang, A. A. et al., 2002). Partly purified OPH, acetylcholinesterase or butyrylcholinesterase has been incorporated into polyurethane foam sponges (Havens, P. L. and Rase, H. F., 1993; Gordon, R. K. et al., 1999). Partly purified or purified OPH has been incorporated into solid polyurethane foam (LeJeune, K. E. and Russell, A. J., 1996; LeJeune, K. E. et al., 1997; LeJeune, K. E. et al., 1999). Recombinant Escherichia coli cells expressing OPH have been immobilized in a poly(vinylalcohol) cryogel (Hong, M. S. et al., 1998; Efremenko, E. N. et al., 2002; Kim, J.-W. et al., 2002). Purified OPH has been immobilized in polyethylene glycol hydrogels (Andreopoulos, F. M. et al., 1999). Recombinant Escherichia coli expressing OPH at the cell surface has been immobilized to polypropylene fabric by absorption of the cells to the fabric (Mulchandani, A. et al., 1999). Purified OPH was immobilized to mesoporous silica by Tris-(methoxy) carboxylethylsilane or Tris-(methoxy)aminopropylsilane (Lei, C. et al., 2002). A fusion protein comprising OPH and a cellulose-binding domain has been immobilized to cellulose supports (Richins, R. D. et al., 2000). Sonicated Escherichia coli cells expressing a fusion protein comprising OPH, a green fluorescent protein, and a polyhistidine sequence as an affinity tag, have been attached to a nickel-iminodiacetic:. acid-agarose bead resin (Wu,. C.-F. et al., 2002). A fusion protein comprising OPH and a, polyhistidine sequence as an affinity tag has been attached to a chitosan film (Chen, T. et al., 2001). A purified fusion protein comprising an elastin-like polypeptide and OPH has shown to reversibly bind to the hydrophobic surface of polystyrene plates at temperatures above 37° C. (Shimazu, M. et al., 2002).

In addition to OPH, other OP compound enzyme compositions have been described. Purified OPAA has been encapsulated in a liposome for use in OP compound degradation (Petrikovics, I. et al., 2000; Petrikovics, I. et al., 2000). Purified OPAA has been mixed with fire fighting foams, detergents, and a skin care lotion in an attempt to create a readily dispersible decontamination composition (Cheng, T. C. et al., 1999). Purified squid-type DFPase has been encapsulated in erythrocytes for use in OP compound degradation (McGuinn, W. D. et al., 1993). Purified squid-type DFPase has been coupled to agarose beads (Hoskin, F. C. G. and Roush, A. H., 1982). Purified squid-type DFPase has also been incorporated into a polyurethane matrix (Drevon, G. F. et al., 2002; Drevon, G. F. et al., 2001; Drevon, G. F. and Russell, A. J., 2000).

US. Patent Publication no. US 2002/0106361 discusses a marine anti-fungal enzyme for use in a marine coating. However, the substrate for the enzyme was incorporated into the marine coating, and the enzyme was in a marine environment as the organism from which it was obtained. Immobilized enzymes in a latex are discussed in the April, 2002 edition of “Emulsion Polymer Technologies,” by the Paint Research Association website http://www.pra.org.uk/publications/emulsion/emulsion highlights-2002.htm.

However, to date, there has been limited success in using these and other approaches to harness the potential of these enzymes in systems that can be readily and cost effectively used in field-based military or civilian applications. Thus, despite the current understanding of the various OP compound degrading compositions and techniques, whether based on caustic chemicals or enzymes, there is a clear and present need for compositions and methods that can readily be used in OP compound degradation. This is particularly true for the detoxification of OP chemical warfare agents. In particular, apparatus, compositions, and methods are needed that will detoxify OP compounds and fluid waste streams that contains OP compounds.

### SUMMARY OF THE INVENTION

This invention relates to: novel processes for the detoxification of organophosphorus compounds (“OP compounds”), including when OP compounds are in a fluid or fluid stream; and novel apparatus for carrying out the processes of the present invention, including chemical reactor systems comprising one or more fluid contacting bioactive surfaces and bioactive support components. “Bioactive” refers to the ability of an enzyme to accelerate a chemical reaction differentiating such activity from a like ability of a composition, and/or a method that does not comprise an enzyme to accelerate a chemical reaction. “Organophosphorus compound” or “OP compound” means a compound comprising a phosphoryl center, and further comprises two or three ester linkages.

An object of the present invention is a reactor for detoxifying a fluid or fluid stream containing an OP compound comprising a surface coated with a bioactive coating. “Reactor” means a device, container, or vessel for conducting a chemical reaction. “Detoxifying” “detoxification,” “detoxify,” “detoxified,” “degradation,” “degrade,” and “degraded” refers to a chemical reaction of a compound that produces a chemical byproduct that is less harmful to the health or survival of a target organism contacted with the chemical product relative to contact with the parent compound. One of skill in the art will recognize that the detoxification (i.e., degradation) of the OP compound will occur through enzymatic hydrolysis. “Hydrolysis” means decomposition of a chemical moiety involving the splitting of a chemical bond and the addition of a hydrogen cation and a hydroxide anion of water. “Hydrolyze” means to subject a a chemical moiety to hydrolysis or to undergo hydrolysis. “Hydrolysate” means the product of a hydrolysis reaction. In other words the detoxified fluid is the hydrolysate of the OP containing fluid that was introduced into the reactor. “Fluid” means a compound, substance, or mixture capable of flowing, includes, but is not limited to, liquids, gases, slurries, supercritical fluids, and mixtures thereof. Prefered fluids are liquids and liquid mixtures. More preferred fluids are aqueous liquids and mixtures.

Preferred reactors are column reactors, packed bed reactors, fluidized bed reactors, tubular reactors, and stirred tank reactors. Additional preferred reactors are batch reactors and continuous reactors. In one aspect, a preferred reactor will have at least a portion of the reactor wall, or other fluid contacting surface, coated with a bioactive coating.

Another object of the present invention is a bioactive support component for use in treating a fluid stream containing an OP compound. A bioactive support component may be constructed by coating a support component with a bioactive coating, an optionally, allowing the bioactive coating to cure. The resulting bioactive support component may be disposed in a reactor suitable for treating a fluid containing an OP compound. The bioactive support component may be any material of construction known in the art that is rigid, semi-rigid, or flexible having a surface to which the boactive coating will adhere. Preferred materials for the support component of a bioactive support component are metal, wood, glass, polymer, or ceramic. A more preferred material for a support component is metal, particularly stainless steel mesh.

A preferred reactor is a column with a portion of the interior of the reactive column, or other fluid contacting surface, coated with a bioactive coating. Alternately, another preferred reactor is a column having disposed inside the column a support component that is coated with a bioactive coating.

Another object of the present invention is a process for detoxifying an organophosphorous compound comprising the step of contacting an organophosphorous compound with a bioactive coating containing an enzyme capable of hydrolyzing the organophosphorus compound. “Enzyme” refers to a molecule that possesses the ability to accelerate a chemical reaction, and comprises one or more chemical moieties typically synthesized in living organisms, including but not limited to, an amino acid, a nucleotide, a polysaccharide or simple sugar, a lipid, or a combination thereof. Organophosphorus hydrolase is an enzyme that has been also refered to in that art as “organophosphate-hydrolyzing enzyme,” “phosphotriesterase,” “PTE,” “organophosphate-degrading enzyme,” “OP anhydrolase,” “OP hydrolase,” “OP thiolesterase,” “organophosphorus triesterase,” “parathion hydrolase,” “paraoxonase,” “DFPase,” “somanase,” “VXase,” and “sarinase.” As used herein, this type of enzyme will be referred to herein as “organophosphorus hydrolase” or “OPH.”

Preffered enzymes are organophosphorus hydrolases that are capable of detoxifying chemical weapons agents, in particular, tabun (“GA”), sarin (“GB”), soman (“GD”), cyclosarin, VX, and its isometric analog Russian VX (“VR” or “R-VX”); chemical weapons agent analogs, chemical weapons surrogates; and pesticides.

Another object of the present invention is a process of treating a fluid stream containing an organophosphorous compound comprising the steps of: applying a bioactive coating to a fluid contacting surface of a reactor; optionally curing the bioactive coating; and contacting the fluid stream with the bioactive coated fluid contacting surface of the reactor for an amount of time sufficient for the organophosphorus compound to detoxify. The detoxified fluid may be collected or processed further.

Another object of the present invention is a process for treating a fluid stream containing an organophosphorus compound comprising the steps of: applying a bioactive coating to support component; optionally allowing the bioactive coating to cure; disposing of the prepared bioactive component in a reactor; and contacting the contaminated fluid stream with the bioactive support component for an amount of time sufficient for the organophosphorus compound to detoxify. The detoxified fluid may be collected or processed further.

### BRIEF DESCRIPTION OF THE DRAWINGS

The invention will be more fully understood and further advantages will become apparent when reference is made to the following detailed description of the invention and the accompanying drawings in which:

FIG. 1 is a simplified view of a column reactor, disposed within the reactor is a bioactive support component;

FIG. 2 is a simplified view of a column reactor, disposed within the reactor is an alternate embodiment of bioactive support component;

FIG. 3 is a simplified view of a column reactor, disposed within the reactor is a multiplicity of bioactive support components that are disposed within a containing member;

FIG. 4 is a simplified view of a column reactor, disposed within the reactor are multiple, segregated layers of bioactive support components, wherein the bioactive support components are random and irregular in shape;

FIG. 5 is a schematic of a pilot scale batch reactor system; wherein the system is capable of delivering controlled flows of fluid from a holding tank to an attached reactor;

FIG. 6 is a detailed drawing of a pilot scale batch reactor system of FIG.5; wherein the system is capable of delivering controlled flows of fluid from a holding tank to an attached reactor;

FIG. 7 is a bar graph demonstrating the hydrolysis of the organophosphorus compound Paraxon in a fluid stream as shown by the increase, as a percentage of concentration, of the corresponding hydrolysis reaction product Para-Nitrophenol;

FIG. 8 is a spectral analysis of a decontaminated effluent, which demonstrates the presence of the hydrolysis reaction product Para-Nitrophenol, as well as, indication that additional organic materials are contained in the effluent.

### DETAILED DESCRIPTION OF THE PREFERRED EMBODIMENTS

One skilled in the art will readily appreciate that the present invention is well adapted to carry out the objects and obtain the ends and advantages mentioned as well as those inherent therein. It should be understood, however, that the enzyme compositions, enzymes, microorganism-based particulate materials, compounds, coatings, paints, films, support materials, reactors, coating applicators, and all methods, procedures, and techniques described herein are presently representative of preferred embodiments. These techniques are intended to be exemplary, are given by way of illustration only, and are not intended as limitations on the scope of the present invention. Other objects, features, and advantages of the present invention will be readily apparent to one skilled in the art from the following detailed description, specific examples, and claims; i.e., various changes, substitutions, other uses, and modifications may be made to the invention disclosed herein without departing from the scope and spirit of the present invention as described and claimed.

As used herein other than the claims, the terms “a, “an, “the,” and “said” mean one or more. As used herein in the claim(s), when used in conjunction with the words “comprises” or “comprising,” the words “a,” “an,” “the,” or “said” may mean one or more than one. As used herein “another” may mean at least a second or more.

As would be known to one of ordinary skill in the art, many variations of nomenclature are commonly used to refer to a specific chemical composition. Accordingly, several common alternative names may be provided herein in quotations and parentheses/brackets, or other grammatical technique, adjacent to a chemical composition's preferred designation when referred to herein. Additionally, many chemical compositions referred to herein are further identified by a Chemical Abstracts Service registration number. As would be known to those of ordinary skill in the art, the Chemical Abstracts Service provides a unique numeric designation, denoted herein as “CAS No.,” for specific chemicals and some chemical mixtures, which unambiguously identifies a chemical composition's molecular structure.

In various embodiments described herein, exemplary values are specified as a range. Examples of such ranges cited herein include, for example, a size of a biomolecule, a temperature for growth and/or preparation of a microorganism, a chemical moiety's content in a coating component, a coating component's content in a coating composition and/or film, a coating component's mass, a glass transition temperature (“T_{g}”), a temperature for a chemical reaction (e.g., film formation, chemical modification of a coating component, hydrolysis of an organophosphorus compound), the thickness of a coating and/or film upon a surface, etc. It will be understood that herein the phrase “including all intermediate ranges and combinations thereof” associated with a given range is all integers and sub-ranges comprised within a cited range. For example, citation of a range “0.03% to 0.07%, including all intermediate ranges and combinations thereof” is specific values within the sited range, such as, for example, 0.03%, 0.04%, 0.05%, 0.06%, and 0.07%, as well as various combinations of such specific values, such as, for example, 0.03%, 0.06% and 0.07%, 0.04% and 0.06%, or 0.05% and 0.07%, as well as sub-ranges such as 0.03% to 0.05%, 0.04% to 0.07%, or 0.04% to 0.06%, etc.

In addition to the sources described herein for biomolecules, reagents, living cells, etc., one of ordinary skill in the art may obtain such materials and/or chemical formulas thereof for use in the present invention from convenient source such as a public database, a biological depository, and/or a commercial vendor. For example, various nucleotide sequences, including those that encode amino acid sequences, may be obtained at a public database, such as the Entrez Nucleotides database found at: http://www.ncbi.nlm.nih.gov/entrez/query.fcgi?db=Nucleotide, which includes sequences from other databases including GenBank, RefSeq, and PDB. In another example, various amino acid sequences may be obtained at a public database, such as the Entrez databank found at: http://www.ncbi.nlm.nih.gov/entrez/query.fcgi?db=Protein, which includes sequences from other databases including SwissProt, PIR, PRF, PDB, GenBank, and RefSeq. Additional examples of such databases are listed at: http://www.rcsb.org/pdb/links.html#Databases, and numerous nucleic acid sequences and/or encoded amino acid sequences can be obtained from such sources. In a further example, biological materials that comprise, or are capable of comprising such biomolecules (including living cells), may be obtained from a depository such as the American Type Culture Collection (“ATCC”), P.O. Box 1549 Manassas, Va. 20108, USA. In an additional example, biomolecules, chemical reagents, biological materials, and equipment may be obtained, as is well known to those of ordinary skill in the art, from commercial vendors such as Amershamn Biosciences®, 800 Centennial Avenue, P.O. Box 1327, Piscataway, N.J. 08855-1327 USA; BD Biosciences®, including Clontech®, Discovery Labware®, Immunocytometry Systems® and Pharmingen®, 1020 East Meadow Circle, Palo Alto, Calif. 94303-4230 USA; Invitrogen™, 1600 Faraday Avenue, PO Box 6482, Carlsbad, Calif. 92008 USA; New England Biolabs®, 32 Tozer Road, Beverly, Mass. 01915-5599 USA; Merck®, One Merck Drive, P.O. Box 100, Whitehouse Station, N.J. 08889-0100 USA; Novagene®, 441 Charmany Dr., Madison, Wis. 53719-1234 USA; Promega®, 2800 Woods Hollow Road, Madison Wis. 53711 USA; Pfizer®, including Pharmacia®, 235 East 42nd Street, New York, N.Y. 10017 USA; Quiagen®, 28159 Avenue Stanford, Valencia, Calif. 91355 USA; Sigma-Aldricho, including Sigma, Aldrich, Fluka, Supelco and Sigma-Aldrich Fine Chemicals, PO Box 14508, Saint Louis, Mo. 63178 USA; Stratagene®, 11011 N. Torrey Pines Road, La Jolla, Calif. 92037 USA, etc.

In addition to those techniques specifically described herein, one of ordinary skill in the art may manipulate a cell, nucleic acid sequence, amino acid sequence, and the like, in light of the present disclosures, using standard techniques known in the art [see, for example, In “Molecular Cloning” (Sambrook, J., and Russell, D. W., Eds.) 3rd Edition, Cold Spring Harbor, N.Y.: Cold Spring Harbor Laboratory Press, 2001; In “Current Protocols in Molecular Biology” (Chanda, V. B. Ed.) John Wiley & Sons, 2002; In “Current Protocols in Nucleic Acid Chemistry” (Harkins, E. W. Ed.) John Wiley & Sons, 2002; In “Current Protocols in Protein Science” (Taylor, G. Ed.) John Wiley & Sons, 2002; In “Current Protocols in Cell Biology” (Morgan, K. Ed.) John Wiley & Sons, 2002; In “Current Protocols in Pharmacology”. (Taylor, G. Ed.) John Wiley & Sons, 2002; In “Current Protocols in Cytometry” (Robinson, J. P. Ed.) John Wiley & Sons, 2002; In “Current Protocols in Immunology” (Coico, R. Ed.) John Wiley & Sons, 2002].

In addition to those techniques specifically described herein, one of ordinary skill in the art may design a suitable chemical reactor system, e.g., batch, semi-continuous, continuous, stirred tank, flow, tube, column, fixed bed, fluidized bed, combinations thereof, and the like, in light of the present disclosures, using standard techniques known in the art (see for example, “Perry's Chemical Engineering Handbook” (Perry, R. H., and Green, D. W., Eds.), 7^{th} Edition, McGraw-Hill, 1997; “Chemical Reactor Design, Optimization, and Scaleup” (Nauman, E. Bruce) McGraw-Hill, 2002.

The methods and apparatus of the present invention utilize the biologically active coatings and coating components (“bioactive coating”) described and claimed in U.S. Publication No. 2004/0109853, entitled “Biological Active Coating Components, Coatings, and Coated Surfaces,” which is a conversion of U.S. provisional application 60/409,102 entitled “Bioactive Protein Paint Additive, Paint, and Painted Various.” The contents of U.S. Publication No. 2004/0109853 are incorporated herein by reference in its entirety for all purposes.

As used herein, a “bioactive coating” of the present invention refers generally to the biologically active coatings described and claimed in U.S. Publication No. 2004/0109853. The present invention contemplates that any of the bioactive coatings as described and claimed therein may be used to achieve the benefits of the present invention. More particularly the: whole cells, cell fragments, and enzymes; method of preparing those whole cells, cell fragments, and enzymes; the bioactive coatings, particularly bioactive paint; method of preparing a bioactive coating; as described and claimed in U.S. Publication No. 2004/0109853 are all facets of the present invention. Without limiting the scope of the present invention, certain aspects of said bioactive coatings, their preparation, and use are discussed in more particular detail below, with reference to the disclosure of U.S. Publication No. 2004/0109853 when appropriate.

The selection of a biomolecule for use in the present invention depends on the desired property that is to be conferred to a composition of the present invention. A preferred biomolecule of the present invention comprises an enzyme, as enzymatic activity is a preferred property to be conferred to a biomolecule composition, coating and/or paint in the present invention. As used herein, the term “enzyme” refers to a molecule that possesses the ability to accelerate a chemical reaction, and comprises one or more chemical moieties typically synthesized in living organisms, including but not limited to, an amino acid, a nucleotide, a polysaccharide or simple sugar, a lipid, or a combination thereof. As used herein, the term “bioactive” refers to the ability of an enzyme to accelerate a chemical reaction differentiating such activity from a like ability of a composition, and/or a method that does not comprise an enzyme to accelerate a chemical reaction.

In preferred embodiments, an enzyme comprises a proteinaceous molecule. It is contemplated that any proteinaceous molecule that functions as an enzyme, whether identical to the wild-type amino acid sequence encoded by an isolated gene, a functional equivalent of such a sequence, or a combination thereof, may be used in the present invention. As used herein, a “wild-type enzyme” refers to an amino acid sequence that functions as an enzyme and is identical to the sequence encoded by an isolated gene from a natural source. As used herein, a “functional equivalent” to the wild-type enzyme is a proteinaceous molecule comprising a sequence and/or a structural analog of a wild-type enzyme's sequence and/or structure and functions as an enzyme. The functional equivalent enzyme may possess similar or the same enzymatic properties, such as catalyzing chemical reactions of the wild-type enzyme's EC classification, or may possess other desired enzymatic properties, such as catalyzing the desirable chemical reactions of an enzyme that is related to the wild-type enzyme by sequence and/or structure. Examples of a functional equivalent of a wild-type enzyme are described herein, and include mutations to a wild-type enzyme sequence, such as a sequence truncation, an amino acid substitution, an amino acid modification, a fusion protein, or a combination thereof, wherein the altered sequence functions as an enzyme.

In certain embodiments, an enzyme may comprise a simple enzyme, a complex enzyme, or a combination thereof. As known herein, a “simple enzyme” is an enzyme wherein the chemical properties of moieties found in its amino acid sequence is sufficient for producing enzymatic activity. As known herein, a “complex enzyme” is an enzyme whose catalytic activity functions only when an apo-enzyme is combined with a prosthetic group, a co-factor, or a combination thereof. An “apo-enzyme” is a proteinaceous molecule and is catalytically inactive without the prosthetic group and/or co-factor. As known herein, a “prosthetic group” or “co-enzyme” is non-proteinaceous molecule that is attached to the apo-enzyme to produce a catalytically active complex enzyme. As known herein, a “holo-enzyme” is a complex enzyme that comprises an apo-enzyme and a co-enzyme. As known herein, a “co-factor” is a molecule that acts in combination with the apo-enzyme to produce a catalytically active complex enzyme. In some aspects, a prosthetic group is one or more bound metal atoms, a vitamin derivative, or a combination thereof. Examples of metal atoms that may be used as a prosthetic group and/or a co-factor include Ca, Cd, Co, Cu, Fe, Mg, Mn, Ni, Zn, or a combination thereof. Usually the metal atom is an ion, such as Ca²⁺, Cd²⁺, Co²⁺, Cu²⁺, Fe⁺², Mg²⁺, Mn²⁺, Ni²⁺, Zn²⁺, or a combination thereof. As known herein, a “metalloenzyme” is a complex enzyme that comprises an apo-enzyme and a prosthetic group, wherein the prosthetic group comprises a metal atom. As known herein, a “metal activated enzyme” is a complex enzyme that comprises an apo-enzyme and a co-factor, wherein the co-factor comprises a metal atom.

A chemical that binds a proteinaceous molecule is known herein as a “ligand.” As used herein, “bind” or “binding” refers to a physical contact between the proteinaceous molecule at a specific region of the proteinaceous molecule and the ligand in a reversible fashion. Examples of binding interactions are well known in the art, and include such interactions as a ligand known as an “antigen” binding an antibody, a ligand binding a receptor, and the like. A portion of the proteinaceous molecule wherein substrate binding occurs is known herein as a “binding site.” A ligand that is acted upon by the enzyme in the accelerated chemical reaction is known herein as a “substrate.” A contact between the enzyme and a substrate in a fashion suitable for the accelerated chemical reaction to proceed is known herein as “substrate binding.” A portion of the enzyme involved in the chemical interactions that contributed to the accelerated chemical reaction is known herein as an “active site.”

A chemical that slows or prevents the enzyme from conducting the accelerated chemical reaction is known herein as an “inhibitor.” A contact between the enzyme and the inhibitor in a fashion suitable for slowing or preventing the accelerated chemical reaction to proceed upon a target substrate is known herein as “inhibitor binding.” In some embodiments, inhibitor binding occurs at a binding site, an active site, or a combination thereof. In some aspects, an inhibitor's binding occurs without the inhibitor undergoing the chemical reaction. In specific aspects, the inhibitor may also be a substrate such as in the case of an inhibitor that precludes the enzyme from catalyzing the chemical reaction of a target substrate for the period of time inhibitor binding occurs at an active and/or binding site. In other aspects, an inhibitor undergoes the chemical reaction at a rate that is slower relative to a target substrate.

In some embodiments, enzymes may be described by the classification system of The International Union of Biochemistry and Molecular Biology (“IUBMB”). The IUBMB classifies enzymes by the type of reaction catalyzed and enumerates each sub-class by a designated enzyme commission number (“EC”). The IUBMB classification of various enzymes may be obtained using the computerized database at http://www.chem.qmw.ac.uk/iubmb/enzyme/. Based on these broad categories, an enzyme may comprise an oxidoreductase (EC 1), a transferase (EC 2), a hydrolase (EC 3), a lyase (EC 4), an isomerase (EC 5), a ligase (EC 6), or a combination thereof. Often, an enzyme may be able to catalyze multiple reactions, and thus have multiple EC classifications.

Generally, the chemical reaction catalyzed by an enzyme alters a moiety of a substrate. As used herein, a “moiety” or “group,” in the context of the field of chemistry, refers to a chemical sub-structure that is a part of a larger molecule. Examples of moiety include an acid halide, an acid anhydride, an alcohol, an aldehyde, an alkane, an alkene, an alkyl halide, an alkyne, an amide, an amine, an arene, an aryl halide, a carboxylic acid, an ester, an ether, a ketone, a nitrile, a phenol, a sulfide, a sulfonic acid, a thiol, etc.

An oxidoreductase catalyzes an oxido-reduction of a substrate, wherein the substrate is either a hydrogen donor and/or an electron donor. An oxidoreductase is generally classified by the substrate moiety that is the donor or acceptor. Examples of oxidoreductases include an oxidoreductase that acts on a donor CH—OH moiety, (EC 1.1); an donor aldehyde or a donor oxo moiety, (EC 1.2); a donor CH—CH moiety, (EC 1.3); a donor CH—NH₂ moiety, (EC 1.4); a donor CH—NH moiety, (EC 1.5); a donor nicotinamide adenine dinucleotide (“NADH”) or a donor nicotinamide adenine dinucleotide phosphate (“NADPH”), (EC 1.6); a donor nitrogenous compound, (EC 1.7); a donor sulfur moiety, (EC 1.8); a donor heme moiety, (EC 1.9); a donor diphenol or a related moiety as donor, (EC 1.10); a peroxide as an acceptor, (EC 1.11); a donor hydrogen, (EC 1.12); a single donor with incorporation of molecular oxygen (“oxygenase”), (EC 1.13); a paired donor, with incorporation or reduction of molecular oxygen, (EC 1.14); a superoxide radical as an acceptor, (EC 1.15); an oxidoreductase that oxidises a metal ion, (EC 1.16); an oxidoreductase that acts on a donor CH₂ moiety, (EC 1.17); a donor iron-sulfur protein, (EC 1.18); a donor reduced flavodoxin, (EC 1.19); a donor phosphorus or donor arsenic moiety, (EC 1.20); an oxidoreductase that acts on an X—H and an Y—H to form an X—Y bond, (EC 1.21); as well as a other oxidoreductase, (EC 1.97); or a combination thereof.

A transferase catalyzes the transfer of a moiety from a donor compound to an acceptor compound. A transferase is generally classified based on the chemical moiety transferred. Examples of transferases include an transferase that catalyzes the transfer of a one-carbon moiety, (EC 2.1); an aldehyde or a ketonic moiety, (EC 2.2); an acyl moiety, (EC 2.3); a glycosyl moiety, (EC 2.4); an alkyl or an aryl moiety other than a methyl moiety, (EC 2.5); a nitrogenous moiety, (EC 2.6); a phosphorus-containing moiety, (EC 2.7); a sulfur-containing moiety, (EC 2.8); a selenium-containing moiety, (EC 2.9); or a combination thereof.

A hydrolase catalyses the hydrolysis of a chemical bond. A hydrolase is generally classified based on the chemical bond cleaved or the moiety released or transferred by the hydrolysis reaction. Examples of hydrolases include a hydrolase that catalyzes the hydrolysis of an ester bond, (EC 3.1); a glycosyl released/transferred moiety, (EC 3.2); an ether bond, (EC 3.3); a peptide bond, (EC 3.4); a carbon-nitrogen bond, other than a peptide bond, (EC 3.5); an acid anhydride, (EC 3.6); a carbon-carbon bond, (EC 3.7); a halide bond, (EC 3.8); a phosphorus-nitrogen bond, (EC 3.9); a sulfur-nitrogen bond, (EC 3.10); a carbon-phosphorus bond, (EC 3.11); a sulfur-sulfur bond, (EC 3.12); a carbon-sulfur bond, (EC 3.13); or a combination thereof.

A lyase catalyzes the cleavage of a chemical bond by reactions other than hydrolysis or oxidation. A lyase is generally classified based on the chemical bond cleaved. Examples of lyases include a lyase that catalyzes the cleavage of a carbon-carbon bond, (EC 4.1); a carbon-oxygen bond, (EC 4.2); a carbon-nitrogen bond, (EC 4.3); a carbon-sulfur bond, (EC 4.4); a carbon-halide bond, (EC 4.5); a phosphorus-oxygen bond, (EC 4.6); a other lyase, (EC 4.99); or a combination thereof.

An isomerase catalyzes a change within one molecule. Examples of isomerases include a racemase or an epimerase, (EC 5.1); a cis-trans-isomerases, (EC 5.2); an intramolecular isomerase, (EC 5.3); an intramolecular transferase, (EC 5.4); an intramolecular lyase, (EC 5.5); a other isomerases, (EC 5.99); or a combination thereof.

A ligase catalyses the formation of a chemical bond between two substrates with the hydrolysis of a diphosphate bond of a triphosphate such as ATP. A ligase is generally classified based on the chemical bond created. Examples of lyases include a ligase that form a carbon-oxygen bond, (EC 6.1); a carbon-sulfur bond, (EC 6.2); a carbon-nitrogen bond, (EC 6.3); a carbon-carbon bond, (EC 6.4); a phosphoric ester bond, (EC 6.5); or a combination thereof.

A preferred enzyme for use in the present invention comprises a hydrolase. A preferred hydrolase comprises an esterase. A preferred esterase comprises an esterase that catalyzes the hydrolysis of an organophosphorus compound. Examples of such preferred esterases are those identified by enzyme commission number EC 3.1.8, the phosphoric triester hydrolases. As used herein, a phosphoric triester hydrolase catalyzes the hydrolytic cleavage of an ester from a phosphorus moiety. Examples of a phosphoric triester hydrolase include an aryldialkylphosphatase, a diisopropyl-fluorophosphatase, or a combination thereof.

An aryldialkylphosphatase (EC 3.1.8.1) is also known by its systemic name “aryltriphosphate dialkylphosphohydrolase,” and various enzymes in this category have been known in the art by names such as “organophosphate hydrolase”; “paraoxonase”; “A-esterase”; “aryltriphosphatase”; “organophosphate esterase”; “esterase B1”; “esterase E4”; “paraoxon esterase”; “pirimiphos-methyloxon esterase”; “OPA anhydrase”; “organophosphorus hydrolase”; “phosphotriesterase”; “PTE”; “paraoxon hydrolase”; “OPH”; and “organophosphorus acid anhydrase.” An aryldialkylphosphatase catalyzes the following reaction: aryl dialkyl phosphate+H₂O=an aryl alcohol+dialkyl phosphate. Examples of an aryl dialkyl phosphate include an organophosphorus compound comprising a phosphonic acid ester, a phosphinic acid ester, or a combination thereof.

A diisopropyl-fluorophosphatase (EC 3.1.8.2) is also known by its systemic name “diisopropyl-fluorophosphate fluorohydrolase,” and various enzymes in this category have been known in the art by names such as “DFPase”; “tabunase”; “somanase”; “organophosphorus acid anhydrolase”; “organophosphate acid anhydrase”; “OPA anhydrase”; “diisopropylphosphofluoridase”; “dialkylfluorophosphatase”; “diisopropyl phosphorofluoridate hydrolase”; “isopropylphosphorofluoridase”; and “diisopropylfluorophosphonate dehalogenase.” A diisopropyl-fluorophosphatase catalyzes the following reaction: diisopropyl fluorophosphate+H₂O=fluoride+diisopropyl phosphate. Examples of a diisopropyl fluorophosphates include an organophosphorus compound comprising a phosphorus-halide, a phosphorus-cyanide, or a combination thereof.

Examples of phosphoric triester hydrolases and cleaved OP compounds and bond types are shown at Table 1.

TABLE 1
Phosphoric Triester Hydrolases

| | OP Compound Phosphoryl Bond-Type and | | | | |
|---|---|---|---|---|---|
| | Phosphoryl Bond Types Cleaved by Enzyme | | | | |
| | | Various OP | Sarin, | VX, | |
| | | Pesticides | Soman | R—VX | Tabun |
| Enzyme | P—C | P—O | P—F | P—S | P—CN |
| OPH^{a,b,c,d,e,f,g} | − | + | + | + | + |
| Human | + | + | + | − | + |
| Paraoxonase^{h,i,j} | | | | | |
| OPAA-2^{k,l} | − | + | + | − | + |
| Squid DFPase^{m} | − | − | + | − | − |

^{a}Dumas, D. P. et al., 1989a;
^{b}Dumas, D. P. et al., 1989b;
^{c}Dumas, D. P. et al., 1990;
^{d}Dave, K. I. et al., 1993;
^{e}Chae, M. Y. et al., 1994;
^{f}Lai, K. et al., 1995;
^{g}Kolakowski, J. E. et al., 1997;
^{h}Hassett, C. et al., 1991;
ⁱJosse, D. et al., 2001;
^{j}Josse, D. et al., 1999;
^{k}DeFrank, J. J. et al. 1993;
^{l}Cheng, T. -C. et al., 1996;
^{m}Hoskin, F. C. G. and Roush, A. H., 1982.

A preferred substrate for a composition of the present invention comprises an organophosphorus compound. As used herein, an “organophosphorus compound” is a compound comprising a phosphoryl center, and further comprises two or three ester linkages. In some aspects, the type of phosphoester bond and/or additional covalent bond at the phosphoryl center classifies an organophosphorus compound. In embodiments wherein the phosphorus is linked to an oxygen by a double bond (P═O), the OP compound is known as an “oxon OP compound” or “oxon organophosphorus compound.” In embodiments wherein the phosphorus is linked to a sulfur by a double bond (P═S), the OP compound is known as a “thion OP compound” or “thion organophosphorus compound.” Additional examples of bond-type classified OP compounds include a phosphonocyanate, which comprises a P—CN bond; a phosphoroamidate, which comprises a P—N bond; a phosphotriester, which comprises a P—O bond; a phosphodiester, which comprises a P—O bond; a phosphonofluoridate, which comprises a P—F bond; and a phosphonothiolate, which comprises a P—S bond. A “dimethyl OP compound” comprises two methyl moieties covalently bonded to the phosphorus atom, such as, for example, malathion. A “diethyl OP compound” comprises two ethoxy moieties covalently bonded to the phosphorus atom, such as, for example, diazinon.

In general embodiments, an OP compound comprises an organophosphorus nerve agent or an organophosphorus pesticide. As used herein, a “nerve agent” is an inhibitor of a cholinesterase, including but not limited to, an acetyl cholinesterase, a butyl cholinesterase, or a combination thereof. The toxicity of an OP compound depends on the rate of release of its phosphoryl center (e.g., P—C, P—O, P—F, P—S, P—CN) from the target enzyme (Millard, C. B. et al., 1999). Preferred nerve agents are inhibitors of a cholinesterase (e.g., acetyl cholinesterase) whose catalytic activity is often critical for health and survival in animals, including humans.

Certain OP compounds are so toxic to humans that they have been adapted for use as chemical warfare agents, such as tabun, soman, sarin, cyclosarin, VX, and R-VX. A CWA may be in airborne form and such a formulation is known herein as an “OP-nerve gas.” Examples of airborne forms include a gas, a vapor, an aerosol, a dust, or a combination thereof. Examples of an OP compounds that may be formulated as an OP nerve gas include tabun, sarin, soman, VX, GX, or a combination thereof.

In addition to the initial inhalation route of exposure common to such agents, CWAs, especially persistent agents such as VX and thickened soman, pose threats through dermal absorption [In “Chemical Warfare Agents: Toxicity at Low Levels,” (Satu M. Somani and James A. Romano, Jr., Eds.) p. 414, 2001]. As used herein, a “persistent agent” is a CWA formulated to be non-volatile and thus remain as a solid or liquid while exposed to the open air for more than three hours. Often after release, a persistent agent may convert from an airborne dispersal form to a solid or liquid residue on a surface, thus providing the opportunity to contact the skin of a human. The toxicities for common OP chemical warfare agents after contact with skin are shown at Table 2.

TABLE 2
LD₅₀ Values* of Common Organophosphorus Chemical
Warfare Agents

| Common OP | Estimated human LD₅₀ - | |
|---|---|---|
| CWA | percutaneous (skin) administration | |
| Tabun | 1000 | milligrams (“mg”) |
| Sarin | 1700 | mg |
| Soman | 100 | mg |
| VX | 10 | mg |

*LD₅₀ - the dose need to kill 50% of individuals in a population after administration, wherein the individuals weigh approximately 70 kg.

In some embodiments, an OP compound may be a particularly poisonous organophosphorus nerve agent. As used herein, a “particularly poisonous” agent is a composition with a LD₅₀ of 35 mg/kg or less for an organism after percutaneous (“skin”) administration of the agent. Examples of a particularly poisonous OP nerve agent include tabun, sarin, cyclosarin, soman, VX, R-VX, or a combination thereof.

As used herein, “detoxification,” “detoxify,” “detoxified,” “degradation,” “degrade,” and “degraded” refers to a chemical reaction of a compound that produces a chemical byproduct that is less harmful to the health or survival of a target organism contacted with the chemical product relative to contact with the parent compound. OP compounds may be detoxified using chemical hydrolysis or through enzymatic hydrolysis (Yang, Y.-C. et al., 1992; Yang, Y.-C. et al., 1996; Yang, Y.-C. et al., 1990; LeJeune, K. E. et al., 1998a). In general embodiments, the enzymatic hydrolysis is a specifically targeted reaction wherein the OP compound is cleaved at the phosphoryl center's chemical bond resulting in predictable byproducts that are acidic in nature but benign from a neurotoxicity perspective (Kolakowski, J. E. et al., 1997; Rastogi, V. K. et al., 1997; Dumas, D. P. et al., 1990; Raveh, L. et al., 1992). By comparison, chemical hydrolysis can be much less specific, and in the case of VX may produce some quantity of byproducts that approach the toxicity of the intact agent (Yang, Y.-C. et al., 1996; Yang, Y.-C. et al., 1990). In preferred facets, an enzyme composition of the present invention degrades a CWA, a particularly poisonous organophosphorus nerve agent, or a combination thereof into byproduct that is not particularly poisonous.

Many OP compounds are pesticides that are not particularly poisonous to humans, though they do possess varying degrees of toxicity to humans and other animals. Examples of an OP pesticide include bromophos-ethyl, chlorpyrifos, chlorfenvinphos, chlorothiophos, chlorpyrifos-methyl, coumaphos, crotoxyphos, crufomate, cyanophos, diazinon, dichlofenthion, dichlorvos, dursban, EPN, ethoprop, ethyl-parathion, etrimifos, famphur, fensulfothion, fenthion, fenthrothion, isofenphos, jodfenphos, leptophos-oxon, malathion, methyl-parathion, mevinphos, paraoxon, parathion, parathion-methyl, pirimiphos-ethyl, pirimiphos-methyl, pyrazophos, quinalphos, ronnel, sulfopros, sulfotepp, trichloronate, or a combination thereof. In some embodiments, a composition of the present invention degrades a pesticide into a byproduct that is less toxic to an organism. In specific aspects, the organism is an animal, such as a human.

Organophosphorus hydrolase (E.C.3.1.8.1) has been also refered to in that art as “organophosphate-hydrolyzing enzyme,” “phosphotriesterase,” “PTE,” “organophosphate-degrading enzyme,” “OP anhydrolase,” “OP hydrolase,” “OP thiolesterase,” “organophosphorus triesterase,” “parathion hydrolase,” “paraoxonase,” “DFPase,” “somanase,” “VXase,” and “sarinase.” As used herein, this type of enzyme will be referred to herein as “organophosphorus hydrolase” or “OPH.”

The initial discovery of OPH was from two bacterial strains from the closely related genera: Pseudomonas diminuta and Flavobacterium spp. (McDaniel, S. et al., 1988; Harper, L. et al., 1988), which encoded identical organophosphorus degrading opd genes on large plasmids (Genbank accession no. M20392 and Genbank accession no. M22863) (copending U.S. patent application Ser. No. 07/898,973, incorporated herein in its entirety by reference). It is likely that Pseudomonas diminuta was derived from the Flavobacterium spp. Subsequently, other such OPH encoding genes have been discovered. The use of any opd gene or their gene product in the described compositions and methods is contemplated. Examples of opd genes and gene products that may be used include the Agrobacterium radiobacter P230 organophosphate hydrolase gene, opdA (Genbank accession no. AY043245; Entrez databank no. AAK85308); the Flavobacterium balustinum opd gene for parathion hydrolase (Genbank accession no. AJ426431; Entrez databank no. CAD19996); the Pseudomonas diminuta phosphodiesterase opd gene (Genbank accession no. M20392; Entrez databank no. AAA98299; Protein Data Bank entries 1JGM, 1DPM, 1EYW, IEZ2, 1HZY, 110B, 110D, 1PSC and 1PTA); the Flavobacterium sp opd gene (Genbank accession no. M22863; Entrez databank no. AAA24931; ATCC 27551); the Flavobacterium sp. parathion hydrolase opd gene (Genbank accession no. M29593; Entrez databank no. AAA24930; ATCC 27551); or a combination thereof (Home, I. et al., 2002; Somara, S. et al., 2002; McDaniel, C. S. et al., ¹988a; Harper, L. L. et al., 1988; Mulbry, W. W. and Karns, J. S., 1989).

Because OPH possesses the desirable property of cleaving a broad range of OP compounds (Table 1), it is the OP detoxifying enzyme that has been most studied and characterized, with the enzyme obtained from Pseudomonas being the target of focus for most studies. This OPH was initially purified following expression from a recombinant baculoviral vector in insect tissue culture of the Fall Armyworm, Spodoptera frugiperda (Dumas, D. P. et al., 1989b). Purified enzyme preparations have been shown to be able to detoxify via hydrolysis a wide spectrum of structurally related insect and mammalian neurotoxins that function as acetylcholinesterase inhibitors. Of great interest, this detoxification ability included a number of organophosphorofluoridate nerve agents such as sarin and soman. This was the first recombinant DNA construction encoding an enzyme capable of degrading these potent nerve gases. This enzyme was capable of degrading the common organophosphorus insecticide analog (paraoxon) at rates exceeding 2×10⁷ M⁻¹ (mole enzyme)⁻¹, which is equivalent to the most catalytically efficient enzymes observed in nature. The purified enzyme preparations are capable of detoxifying sarin and the less toxic model mammalian neurotoxin O,O-diisopropyl phosphorofluoridate (“DFP”) at the equivalent rates of 50-60 molecules per molecule of enzyme-dimer per second. In addition, the enzyme can hydrolyze soman and VX at approximately 10% and 1% of the rate of sarin, respectively. The breadth of substrate utility (e.g., V agents, sarin, soman, tabun, cycosarin, OP pesticides) and the efficiency for the hydrolysis exceeds the known abilities of other prokaryotic and eukaryotic organophosphorus acid anydrases, and it is clear that this detoxification is due to a single enzyme rather than a family of related, substrate-limited proteins.

The X-ray crystal structure of Pseudomonas OPH has been determined (Benning, M. M. et al., 1994; Benning, M. M. et al., 1995; Vanhooke, J. L. et al., 1996). Each OPH monomer's active site binds two atoms of Zn²⁺; however, OPH is usually prepared wherein Co²⁺ replaces Zn²⁺, which enhances catalytic rates. Examples of the catalytic rates (k_{cat}) and specificities (k_{cat}/Kₘ) for Co²⁺ substituted OPH against various OP compounds are shown at Table 3 below.

TABLE 3
Catalytic Activity of Wild-Type OPH binding Co²⁺

| | |
|---|---|
| k_{cat} (s⁻¹) | k_{cat}/Kₘ (M⁻¹ s⁻¹) |

| | | |
|---|---|---|
| OP Pesticide Substrate | | |
| Paraoxon | 15000^{a} | 1.3 × 10⁸ |
| OP CWA Substrates | | |
| Sarin | 56^{b} | 8 × 10⁴ |
| Soman | 5^{b} | 1 × 10⁴ |
| VX | 0.3^{b} | 7.5 × 10² |
| R-VX | 0.5^{c} | 105 |
| Tabun* | 77^{d} | 7.6 × 10⁵ |

*Wild-type Zn²⁺ OPH was used in obtaining these kinetic parameters;
^{a}diSioudi, B. et al., 1999a;
^{b}Kolakoski, J. E. et al., 1997;
^{c}Rastogi, V. K. et al., 1997;
^{d}Raveh, L. et al., 1992.

The phosphoryl center of OP compounds is chiral, and Pseudomonas OPH preferentially binds and/or cleaves Sₚ enantiomers over Rₚ enantiomers of the chiral phosphorus in various substrates by a ratio of about 10:1 to about 90:1 (Chen-Goodspeed, M. et al., 2001 a; Hong, S. B. and Raushel, F. M., 1999; Hong, S.-B. and Raushel, F. M., 1999). CWAs such as VX, sarin, and soman are usually prepared and used as a mixture of sterioisomers of varying toxicity, with VX and sarin having two enantomers each, with the chiral center around the phosphorus of the cleavable bond. Soman possesses four enantomers, with one chiral center based on the phosphorus and an additional chiral center based on a pinacolyl moeity [In “Chemical Warfare Agents: Toxicity at Low Levels” (Satu M. Somani and James A. Romano, Jr., Eds.) pp 26-29, 2001; Li, W.-S. et al., 2001; Yang, Y. C. et al., 1992; Benshop, H. P. et al., 1988]. The S_{P} enantiomer of sarin is about 10⁴ times faster in inactivating acetylcholinesterase than the R_{P} enantiomer (Benschop, H. P. and De Jong, L. P. A. 1988), while the two Sₚ enantiomers of soman is about 10⁵ times faster in inactivating acetylcholinesterase than the R_{P} enantiomers (Li, W. S. et al., 2001; Benschop, H. P. et al., 1984). Wild-type organophosphorus hydrolase seems to have greater specificity for the less toxic enantiomers of sarin and soman. OPH is about 9-fold faster cleaving an analog of the R_{P} enantiomer of sarin relative to an analog of the S_{P} enantiomer, and about 10-fold faster in cleaving analogs of the R_{c} enantiomers of soman relative to analogs of the S_{c} enantiomers (Li, W. S. et al., 2001).

Human paraoxonase (EC 3.1.8.1), is a calcium dependent protein, and is also known as an “arylesterase” or aryl-7ester hydrolase“(Josse, D. et al., 1999; Vitarius, J. A. and Sultanos, L. G., 1995). Examples of the human paraoxonase (“HPON1”) gene and gene products can be accessed at (Genbank accession no. M63012; Entrez databank no. AAB59538) (Hassett, C. et al., 1991).

It is contemplated that a carboxylase gene isolated from an animal may be used as an organophosphate hydrolase in the present invention. As used herein, a “carboxylase” or “ali-esterase” (EC 3.1.1.1) is an enzyme that hydrolytically cleaves carboxylic esters (e.g., C—O bonds). As is well known to those of ordinary skill in the art, most genes in eukaryatic organisms have multiple alleles which comprise varient nucleotide and/or expressed protein sequences for a particular gene. Certain insect species have been identified with reduced carboxylase activity and enhanced resistance to OP compounds such as malathion or diazinon. Examples of insect species include Plodia interpunctella, Chrysomya putoria, Lucilia cuprina, and Musca domestica. In particular, an allele of a carboxylase gene possessing organophosphate hydrolase (EC 3.1.8.1) activity is thought to be responsible for OP compound resistance. Examples of such carboxylase genes include alleles isolated from Lucilia cuprina (Genbank accession no. U56636; Entrez databank no. AAB67728), Musca domestica (Genbank accession no. AF133341; Entrez databank no. AAD29685), or a combination thereof (Claudianos, C. et al., 1999; Campbell, P. M. et al., 1998; Newcomb, R. D. et al., 1997). Additionally, carboxylases or carbamoyl lyases are useful against the carbamate nerve agents, and are specifically contemplated for use in biomolecule composition of the present invention for use against such agents.

Organophosphorus acid anhydrolases (E.C.3.1.8.2), known as “OPAAs,” have been isolated from microorganisms and identified as enzymes that detoxify OP compounds (Serdar, C. M. and Gibson, D. T., 1985; Mulbry, W. W. et al., 1986; DeFrank, J. J. and Cheng, T. C., 1991). The better-characterized OPAAs have been isolated from Altermonas species, such as Alteromonas sp JD6.5, Alteromonas haloplanklis and Altermonas undina (ATCC 29660) (Cheng, T. C. et al., 1996; Cheng, T. C. et al., 1997; Cheng, T. C. et al., 1999; Cheng, T. C. et al., 1993). Examples of OPAA genes and gene products that may be used include the Alteromonas sp JD6.5 opaA gene, (GeneBank accession no. U29240; Entrez databank no. AAB05590); the Alteromonas haloplanktis prolidase gene (GeneBank accession no. U56398; Entrez databank AAA99824; ATCC 23821); or a combination thereof (Cheng, T. C. et al., 1996; Cheng, T. C. et al., 1997). The wild-type encoded OPAA from Alteromonas sp JD6.5 is 517 amino acids, while the wild-type encoded OPAA from Alteromonas haloplanktis is 440 amino acids (Cheng, T. C. et al., 1996; Cheng, T. C. et al., 1997). The Alteromonas OPAAs accelerates the hydrolysis of phosphotriesters and phosphofluoridates, including cyclosarin, sarin and soman (Table 4).

TABLE 4
Catalytic Activity of Wild-Type OPAAS

| | k_{cat} (s⁻¹) per species OPAA per OP Substrate | | |
|---|---|---|---|
| | A. sp JD6.5 | A. haloplanktis | A. undina |
| OP Compound Substrate | | | |
| DFP | 1650^{a} | 575^{a} | 1239^{a} |
| OP CWA Substrates | | | |
| Sarin | 611^{a} | 257^{a} | 376^{a} |
| Cyclosarin | 1650^{a} | 269^{a} | 1586^{a} |
| Soman | 3145^{a} | 1389^{a} | 2496^{a} |
| Tabun | 85^{a} | 113^{a} | 292^{a} |

^{a}Cheng, T. C. et al., 1999

Similar to OPH, OPAA from Alteromonas sp JD6.5 (“OPAA-2”) has a general binding and cleavage preference up to 112:1 for the Sₚ enantiomers of various p-nitrophenyl phosphotriesters (Hill, C. M. et al., 2000). Additionally, OPAA from Alteromonas sp JD6.5 is over 2 fold faster at cleaving an Sₚ enantiomer of a sarin analog, and over 15-fold faster in cleaving analogs of the R_{c} enantiomers of soman relative to analogs of the S_{c} enantiomers (Hill, C. M. et al., 2001).

Additionally, a prolidase (“imidodipeptidase,” “proline dipeptidase,” “peptidase D,” “g-peptidase”), PepQ and/or aminopeptidase P gene or gene product with OPAA activity, or a functional equivalent thereof may be used in the present invention. OPAAs possess sequence and structural similarity to human prolidase, Escherichia coli aminopeptidase P and Escherichia coli PepQ (Cheng, T. C. et al., 1997; Cheng, T. C. et al., 1996). A prolidase or a PepQ protein (E.C. 3.4.13.9) hydrolyzes a C—N bond of a dipeptide with a prolyl residue at the carboxyl-terminus, and OPAAs are also classified as prolidases. An aminopeptidase P (EC 3.4.11.9) hydrolyzes the C—N amino bond of a proline at the penultimate position from the amino terminus of an amino acid sequence. Partly purified human and porcine prolidase demonstrated the ability to cleave DFP and G-type nerve agents (Cheng, T. C. et. al., 1997). Examples of prolidase genes and gene products include the Mus musculus prolidase gene (GeneBank accession no. D82983; Entrez databank no. BAB11685); the Homo sapien prolidase gene (GeneBank accession no. J04605; Entrez databank AAA60064); the Lactobacillus helveticus prolidase (“PepQ”) gene (GeneBank accession no. AF012084; Entrez databank AAC24966); the Escherichia coli prolidase (“pepQ”) gene (GeneBank accession no. X54687; Entrez databank CAA38501); the Escherichia coli aminopeptidase P (“pepP”) gene (GeneBank accession no. D00398; Entrez databank BAA00299; Protein Data Bank entries 1A16, 1AZ9, 1JAW and 1M35); or a combination thereof (Ishii, T. et al., 1996; Endo, F. et al., 1989; Nakahigashi, K. and Inokuchi, H., 1990; Yoshimoto, T. et al., 1989).

As used herein, a “squid-type DFPase” (EC 3.1.8.2) refers to an enzyme that catalyzes the cleavage of both DFP and soman, and is isolated from organisms of the Loligo genus. Generally, a squid-type DFPase cleaves DFP at a faster rate than soman. Squid-type DFPases include, for example, a DFPase from Loligo vulgaris, Loligo pealei, Loligo opalescens, or a combination thereof (Hoskin, F. C. G. et al., 1984; Hoskin, F. C. G. et al., 1993; Garden, J. M. et al., 1975).

A well-characterized example of a squid-type DFPase includes the DFPase that has been isolated from the optical ganglion of Loligo vulgaris (Hoskin, F. C. G. et al., 1984). This squid-type DFPase cleaves a variety of OP compounds, including DFP, sarin, cyclosarin, soman, and tabun (Hartleib, J. and Ruterjans, H., 2001 a). The gene encoding this squid-type DFP has been isolated, and can be accessed at GeneBank accession no. AX018860 (International patent publication: WO 9943791-A). Further, this enzyme's X-ray crystal structure has been determined (Protein Data Bank entry 1E1A) (Koepke, J. et al., 2002; Scharff, E. I. et al., 2001). This squid-type DFPase binds two Ca²⁺ ions, which are important in catalytic activity and enzyme stability (Hartleib, J. et al., 2001). Both the DFPase from Loligo vulgaris and Loligo pealei are susceptible to proteolytic cleavage into a 26-kDa and 16 kDa fragments, and the fragments from Loligo vulgaris are capable of forming active enzyme when associated together (Hartleib, J. and Ruterjans, H., 2001 a).

As used herein, a “Mazur-type DFPase” (EC 3.1.8.2) refers to an enzyme that catalyzes the cleavage of both DFP and soman. Generally, Mazur-type DFPases cleaves soman at a faster rate than DFP. Examples of a Mazur-type DFPases include the DFPase isolated from mouse liver (Billecke, S. S. et al., 1999), which may be the same as the DFPase known as SMP-30 (Fujita,T. et al., 1996; Billecke, S. S. et al., 1999; Genebank accession no. U28937; Entrez databank AAC52721); a DFPase isolated from rat liver (Little, J. S. et al., 1989); a DFPase isolated from hog kidney; a DFPase isolated from Bacillus stearothermophilus strain OT, a DFPase isolated from Escherichia coli (ATCC25922) (Hoskin, F. C. G. et al., 1993; Hoskin, F.C.G, 1985); or a combination thereof.

It is contemplated that any phosphoric triester hydrolase that is known in the art may be used in preferred embodiments of the present invention. An example of an additional phosphoric triester hydrolase includes the product of the gene, mpd, (GenBank accession number AF338729; Entrez databank AAK14390) isolated from Plesiomonas sp. strain M6 (Zhongli, C. et al., 2001). Other examples include the phosphoric triester hydrolase identified in a Xanthomonas sp. (Tchelet; R. et al., 1993); Tetrahymena (Landis, W. G. et al., 1987); certain plants such as Myriophyllum aquaticum, Spirodela origorrhiza L, Elodea Canadensis and Zea mays (Gao, J. et al., 2000; Edwards, R. and Owen, W. J., 1988); and in hen liver and brain (Diaz-Alejo, N. et al., 1998). Additional, cholinesterases (e.g., an acetyl cholinesterase) with OP degrading activity have been identified in insects resistant OP pesticides (see, for example, Baxter, G. D. et al., 1998; Baxter, G. D. et al., 2002; Rodrigo, L., et al., 1997, Vontas, J. G., et al., 2002; Walsh, S. B., et al., 2001; Zhu, K. Y., et al., 1995), and are contemplate for use a bimolecular composition of the present invention.

It is possible to optimize a proteinaceous molecule with a defined amino acid sequence and/or length for one or more properties. An alteration in a desirable property is possible because such molecules can be manipulated, for example, by chemical modification, as described herein or as would be known to one of ordinary skill in the art, in light of the present disclosures. As used herein “alter” or “alteration” may result in an increase or a decrease in the measured value for a particular property. As used herein a “property,” in the context of an proteinaceous molecule, includes, but is not limited to, a ligand binding property, a catalytic property, a stability property, a property related to environmental safety, or a combination thereof. Examples of a catalytic property that may be altered include a kinetic parameter, such as Kₘ, a catalytic rate (k_{cat}) for a substrate, an enzyme's specificity for a substrate (k_{cat}/Kₘ), or a combination thereof. Examples of a stability property that may be altered include thermal stability, half-life of activity, stability after exposure to a weathering condition, or a combination thereof. Examples of a property related to environmental safety include an alteration in toxicity, antigenicity, biodegradability, or a combination thereof. However, as would be readily apparent to one of ordinary skill in the art, an alteration to increase an enzyme's catalytic rate for a substrate, an enzyme's specificity for a substrate, a proteinaceous molecule's thermal stability, a proteinaceous molecule's half-life of activity, or a proteinaceous molecule's stability after exposure to a weathering condition may be preferred for some applications, while a decrease in toxicity and/or antigenicity for a proteinaceous molecule may be preferred in additional applications. An enzyme comprising a chemical modification that function as an enzyme of the present invention is a “functional equivalent” to, and “in accordance” with, an un-modified enzyme.

It is also understood by those of skill in the art that there is a limit to the number of chemical modifications that can be made to an enzyme of the present invention before a preferred property is undesirably altered. However, in light of the disclosures herein of assays for determining whether a composition possesses one or more desirable properties, including, for example, a preferred enzymatic activity, a stability property, etc., and that which is known in the art regarding such assays, it is well within the ability of one of ordinary skill in the art to determine whether a given chemical modification to an enzyme of the present invention produces a molecule that still possesses a suitable set of properties for use in a particular application. In certain aspects, a functional equivalent enzyme comprising a plurality of different chemical modifications can be produced in accordance with the present invention.

It is particularly contemplated that a functional equivalent enzyme comprising a structural analog and/or sequence analog may possess an enhanced desirable property and/or a reduced undesirable property, in comparison to the enzyme upon which it is based. All such functional equivalent enzymes described herein, or as would be known to one of ordinary skill in the art in light of the present disclosures, are considered part of the present invention. As used herein, a “structural analog” refers to one or more chemical modifications to the peptide backbone or non-side chain chemical moieties of a proteinaceous molecule. In certain aspects, a subcomponent of an enzyme such as an apo-enzyme, a prosthetic group, a co-factor, or a combination thereof, may be modified to produce a functional equivalent structural analog. In particular facets, such an enzyme sub-component that does not comprise a proteinaceous molecule may be altered to produce a functional equivalent structural analog of an enzyme when combined with the other sub-components. As used herein, a “sequence analog” refers to one or more chemical modifications to the side chain chemical moieties, also known herein as a “residue” of one or more amino acids that define a proteinaceous molecule's sequence. Often such a “sequence analog” comprises an amino acid substitution, which is generally produced by recombinant expression of a nucleic acid comprising a genetic mutation to produce a mutation in the expressed amino acid sequence.

As used herein, an “amino acid” may be a common or uncommon amino acid. The common amino acids include: alanine (Ala, A); arginine (Arg, R); aspartic acid (a.k.a. aspartate; Asp, D); asparagine (Asn, N); cysteine (Cys, C); glutamic acid (a.k.a. glutamate; Glu, E); glutamine (Gln, Q); glycine (Gly, G); histidine (His, H); isoleucine (Ile, I); leucine (Leu, L); lysine (Lys, K); methionine (Met, M); phenylalanine (Phe, F); proline (Pro, P); serine (Ser, S); threonine (Thr, T); tryptophan (Trp, W); tyrosine (Tyr, Y); and valine (Val, V). Common amino acids are often biologically produced in the biological synthesis of a peptide or a polypeptide. An uncommon amino acid refers to an analog of a common amino acid, as well as a synthetic amino acid whose side chain is chemically unrelated to the side chains of the common amino acids. Various uncommon amino acids are well known to those of ordinary skill in the art though it is contemplated that in general embodiments, an enzyme of the present invention will be biologically produced, and thus lack or possess relatively few uncommon amino acids prior to any subsequent non-mutation based chemical modifications.

As is well known in the art, the side chains of amino acids comprise moieties with specific chemical and physical properties. Certain side chains contribute to a ligand binding property, a catalytic property, a stability property, a property related to environmental safety, or a combination thereof. For example, cysteines can form covalent bonds between different parts of a contiguous amino acid sequence, or between non-contiguous amino acid sequences to confer enhanced stability to a secondary, tertiary or quaternary structure. In an additional example, the presence of hydrophobic or hydrophilic side chains exposed to the outer environment can alter the hydrophobicity or hydrophilicity of part of a proteinaceous sequence such as in the case of a transmembrane domain that is embedded in a lipid layer of a membrane. In another example, hydrophilic side chains may be exposed to the environment surrounding a proteinaceous molecule, which can enhance the overall solubility of a proteinaceous molecule in a polar liquid, such as water or a liquid component of a coating. In a further example, various acidic, basic, hydrophobic, hydrophilic, and/or aromatic side chains present at or near a binding site of a proteinaceous structure can affect the. affinity for a proteinaceous sequence for binding a ligand and/or a substrate, based on the covalent, ionic, Van der Waal forces, hydrogen bond, hydrophilic, hydrophobic, and/or aromatic interactions at a binding site. Such interactions by residues at or near an active site also contribute to a chemical reaction that occurs at the active site of an enzyme to produce enzymatic activity upon a substrate. As used herein, a residue is “at or near” another residue or group of residues when it is within 15 Å, 14 Å, 13 Å, 12 Å, 11 Å, 10 Å, 9 Å, 8 Å, 7 Å, 6 Å, 5 Å, 4 Å, 3 Å, 2 Å, or 1 Å of the residue or group of residues, such as residues identified as contributing to the active site and/or binding site.

Identification of an amino acid whose chemical modification would likely change a desirable property of a proteinaceous molecule can be accomplished using such methods as a chemical reaction, mutation, X-ray crystallography, nuclear magnetic resonance (“NMR”), computer based modeling or a combination thereof. Selection of an amino acid on the basis of such information can then be used in the rational design of a mutant proteinaceous sequence that would possess an altered desired property. Preferred alterations include those that alter enzymatic activity to produce a functional equivalent of an enzyme.

For example, many residues of a proteinaceous molecule that contribute to the properties of a proteinaceous molecule comprise chemically reactive moieties. These residues are often susceptible to chemical reactions that can inhibit their ability to contribute to a desirable property of the proteinaceous molecule. Thus, a chemical reaction can be used to identify one or more amino acids comprised within the proteinaceous molecule that may contribute to a desirable property. The identified amino acids then can be subject to modifications such as amino acid substitutions to produce a functional equivalent. Examples of amino acids that can be so chemically reacted include Arg, which can be reacted with butanedione; Arg and/or Lys, which can be reacted with phenylglyoxal; Asp and/or Glu, which can be reacted with carbodiimide and HCl; Asp and/or Glu, which can be reacted with N-ethyl-5-phenylisoxazolium-3′-sulfonate (“Woodward's reagent K”); Asp and/or Glu, which can be reacted with 1,3-dicyclohexyl carbodiumide; Asp and/or Glu, which can be reacted with 1-ethyl-3-(3-dimethylamino-propyl)carbodiimide (“EDC”); Cys, which can be reacted with p-hydroxy mercuri-benzoate; Cys, which can be reacted with dithiobisnitrobenzoate (“DTNB”); Cys, which can be reacted with iodoacetamide; His, which can be reacted with diethylpyrocarbonate (“DEPC”); His, which can be reacted with diazobenzenesulfonic acid (“DBS”); His, which can be reacted with 3,7-bis(dimethylamino)phenothiazin-5-ium chloride (“methylene blue”); Lys, which can be reacted with dimethylsuberimidate; Lys and/or Arg, which can be reacted with 2,4-dinitrofluorobenzene; Lys and/or Arg, which can be reacted with trinitrobenzene sulfonic acid (“TNBS”); Trp, which can be reacted with 2-hydroxy-5-nitrobenzyl bromide 1 -ethyl-3(3-dimethylaminopropyl); Trp, which can be reacted with 2-acetoxy-5-nitrobenzyl chloride; Trp, which can be reacted with N-bromosucinimide; Tyr, which can be reacted with N-acetylimidazole (“NAI”); or a combination thereof (Hartleib, J. and Rutedjans, H., 2001b; Josse, D. et al., 1999; Josse, D. et al., 2001).

In an additional example, the secondary, tertiary and/or quaternary structure of a proteinaceous molecule may be modeled using techniques known in the art, including X-ray crystallography, nuclear magnetic resonance, computer based modeling, or a combination thereof to aid in the identification of active-site, binding site, and other residues for the design and production of a mutant form of an enzyme (Bugg, C. E. et al., 1993; Cohen, A. A. and Shatzmiller, S. E., 1993; Hruby, V. J., 1993; Moore, G. J., 1994; Dean, P. M., 1994; Wiley, R. A. and Rich, D. H., 1993). The secondary, tertiary and/or quaternary structures of a proteinaceous molecule may be directly determined by techniques such as X-ray crystallography and/or nuclear magnetic resonance to identify amino acids most likely affect one or more desirable properties. Additionally, many primary, secondary, tertiary, and/or quaternary structures of proteinaceous molecules can be obtained using a public computerized database. An example of such a databank that may be used for this purpose is the Protein Data Bank (PDB), which is an international repository of the 3-dimensional structures of many biological macromolecules, and can be accessed at http://www.rcsb.org/pdb/index.html. Additional examples of such databases are listed at: http://www.rcsb.org/pdb/links.html#Databases.

Computer modeling can be used to identify amino acids most likely to affect one or more desirable properties. Often, a structurally related proteinaceous molecule comprises primary, secondary, tertiary and/or quaternary structures that are evolutionarily conserved in the wild-type protein sequences of various organisms. As would be known to those of ordinary skill in the art, the secondary, tertiary and/or quaternary structure of a proteinaceous molecule can be modeled using a computer to overlay the proteinaceous molecule's amino acid sequence, which is also known as the “primary structure,” onto the computer model of a described primary, secondary, tertiary, and/or quaternary structure of another, structurally related proteinaceous molecule. Often the amino acids that may participate in an active site, a binding site, a transmembrane domain, the general hydrophobicity and/or hydrophilicity of a proteinaceous molecule, the general positive and/or negative charge of a proteinaceous molecule, etc, may be identified by such comparative computer modeling.

In embodiments wherein an amino acid of particular interest have been identified using such techniques, functional equivalents may be created using mutations that substitute a different amino acid for the identified amino acid of interest. Examples of substitutions of an amino acid side chain to produce a “functional equivalent” proteinaceous molecule are also known in the art, and may involve a conservative side chain substitution a non-conservative side chain substitution, or a combination thereof, to rationally alter a property of a proteinaceous molecule. Examples of conservative side chain substitutions include, when applicable, replacing an amino acid side chain with one similar in charge (e.g., an arginine, a histidine, a lysine); similar in hydropathic index; similar in hydrophilicity; similar in hydrophobicity; similar in shape (e.g., a phenylalanine, a tryptophan, a tyrosine); similar in size (e.g., an alanine, a glycine, a serine); similar in chemical type (e.g., acidic side chains, aromatic side chains, basic side chains); or a combination thereof. Conversely, when a change to produce a non-conservative substitution is contemplated to alter a property of proteinaceous molecule, and still produce a “functional equivalent” proteinaceous molecule, these guidelines can be used to select an amino acid whose side-chains relatively non-similar in charge, hydropathic index, hydrophilicity, hydrophobicity, shape;-size, chemical type, or a combination thereof. Various amino acids have been given a numeric quantity based on the characteristics of charge and hydrophobicity, called the hydropathic index (Kyte, J. and Doolittle, R. F. 1982), which can be used as a criterion for a substitution. The hydropathic index of the common amino acids are: Arg (−4.5); Lys (−3.9); Asn (−3.5); Asp (−3.5); Gln (−3.5); Glu (−3.5); His (−3.2); Pro (−1.6); Tyr (−1.3); Trp (−0.9); Ser (−0.8); Thr (−0.7); Gly (−0.4); Ala (+1.8); Met (+1.9); Cys (+2.5); Phe (+2.8); Leu (+3.8); Val (4.2); and Ile (+4.5). Additionally, a value has also been given to various amino acids based on hydrophilicity, which can also be used as a criterion for substitution (U.S. Pat. No. 4,554,101). The hydrophilicity values for the common amino acids are: Trp (−3.4); Phe (−2.5); Tyr (−2.3); Ile (−1.8); Leu (−1.8); Val (−1.5); Met (−1.3); Cys (−1.0); Ala (−0.5); His (−0.5); Pro (−0.5±0.1); Thr (−0.4); Gly (0); Asn (+0.2); Gln (+0.2); Ser (+0.3); Asp (+3.0±0.1); Glu (+3.0±0.1); Arg (+3.0); and Lys (+3.0). In aspects wherein an amino acid is being conservatively substituted for an amino acid whose hydropathic index or hydrophilic value is similar, the difference between the respective index and/or value is preferably within ±2, more preferably within ±1, and most preferably within ±0.5. In aspects wherein an amino acid is being non-conservatively substituted for an amino acid whose hydropathic index or hydrophilic value is similar, the difference between the respective index and/or value is preferably greater than ±0.5, more preferably greater than ±0.1, and most preferably greater than ±0.2.

In certain embodiments, a functional equivalent may be produced by a non-mutation based chemical modification to an amino acid, a peptide or a polypeptide. Examples of chemical modifications include, when applicable, a hydroxylation of a proline or a lysine; a phosphorylation of a hydroxyl group of a serine and/or a threonine; a methylation of an alpha-amino group of a lysine, an arginine and/or a histidine (Creighton, T. E., 1983); adding a detectable label such as a fluorescein isothiocyanate compound (“FITC”) to a lysine side chain and/or a terminal amine (Rogers, K. R. et al., 1999); covalent attachment of a poly ethylene glycol (Yang, Z. et al., 1995; Kim, C. et al., 1999; Yang, Z. et al., 1996; Mijs, M. et al., 1994); an acylatylation of an amino acid, particularly at the N-terminus; an amination of an amino acid, particularly at the C-terminus (Greene, T. W. and Wuts, P. G. M. “Productive Groups in Organic Synthesis,” Second Edition, pp. 309-315, John Wiley & Sons, Inc., USA, 1991); a deamidation of an asparagine or a glutamine to an aspartic acid or glutamic acid, respectively; a derivation of an amino acid by a sugar moiety, a lipid, a phosphate, or a famysyl group; an aggregation (e.g., a dimerization) of a plurality of proteinaceous molecules, whether of identical sequence or varying sequences; a cross-linking of a plurality of proteinaceous molecules of the present invention using a cross-linking agent [e.g., a 1,1 -bis(diazoacetyl)-2-phenylethane; a glutaraldehyde; a N-hydroxysuccinimide ester; a 3,3′-dithiobis (succinimidyl-propionate); a bis-N-maleimido-1,8-octane]; an ionization of an amino acid into an acidic, basic or neutral salt form; an oxidation of an amino acid; or a combination thereof of any of the forgoing. Such modifications may produce a desirable alteration in a property of a proteinaceous molecule, as would be known to those of ordinary skill in the art. For example, it is contemplated that a N-terminal glycosylation may enhance a proteinaceous molecule's stability (Powell, M. F. et al., 1993). In an additional example, it is contemplated that substitution of a beta-amino acid isoserine for a serine may enhance the aminopeptidase resistance a proteinaceous molecule (Coller, B. S. et al., 1993).

A proteinaceous molecule for use in the present invention may comprise a proteinaceous molecule longer or shorter than the wild-type amino acid sequences specifically disclosed herein, or that would be known to those of ordinary skill in the art in light of the present disclosure. For example, an enzyme comprising longer or shorter sequences is encompassed as part of the present invention, insofar as it retains enzymatic activity. In some embodiments, a proteinaceous molecule for use in the present invention may comprise one or more peptide and/or polypeptide sequences. In certain embodiments, a modification to a proteinaceous molecule may add and/or subtract one or two amino acids from a peptide and/or polypeptide sequence. In other embodiments, a change to a proteinaceous molecule may add and/or remove one or more peptide and/or polypeptide sequences. Often a peptide or a polypeptide sequence may be added or removed to confer or remove a specific property from the proteinaceous molecule, and numerous examples of such modifications to a proteinaceous molecule are described herein, particularly in reference to fusion proteins. In particular, the native OPH of Pseudomonas diminuta is produced with a short amino acide sequence at its N-terminas that promotes the exportation of the protein through the cell membrane and is later cleaned. Thus, in certain embodiment, this signal sequence amino acide sequence is deleted by genetic modification in the DNA construction placed into Escherichia coli host cells in order to enhance its production.

As used herein, a “peptide” comprises a contiguous molecular sequence from 3 to 100 amino acids in length, including all intermediate ranges and combinations thereof. A sequence of a peptide may be 3 to 100 amino acids in length, including all intermediate ranges and combinations thereof. As used herein a “polypeptide” comprises a contiguous molecular sequence 101 amino acids or greater. Examples of a sequence length of a polypeptide include 101 to 10,000 amino acids, including all intermediate ranges and combinations thereof. As used herein a “protein” is a proteinaceous molecule comprising a contiguous molecular sequence three amino acids or greater in length, matching the length of a biologically produced proteinaceous molecule encoded by the genome of an organism.

It is recognized that removal of one or more amino acids from an enzyme's sequence may reduce or eliminate a detectable, desirable property such asenzymatic activity, and therefore would not be preferred. However, it is further contemplated that a longer sequence, particularly a proteinaceous molecule that consecutively or non-consecutively comprises or even repeats one or more enzymatic sequences disclosed herein, or as would be known to those of ordinary skill in the art in light of the present disclosure, would be encompassed within the present invention. Additionally, fusion proteins may be bioengineered to comprise a wild-type sequence and/or a functional equivalent of an enzyme sequence and an additional peptide or polypeptide sequence that confers a desirable property and/or function.

Using recombinant DNA technology, wild-type and mutant forms of the opd gene have been expressed, predominantly in Escherichia coli, for further characterization and analysis. Unless otherwise noted, the various OPH enzymes, whether wild-type or mutants, that act as functional equivalents were prepared using the OPH genes and encoded enzymes first isolated from Pseudomonas diminuta and Flavobacterium spp.

OPH normally binds two atoms of Zn²⁺ per monomer when endogenously expressed. While binding Zn²⁺, this enzyme is one of the most stable dimeric enzymes known, with a thermal temperature of melting (“Tₘ”) of approximately 75° C. and a conformational stability of approximately 40 killocalorie per mole (“kcal/mol”) (Grimsley, J. K. et al., 1997). However, structural analogs have been made wherein Co²⁺, Fe²⁺, Cu²⁺, Mn²⁺, Cd²⁺, or Ni²⁺ are bound instead to produce enzymes with altered stability and rates of activity (Omburo, G. A. et al., 1992). For example, Co²⁺ substituted OPH does possess a reduced conformational stability (˜22 kcal/mol). But this reduction in thermal stability is offset by the superior catalytic activity of Co²⁺ substituted OPH in degrading various OP compounds. For example, five-fold or greater rates of detoxification of sarin, soman, and VX were measured for Co²⁺ substituted OPH relative to OPH binding Zn²⁺ (Kolakoski, J. E. et al., 1997). It is contemplated that structural analogs of an OPH sequence may be prepared comprising a Zn²⁺, Co²⁺, Fe²⁺, Cu²⁺, Mn²⁺, Cd²⁺, Ni²⁺, or a combination thereof. Generally, changes in the bound metal can be achieved by using cell growth media during cell expression of the enzyme wherein the concentration of a metal present is defined, and/or removing the bound metal with a chelator (e.g., 1,10-phenanthroline; 8-hydroxyquinoline-5-sulfphonic acid; ethylene-diaminetetraacetic acid) to produce an apo-enzyme, followed by reconstitution of a catalytically active enzyme by contact with a selected metal (Omburo, G. A. et al., 1992; Watkins, L. M. et al., 1997a; Watkins, L. M. et al., 1997b). It is further contemplated that structural analogs of an OPH sequence may be prepared to comprise only one metal atom per monomer.

In an additional example, OPH structure analysis has been conducted using NMR (Omburo, G. A. et al., 1993). In a further example, the X-ray crystal structure for OPH has been determined (Benning, M. M. et al., 1994; Benning, M. M. et al., 1995; Vanhooke, J. L. et al., 1996), including the structure of the enzyme while binding a substrate, further identifying residues involved in substrate binding and catalytic activity (Benning, M. M. et al., 2000). From these structure evaluations, the amino acids His55, His57, His201, His230, Asp301, and the carbamylated lysine, Lys169, have been identified as coordinating the binding of the active site metal. Additionally, the positively charged amino acids His55, His57, His201, His230, His254, and His257 are counter-balanced by the negatively charged amino acids Asp232, Asp233, Asp235, Asp 253, Asp301, and the carbamylated lysine Lys169 at the active site area. A water molecule and amino acids His55, His57, Lys169, His201, His230, and Asp301 are thought to be involved in direct metal binding. The amino acid Asp301 is thought to aid a nucleophilic attack by a bound hydroxide upon the phosphorus to promote cleavage of an OP compound, while the amino acid His354 may aid the transfer of a proton from the active site to the surrounding liquid in the latter stages of the reaction (Raushel, F. M., 2002). The amino acids His254 and His257 are not thought to be direct metal binding amino acids, but may be residues that interact (e.g., a hydrogen bond, a Van der Waal interaction) with each other and other active site residues, such as residues that directly contact a substrate or bind a metal atom. In particular, amino acid His254 is thought to interact with the amino acids His230, Asp232, Asp233, and Asp301. Amino acid His257 is thought to be a participant in a hydrophobic substrate-binding pocket. The active site pocket comprises various hydrophobic amino acids, Trp131, Phe132, Leu271, Phe306, and Tyr309. These amino acids may aid the binding of hydrophobic OP compounds (Benning, M. M. et al., 1994; Benning, M. M. et al., 1995; Vanhooke, J. L. et al., 1996). Electrostatic interactions may occur between phosphoryl oxygen, when present, and the side chains of Trp 131 and His201. Additionally, the side chains of amino acids Trp 131, Phe132, and Phe306 are thought to be orientated toward the atom of the cleaved substrate's leaving group that was previously bonded to the phosphorus atom (Watkins, L. M. et al., 1997a).

Substrate binding subsites known as the small subsite, the large subsite, and the leaving group subsite have been identified (Benning, M. M. et al., 2000; Benning, M. M. et al., 1994; Benning, M. M. et al., 1995; Vanhooke, J. L. et al., 1996). The amino acids Gly60, Ile106, Leu303, and Ser308 are thought to comprise the small subsite. The amino acids Cys59 and Ser61 are near the small subsite, but with the side chains thought to be orientated away from the subsite. The amino acids His254, His257, Leu271, and Met317 are thought to comprise the large subsite. The amino acids Trp131, Phe132, Phe306, and Tyr309 are thought to comprise the leaving group subsite, though Leu271 is sometimes considered part of this subsite as well (Watkins, L. M. et al., 1997a). Comparison of this opd product with the encoded sequence of the opdA gene from Agrobacterium radiobacter P230 revealed that the large subsite possessed generally larger residues that affected activity, specifically the amino acids Arg254, Tyr257, and Phe271 (Home, I. et al., 2002). Few electrostatic interactions are apparent from the X-ray crystal structure of the inhibitor bound by OPH, and it is thought that hydrophobic interactions and the size of the subsites affect substrate specificity, including steriospecificity for a stereoisomer, such as a specific enantiomer of an OP compound's chiral chemical moiety (Chen-Goodspeed, M. et al., 2001b).

Using the sequence and structural knowledge of OPH, numerous mutants of OPH comprising a sequence analog have been specifically produced to alter one or more properties relative to a substrate's cleavage rate (k_{cat}) and/or specificity (k_{cat}/Kₘ). Examples of OPH sequence analog mutants include H55C, H57C, C59A, G60A, S61A, I106A, I106G, W131A, W131F, W131K, F132A, F132H, F132Y, L136Y, L140Y, H201C, H230C, H254A, H254R, H254S, H257A, H257L, H257Y, L271A, L271Y, L303A, F306A, F306E, F306H, F306K, F306Y, S308A, S308G, Y309A, M317A, M317H, M317K, M317R, H55C/H57C, H55C/H201C, H55C/H230C, H57C/H201C, H57C/H230C, A80V/S365P, I106A/F132A, I106A/S308A, I106G/F132G, I106G/S308G, F132Y/F306H, F132H/F306H, F132H/F306Y, F132Y/F306Y, F132A/S308A, F132G/S308G, L182SN310A, H201C/H230C, H254R/H257L, H55C/H57C/H201 C, H55C/H57C/H230C, H55C/H201 C/H230C, I106A/F 132A/H257Y, I106A/F132A/H257W, I106G/F132G/S308G, L130M/H257Y/1274N, H257Y/I274N/S365P, H55C/H57C/H201 C/H230C, I106G/F132G/H257Y/S308G, or A14T/A80V/L185R/H257Y/1274N (Li, W.-S. et al., 2001; Gopal, S. et al., 2000; Chen-Goodspeed, M. et al., 2001 a; Chen-Goodspeed, M. et al., 2001b; Watkins, L. M. et al., 1997a; Watkins, L. M. et al., 1997b; diSioudi, B. et al., 1999; Cho, C. M.-H. et al., 2002; Shim, H. et al., 1996; Raushel, F. M., 2002; Wu, F. et al., 2000a; diSioudi, B. D. et al., 1999).

For example, the sequence and structural information has been used in production of mutants of OPH possessing cysteine substitutions at the metal binding histidines His55, His57, His201, and His230. OPH mutants H55C, H57C, H201C, H230C, H55C/H57C, H55C/H201C, H55C/H230C, H57C/H201C, H57C/H230C, H201C/H230C, H55C/H57C/H201C, H55C/H57C/H230C, H55C/H201C/H230C, H57C/H201C/H230C, and H55C/H57C/H201C/H230C were produced binding either Zn²⁺; Co²⁺ or Cd²⁺. The H57C mutant had between 50% (i.e., binding Cd²⁺, Zn²⁺) and 200% (i.e., binding Co²⁺) wild-type OPH activity for paraoxon cleavage. The H201 C mutant had about 10% activity, the H230C mutant had less than 1% activity, and the H55C mutant bound only one atom of Co²⁺ and possessed little detectable activity, but may still be useful if possessing a desirable property (e.g., enhanced stability) (Watkins, L. M., 1997b).

In an additional example, the sequence and structural information has been used in production of mutants of OPH possessing altered metal binding and/or bond-type cleavage properties. OPH mutants H254R, H257L, and H254R/H257L have been made to alter amino acids that are thought to interact with nearby metal-binding amino acids. These mutants also reduced the number of metal ions (i.e., Co²⁺, Zn²⁺) binding the enzyme dimer from four to two, while still retaining 5% to greater than 100% catalytic l0 rates for the various substrates. These reduced metal mutants possess enhanced specificity for larger substrates such as NPPMP and demeton-S, and reduced specificity for the smaller substrate diisopropyl fluorophosphonate (diSioudi, B. et al., 1999). In a further example, the H254R mutant and the H257L mutant each demonstrated a greater than four-fold increase in catalytic activity and specificity against VX and its analog demeton S. The H257L mutant also demonstrated a five-fold enhanced specificity against soman and its analog NPPMP,(diSioudi, B. D. et al., 1999).

In an example, specific mutants of OPH (a phosphotriesterase), were designed and produced to aid phosphodiester substrates to bind and be cleaved by OPH. These substrates either comprised a negative charge and/or a large amide moiety. A M317A mutant was created to enlarge the size of the large subsite, and M317H, M317K, and M317R mutants were created to incorporate a cationic group in the active site. The M317A mutant demonstrated a 200-fold cleavage rate enhancement in the presence of alkylamines, which were added to reduce the substrate's negative charge. The M317H, M317K, and M317R mutants demonstrated modest improvements in rate and/or specificity, including a 7-fold kcatIKm improvement for the M317K mutant (Shim, H. et al., 1998).

In a further example, the W131K, F132Y, F132H, F306Y, F306H, F306K, F306E, F132H/F306H, F132Y/F306Y, F132Y/F306H, and F132H/F306Y mutants were made to add or change the side chain of active site residues to form a hydrogen bond and/or donate a hydrogen to a cleaved substrate's leaving group, to enhance the rate of cleavage for certain substrates, such as phosphofluoridates. The F132Y, F132H, F306Y, F306H, F132H/F306H, F132Y/F306Y, F132Y/F306H, and F132H/F306Y mutants all demonstrated enhanced enzymatic cleavage rates, of about three- to ten-fold improvement, against the phosphonofluoridate, diisopropyl fluorophosphonate (Watkins, L. M. et al., 1997a).

In an additional example, OPH mutants W131F, F132Y, L136Y, L140Y, L271Y and H257L were designed to modify the active site size and placement of amino acid side chains to refine the structure of binding subsites to specifically fit the binding of a VX substrate. The refinement of the active site structure produced a 33% increase in cleavage activity against VX in the L136Y mutant (Gopal, S. et al., 2000).

Various mutants of OPH have been made to alter the steriospecificity, and in some cases, the rate of reaction, by substitutions in substrate binding subsites. For example, the C59A, G60A, S61A, 1106A, W131A, F132A, H254A, H257A, L271A, L303A, F306A, S308A, Y309A, and M317A mutants of OPH have been produced to alter the size of various amino acids associated with the small subsite, the large subsite and the leaving group subsite, in order to alter enzyme activity and selectivity, including sterioselectivity, for various OP compounds. The G60A mutant reduced the size of the small subsite, and decreased both rate (k_{cat}) and specificity (k_{cat}/Kₐ) for Rₚ-enantiomers, thereby enhancing the overall specificity for some Sₚ-enantiomers to over 11,000: 1. Mutants I106A and S308A, which enlarged the size of the small subsite, as well as mutant F132A, which enlarged the leaving group subsite, all increased the reaction rates for Rₚ-enantiomers and reduced the specificity for Sₚ-enantiomers (Chen-Goodspeed, M. et al., 2001 a).

Additional mutants I106A/F132A, I106A/S308A, F132A/S308A, I106G, F132G, S308G, I106G/F132G, I106G/S308G, F132G/S308G, and I106G/F132G/S308G were produced to further enlarge the small subsite and leaving group subsite. These OPH mutants demonstrated enhanced selectivity for Rₚ-enantiomers. Mutants H254Y, H254F, H257Y, H257F, H257W, H257L, L271Y, L271F, L271W, M317Y, M317F, and M317W were produced to shrink the large subsite, with the H257Y mutant, for example, demonstrating a reduced selectivity for Sₚ-enantiomers (Chen-Goodspeed, M. et al., 2001). Further mutants I106A/H257Y, F132A/H257Y, I106A/F132A/H257Y, I106A/H257Y/S308A, I106A/F132A/H257W, F132A/H257Y/S308A, I106G/H257Y, F132G/H257Y, I106G/F132G/H257Y, I106G/H257Y/S308G, and 1106G/F132G/H257Y/S308G were made to simultaneously enlarge the small subsite and shrink the large subsite. Mutants such as H257Y, I106A/H257Y, I106G, I106A/F132A, and I106G/F132G/S308G were effective in altering steriospecificity for Sₚ:Rₚ enantiomer ratios of some substrates to less than 3:1 ratios. Mutants including F132A/H257Y, I106A/F132A/H257W, I106G/F132G/H257Y, and I106G/F132G/H257Y/S308G demonstrated a reversal of selectivity for Sₚ:Rₚ enantiomer ratios of some substrates to ratios from 3.6:1 to 460:1. In some cases, such a change in steriospecificity was produced by enhancing the rate of catalysis of a less preferred Rₚ enantiomer with little change on the rate of Sₚ enantiomer cleavage (Chen-Goodspeed, M. et al., 2001b; Wu, F. et al., 2000a).

Such alterations in sterioselectivity can enhance OPH performance against a specific OP compound that is a preferred target of detoxification, including a CWA. Enlargement of the small subsite by mutations that substitute the Ilel 06 and Phel 32 residues with the less bulky amino acid alanine and/or reduction of the large subsite by a mutation that substitutes His257 with the bulkier amino acid phenylalanine increased catalytic rates for the Sₚ-isomer; and decreased the catalytic rates for the Rₚ-isomers of a sarin analog, thus resulting in a triple mutant, I106A/F132A/H257Y, with a reversed sterioselectivity such as a Sₚ:Rₚ preference of 30:1 for the isomers of the sarin analog. A mutant of OPH designated G60A has also been created with enhanced steriospecificity relative to specific analogs of enantiomers of sarin and soman (Li, W.-S. et al., 2001; Raushel, F. M., 2002). Of greater interest, these mutant forms of OPH have been directly assayed against sarin and soman nerve agents, and demonstrated enhanced detoxification rates for racemic mixtures of sarin or soman enantiomers. Wild-type OPH has a k_{cat} for sarin of 56 s⁻¹, while the I106A/F132A/H257Y mutant has kcat for sarin of 1000 s−1. Additionally, wild-type OPH has a kat for soman of 5 s⁻¹, while the G60A Mutant has k_{cat} for soman of 10 s⁻¹ (Kolakoski, Jan E. et al. 1997; Li, W.-S. et al., 2001).

It is also possible to produce a mutant enzyme with an enhanced enzymatic property against a specific substrate by evolutionary selection rather than rational design. Such techniques can screen hundreds or thousands of mutants for enhanced cleavage rates against a specific substrate. The mutants identified may possess substitutions at amino acids that have not been identified as directly comprising the active site, or its binding subsites, using techniques such as NMR, X-ray crystallography and computer structure analysis, but still contribute to activity for one or more substrates. For example, selection of OPH mutants based upon enhanced cleavage of methyl parathion identified the A80V/S365P, L182SNV310A, 1274N, H257Y, H257Y/1274N/S365P, L130M/H257Y/I274N, and A14T/A80V/L185R/H257Y/1274N mutants as having enhanced activity. Amino acids Ile274 and Val3 10 are within 10 Å of the active site, though not originally identified as part of the active site from X-ray and computer structure analysis. However, mutants with substitutions at these amino acids demonstrated improved activity, with mutants comprising the I274N and H257Y substitutions particularly active against methyl parathion. Additionally, the mutant, A14T/A80V/L185R/H257Y/I274N, further comprising a LI 85R substitution, was most active having a 25-fold improvement against methyl parathion (Cho, C. M.-H. et al., 2002).

In an example, a functional equivalent of OPH may be prepared that lacks the first 29-31 amino acids of the wild-type enzyme. The wild-type form of OPH endogenously or recombinantly expressed in Pseudomonas or Flavobacterium removes the first N-terminal 29 amino acids from the precursor protein to produce the mature, enzymatically active protein (Mulbry, W. and Kams, J., 1989; Serdar, C. M. et al., 1989). Recombinant expressed OPH in Gliocladium virens apparently removes part or all of this sequence (Dave, K. I. et al., 1994b). Recombinant expressed OPH in Streptomyces lividans primarily has the first 29 or 30 amino acids removed during processing, with a few percent of the functional equivalents having the first 31 amino acids removed (Rowland, S. S. et al., 1992). Recombinant expressed OPH in Spodoptera frugiperda cells has the first 30 amino acids removed during processing (Dave, K. I. et al., 1994a).

The 29 amino acid leader peptide sequence targets OPH enzyme to the cell membrane in Escherichia coli, and this sequence is partly or fuilly removed during cellular processing (Dave, K. I. et al., 1994a; Miller, C. E., 1992; Serdar, C. M. et al., 1989; Mulbry, W. and Karns, J., 1989). The association of OPH comprising the leader peptide sequence with the cell membrane in Escherichia coli expression systems seems to be relatively weak, as brief 15 second sonication releases most of the activity into the extracellular environment (Dave, K. I. et al., 1994a). For example, recombinant OPH often is expressed without this leader peptide sequence to enhance enzyme stability and expression efficiency in Escherichia coli (Serdar, C. M., et al. 1989). In another example, recombinant expression efficiency in Pseudomonas putida for OPH was improved by retaining this sequence, indicating that different species of bacteria may have varying preferences for a signal sequence (Walker, A. W. and Keasling, J. D., 2002). However, it is contemplated that one of ordinary skill in the art can easily modify the length of an enzymatic sequence to optimize expression or other properties in a particular organism, or select a cell with a relatively good ability to express a biomolecule, in light of the present disclosures and methods known in the art (see U.S. Pat. Nos. 6,469,145; 5,589,386; and 5,484,728)

In an example, recombinant OPH sequence-length mutants have been expressed wherein the first 33 amino acids of OPH have been removed, and a peptide sequence M-I-T-N-S added at the N-terminus (Omburo, G. A. et al., 1992; Mulbry, W. and Kams, J., 1989). Often removal of the 29 amino acid sequence is used when expressing mutants of OPH comprising one or more amino acid substitutions such as the C59A, G60A, S61A, I106A, W131A, F132A, H254A, H257A, L271A, L303A, F306A, S308A, Y309A, M317A, I106A/F132A, I106A/S308A, F132A/S308A, I106G, F132G, S308G, I106G/F132G, I106G/S308G, F132G/S308G, 1106G/F132G/S308G, H254Y, H254F, H257Y, H257F, H257W, H257L, L271Y, L271W, M317Y, M317F, M317W, I106A/H257Y, F132A/H257Y, I106A/F132A/H257Y, I106A/H257Y/S308A, I106A/F132A/H257W, F132A/H257Y/S308A, I106G/H257Y, F132G/H257Y, I106G/F132G/H257Y, I106G/H257Y/S308G, and I106G/F132G/H257Y/S308G mutants (Chen-Goodspeed, M. et al., 2001 a). In a further example, LacZ-OPH fusion protein mutants lacking the 29 amino acid leader peptide sequence and comprising an amino acid substitution mutant such as W131F, F132Y, L136Y, L140Y, H257L, L271L, L271Y, F306A, or F306Y have been recombinantly expressed (Gopal, S. et al., 2000).

In an additional example, OPH mutants that comprise additional amino acid sequences are also known in the art. An OPH fusion protein lacking the 29 amino acid leader sequence and possessing an additional C-terminal flag octapeptide sequence was expressed and localized in the cytoplasm of Escherichia coli (Wang, J. et al., 2001). In another example, nucleic acids encoding truncated versions of the ice nucleation protein (“InaV”) from Pseudomonas syringae have been used to construct vectors that express OPH-InaV fusion proteins in Escherichia coli. The InaV sequences targeted and anchored the OPH-InaV fusion proteins to the cells' outer membrane (Shimazu, M. et al., 2001; Wang, A. A. et al., 2002). In a further example, a vector encoding a similar fusion protein was expressed in Moraxella sp., and demonstrated a 70-fold improved OPH activity on the cell surface compared to Escherichia coli expression (Shimazu, M. et al., 2001). In a further example, fusion proteins comprising the signal sequence and first nine amino acids of lipoprotein, a transmembrane domain of outer membrane protein A (“Lpp-OmpA”), and either a wild-type OPH sequence or an OPH truncation mutant lacking the first 29 amino acids has been expressed in Escherichia coli. These OPH-Lpp-OmpA fusion proteins were targeted and anchored to the Escherichia coli cell membrane, though the OPH truncation mutant had only 5% to 10% the activity of the wild-type OPH sequence (Richins, R. D. et al., 1997; Kaneva, I. et al., 1998). In one example, a fusion protein comprising N-terminus to C-terminus, a (His)6 polyhistidine tag, a green fluorescent protein (“GFP”), an enterokinase recognition site, and an OPH sequence lacking the 29 amino acid leader sequence has been expressed within Escherichia coli cells (Wu, C.-F. et al., 2000b, Wu, C.-F. et al., 2002). A similar fusion protein a (His)6 polyhistidine tag, an enterokinase recognition site, and an OPH sequence lacking the 29 amino acid leader sequence has also been expressed within Escherichia coli cells (Wu, C.-F. et al., 2002). Additionally, variations of these GFP-OPH fusion proteins have been expressed within Escherichia coli cells where an second enterokinase recognition site was placed at the C-terminus of the OPH gene fragment sequence, followed by a second OPH gene fragment sequence (Wu, C.-F. et al., 2001b). The GFP sequence produced fluorescence that was proportional to both the quantity of the fusion protein, and the activity of the OPH sequence, providing a fluorescent assay of enzyme activity and stability in GFP-OPH fusion proteins (Wu, C.-F. et al., 2000b, Wu, C.-F. et al., 2002).

In a further example, a fusion protein comprising an elastin-like polypeptide (“ELP”) sequence, a polyglycine linker sequence, and an OPH sequence was expressed in Escherichia coli (Shimazu, M. et al., 2002). In an additional example, a cellulose-binding domain at the N-terminus of an OPH fusion protein lacking the 29 amino acid leader sequence, and a similar fusion protein wherein OPH possessed the leader sequence, where both predominantly excreted into the external medium as soluble proteins by recombinant expression in Escherichia coli (Richins, R. D. et al., 2000).

Various chemical modifications to the amino acid residues of the recombinantly expressed human paraoxonase have been used to identify specific residues including tryptophans, histidines, aspartic acids, and glutamic acids as of importance to enzymatic activity for the cleavage of phenylacetate, paraoxon, chlorpyrifosoxon and diazoxon. Additionally, comparison to conserved residues in human, mouse, rabbit, rat dog, chicken, and turkey paraoxonase enzymes was used to further identify amino acids for the production of specific mutants. Site-directed mutagenesis was used to alter the enzymatic activity of human paraoxonase through conservative and non-conservative substitutions, and thus clarify the specific amino acids of particular importance for enzymatic activity. Specific paraoxonase mutants include the sequence analogs E32A, E48A, E52A, D53A, D88A, D107A, HI14N, D121A, H133N, H154N, HI60N, W193A, W193F, W201A, W201F, H242N, H245N, H250N, W253A, W253F, D273A, W280A, W280F, H284N, or H347N.

The various paraoxonase mutants generally had different enzymatic properties. For example, W253A had a 2-fold greater k_{cat}; and W201F, W253A and W253F each had a 2 to 4 fold increase in kcat, though W201F also had a lower substrate affinity. A non-conservative substitution mutant W280A had 1% wild-type paraoxonase activity, but the conservative substitution mutant W280F had similar activity as the wild-type paraoxonase (Josse, D. et al., 1999; Josse, D. et al., 2001).

Various chemical modifications to the amino acid residues of the recombinantly expressed squid-type DFPase from Loligo vulgaris has been used to identify which specific types of residues of modified arginines, aspartates, cysteines, glutamates, histidines, lysines, and tyrosines, are important to enzymatic activity for the cleavage of DFP. Modification of histidines generally reduced enzyme activity, and site-directed mutagenesis was used to clarify which specific histidines are of importance for enzymatic activity. Specific squid-type DFPase mutants include the sequence analogs H181N, H224N, H274N, H219N, H248N, or H287N.

The H287N mutant lost about 96% activity, and is thought to act as a hydrogen acceptor in active site reactions. The H181N and H274N mutants lost between 15% and 19% activity, and are thought to help stabilize the enzyme. The H224N mutant gained about 14% activity, indicating that alterations to this residue may also affect activity (Hartleib, J. and Ruterjans, H., 2001b).

In a further example of squid-type DFPase functional equivalents, recombinant squid-type DFPase sequence-length mutants have been expressed wherein a (His)6 tag sequence and a thrombin cleavage site has been added to the squid-type DFPase (Hartleib, J. and Ruterjans, H., 2001 a). In an additional example, a polypeptide comprising amino acids 1-148 of squid-type DFPase has been admixed with a polypeptide comprising amino acids 149-314 of squid-type DFPase to produce an active enzyme (Hartleib, J. and Ruterjans, H., 2001a).

It is contemplated that in various embodiments, a composition of the present invention may comprise one or more selected biomolecules, with an enzyme being a preferred biomolecule. It is contemplated that in specific embodiments, a composition of the present invention may comprise an endogenously expressed wild-type enzyme, a recombinant enzyme, or a combination thereof. In specific aspects, a recombinant enzyme comprises a wild-type enzyme, a functional equivalent enzyme, or a combination thereof. Numerous examples of enzymes with different properties are described herein, and any such enzyme as would be known to one of ordinary skill in the art is contemplated for inclusion in a composition of the present invention.

It is contemplated that a combination of biomolecules may be selected for inclusion in the biomolecule composition, coating and/or paint, to optimize one or more properties of such a composition of the present invention. Thus, a composition of the present invention may comprise 1 to 100 or more different selected biomolecules of interest, including all intermediate ranges and combinations thereof. For example, as various enzymes have differing binding properties, catalytic properties, stability properties, properties related to environmental safety, etc, one may select a combination of enzymes to confer the a more desirable range of properties to a composition of the present invention. In a specific example, it is contemplated that phosphoric triester hydrolases, with differing but desirable abilities to cleave the chiral centers of OP compounds, may be admixed to confer a more desirable range of catalytic properties to a composition of the present invention than would be achieved by the selection of a single phosphoric triester hydrolase.

In certain aspects, an enzyme of the present invention may be biologically produced in cell, tissue and/or organism transformed with a genetic expression vector. As used herein, an “expression vector” refers to a carrier nucleic acid molecule, into which a nucleic acid sequence can be inserted, wherein the nucleic acid sequence is capable of being transcribed into a ribonucleic acid (“RNA”) molecule after introduction into a cell. Usually an expression vector comprises deoxyribonucleic acid (“DNA”). As used herein, an “expression system” refers to an expression vector, and may further comprise additional reagents needed to promote insertion of a nucleic acid sequence, introduction into a cell, transcription and/or translation. As used herein, a “vector,” refers to a carrier nucleic acid molecule into which a nucleic acid sequence can be inserted for introduction into a cell. Certain vectors are capable of replication of the vector and/or any inserted nucleic acid sequence in a cell. For example, a viral vector may be used in conjunction with either an eukaryotic or prokaryotic host cell, particularly one that is permissive for replication or expression of the vector. A cell that is capable of being transformed with a vector is known herein as a “host cell.”

In general embodiments, the inserted nucleic acid sequence encodes for at least part of a gene product. In some embodiments wherein the nucleic acid sequence is transcribed into an RNA molecule, the RNA molecule is then translated into a proteinaceous molecule. As used herein, a “gene” refers to a nucleic acid sequence isolated from an organism, and/or man-made copies or mutants thereof, that comprises a nucleic acid sequence capable of being transcribed and/or translated in an organism. A “gene product” is the transcribed RNA and/or translated proteinaceous molecule from a gene. Often, only partial nucleic acid sequences of a gene, known herein as a “gene fragment,” are used COME BACK to produce a part of the gene product. Many gene and gene fragment sequences are known in the art, and are both commercially available and/or publicly disclosed at a database such as Genbank. It is contemplated that a gene and/or a gene fragment can be used to recombinantly produce an enzyme for use in the present invention. It is further contemplated that a gene and/or a gene fragment can be use in construction of a fusion protein comprising an enzyme, for use in the present invention.

In certain embodiments, a nucleic acid sequence such as a nucleic acid sequence encoding an enzyme, or any other desired RNA or proteinaceous molecule (as well as a nucleic acid sequence comprising a promoter, a ribosome binding site, an enhancer, a transcription terminator, an origin of replication, or other nucleic acid sequences described herein or would be known by one of ordinary skill in the art in light of the present disclosures) may be recombinantly produced or synthesized using any method or technique known to those of ordinary skill in the art in various combinations. [In “Molecular Cloning” (Sambrook, J., and Russell, D. W., Eds.) 3rd Edition, Cold Spring Harbor, N.Y.: Cold Spring Harbor Laboratory Press, 2001; In “Current Protocols in Molecular Biology” (Chanda, V. B. Ed.) John Wiley & Sons, 2002; In “Current Protocols in Cell Biology” (Morgan, K. Ed.) John Wiley & Sons, 2002; In “Current Protocols in Nucleic Acid Chemistry” (Harkins, E. W. Ed.) John Wiley & Sons, 2002; In “Current Protocols in Protein Science” (Taylor, G. Ed.) John Wiley & Sons, 2002; In “Current Protocols in Pharmacology” (Taylor, G. Ed.) John Wiley & Sons, 2002; In “Current Protocols in Cytometry” (Robinson, J. P. Ed.) John Wiley & Sons, 2002; In “Current Protocols in Immunology” (Coico, R. Ed.) John Wiley & Sons, 2002]. For example, a gene and/or a gene fragment encoding the enzyme of interest may be isolated and/or amplified through polymerase chain reaction (“PCRTM,,) technology. Often such nucleic acid sequence is readily available from a public database and/or a commercial vendor, as previously described.

Nucleic acid sequences, called codons, encoding for each amino acid are well known in the art, and used to copy and/or mutate a nucleic acid sequence to produce a desired mutant in an expressed amino acid sequence. Codons comprise nucleotides such as adenine (“A”), cytosine (“C”), guanine (“G”), thymine (“T”) and uracil (“U”). The common amino acids are generally encoded by the following codons: alanine is encoded by GCU, GCC, GCA, or GCG; arginine is encoded by CGU, CGC, CGA, CGG, AGA, or AGG; aspartic acid is encoded by GAU or GAC; asparagine is encoded by AAU or AAC; cysteine is encoded by UGU or UGC; glutamic acid is encoded by GAA or GAG; glutamine is encoded by CAA or CAG; glycine is encoded by GGU, GGC, GGA, or GGG; histidine is encoded by CAU or CAC; isoleucine is encoded by AUU, AUC, or AUA; leucine is encoded by UUA, UUG, CUU, CUC, CUA ,or CUG; lysine is encoded by AAA or AAG; methionine is encoded by AUG; phenylalanine is encoded by UUU or WUC; proline is encoded by CCU, CCC, CCA, or CCG; serine is encoded by AGU, AGC, UCU, UCC, UCA, or UCG; threonine is encoded by ACU, ACC, ACA, or ACG; tryptophan is encoded by UGG; tyrosine is encoded by UAU or UAC; and valine is encoded by GUU, GUC, GUA, or GUG.

A mutation in a nucleic acid encoding a proteinaceous molecule may be introduced into the nucleic acid sequence through any technique known to one of ordinary skill in the art. As would be well understood by those of ordinary skill in the art, such a mutation may be bioengineered to a specific region of a nucleic acid comprising one or more codons using a technique such as site-directed mutagenesis or cassette mutagenesis. Numerous examples of phosphoric triester hydrolase mutants have been produced using site-directed mutagenesis or cassette mutagenesis, and are described herein.

It is contemplated that for recombinant expression, the choice of codons may be made to mimic the host cell's molecular biological activity, in order to optimize the efficiency of expression from an expression vector. For example, codons may be selected to match the preferred codons used by a host cell in expressing endogenous proteins. In some aspects, the codons selected may be chosen to approximate the G-C content of an expressed gene and/or a gene fragment in a host cell's genome, or the G-C content of the genome itself. In other aspects, a host cell may be genetically altered to recognize more efficiently use a variety of codons, such as Escherichia coli host cells that are dnaY gene positive (Brinkmann, U. et al., 1989).

An expression vector may comprise specific nucleic acid sequences such as a promoter, a ribosome binding site, an enhancer, a transcription terminator, an origin of replication, or other nucleic acid sequence described herein or would be known by one of ordinary skill in the art in light of the present disclosures, in various combinations. A nucleic acid sequence can be “exogenous,” which means that it is foreign to the cell into which the vector is being introduced or that the sequence is homologous to a sequence in the cell, but in a position within the host cell nucleic acid in which the sequence is ordinarily not found. An expression vector may have one or more nucleic acid sequences removed by restriction enzyme digestion, modified by mutagenesis, and/or replaced with another more appropriate nucleic acid sequence, for transcription and/or translation in a host cell suitable for the expression vector selected.

One of skill in the art can construct a vector through standard recombinant techniques, which are well known and routine in the art. Further, one of skill in the art would know how to express a vector to transcribe a nucleic acid sequence and/or translate its cognate proteinaceous molecule. One of skill in the art would further understand the conditions under which to incubate all of the above described host cells to maintain them and to permit replication of a vector. Also understood and known are techniques and conditions that would allow large-scale production of a vector, as well as production of a nucleic acid sequence encoded by a vector into an RNA molecule and/or translation of the RNA molecule into a cognate proteinaceous molecule.

In certain embodiments, a cell may express multiple gene and/or gene fragment products from the same vector, and/or express more than one vector. Often this occurs simply as part of the normal function of a multi-vector expression system. For example, one gene or gene fragment is often used to produce a repressor that suppresses the activity of a promoter that controls the expression of a gene or a gene fragment of interest. The repressor gene and the desired gene may be on different vectors. However, multiple gene, gene fragment and/or expression systems may be used to express an enzymatic sequence of interest and another gene or gene fragment that is desired for a particular function. In an example, recombinant Pseudomonas putida has co-expressed OPH from one vector, and the multigenes encoding the enzymes for converting p-nitrophenol to β-ketoadipate from a different vector. The expressed OPH catalyzed the cleavage of parathion to p-nitrophenol. The additionally expressed recombinant enzymes converted the p-nitrophenol, which is a moderately toxic compound, to β-ketoadipate, thereby detoxifying both an OP compound and the byproducts of its hydrolysis (Walker, A. W. and Keasling, J. D., 2002). In a further example, Escherichia coli cells expressed a cell surface targeted INPNC-OPH fusion protein from one vector to detoxify OP compounds, and co-expressed from a different vector a cell surface targeted Lpp-OmpA-cellulose binding domain fusion protein to immobilize the cell to a cellulose support (Wang, A. A. et al., 2002). In an additional example, a vector co-expressed an antisense RNA sequence to the transcribed stress response gene σ³² and OPH in Escherichia coli. The antisense σ³² RNA was used to reduce the cell's stress response, including proteolytic damage, to an expressed recombinant proteinaceous molecule. A six-fold enhanced specific activity of expressed OPH enzyme was seen (Srivastava, R. et al., 2000). In a further example, multiple OPH fusion proteins were expressed from the same vector using the same promoter but separate ribosome binding sites (Wu, C.-F. et al., 2001b).

As is well known to those of skill in the art, an expression vector generally comprises a plurality of functional nucleic acid sequences that either comprise a nucleic acid sequence with a molecular biological function in a host cell, such as a promoter, an enhancer, a ribosome binding site, a transcription terminator, etc, and/or encode a proteinaceous sequence, such as a leader peptide, a polypeptide sequence with enzymatic activity, a peptide or polypeptide with a binding property, etc. A nucleic acid sequence may comprise a “control sequence,” which refers to a nucleic acid sequence necessary for the transcription and possibly translation of an operatively linked coding sequence in a particular host cell. As used herein, an “operatively linked” or “operatively positioned” nucleic acid sequence refers to the placement of one nucleic acid sequence into a functional relationship with another nucleic acid sequence. Vectors and expression vectors may further comprise one or more nucleic acid sequences that serve other functions as well and are described herein.

The various functional nucleic acid sequences that comprise an expression vector are operatively linked so to position the different nucleic acid sequences for optimal function in a host cell. In certain cases, the functional nucleic acid sequences may be contiguous such as placement of a nucleic acid sequence encoding a leader peptide sequence in correct amino acid frame with a nucleic acid sequence encoding a polypeptide comprising a polypeptide sequence with enzymatic activity. In other cases, the functional nucleic acid sequences may be non-contiguous such as placing a nucleic acid sequence comprising an enhancer distal to a nucleic acid sequence comprising such sequences as a promoter, a encoded proteinaceous molecule, a transcription termination sequence, etc. One or more nucleic acid sequences may be operatively linked using methods well known in the art, particularly ligation at restriction sites that may pre-exist in a nucleic acid sequence or be added through mutagenesis.

A “promoter” is a control sequence that is a region of a nucleic acid sequence at which initiation and rate of transcription are controlled. In the context of a nucleic acid sequence comprising a promoter and an additional nucleic acid sequence, particularly one encoding a gene or gene fragment's product, the phrases “operatively linked,” “operatively positioned,” “under control,” and “under transcriptional control” mean that a promoter is in a correct functional location and/or orientation in relation to the additional nucleic acid sequence to control transcriptional initiation and/or expression of the additional nucleic acid sequence. A promoter may contain genetic elements at which regulatory proteins and molecules may bind such as RNA polymerase and other transcription factors. A promoter employed may be constitutive, tissue-specific, inducible, and/or useful under the appropriate conditions to direct high level expression of the introduced nucleic acid sequence, such as is advantageous in the large-scale production of a recombinant proteinaceous molecule. Examples of a promoter include a lac, a tac, an amp, a heat shock promoter of a P-element of Drosophila, a baculovirus polyhedron gene promoter, or a combination thereof. In a specific example, the nucleic acids encoding OPH have been expressed using the polyhedron promoter of a baculoviral expression vector (Dumas, D. P. et al., 1990). In a further example, a Cochliobolus heterostrophus promoter, prom1, has been used to express a nucleic acid encoding OPH (Dave, K. I. et al., 1994b).

The promoter may be endogenous or heterologous. An “endogenous promoter” comprises one naturally associated with a gene or sequence, as may be obtained by isolating the 5′ non-coding sequences located upstream of the coding segment and/or exon. Alternatively, certain advantages will be gained by positioning the coding nucleic acid sequence under the control of a “heterologous promoter” or “recombinant promoter,” which refers to a promoter that is not normally associated with a nucleic acid sequence in its natural environment.

A specific initiation signal also may be required for efficient translation of a coding sequence by the host cell. Such a signal may include an ATG initiation codon (“start codon”) and/or an adjacent sequence. Exogenous translational control signals, including the ATG initiation codon, may need to be provided. One of ordinary skill in the art would readily be capable of determining this and providing the necessary signals. It is well known that the initiation codon must be “in-frame” with the reading frame of the desired coding sequence to ensure translation of the entire insert. The exogenous translational control signal and/or an initiation codon can be either natural or synthetic. The efficiency of expression may be enhanced by the inclusion of an appropriate transcription enhancer.

A promoter may or may not be used in conjunction with an “enhancer,” which refers to a cis-acting regulatory sequence involved: in the transcriptional activation of a nucleic acid sequence. An enhancer may be one naturally associated with a nucleic acid sequence, located either downstream or upstream of that sequence. A recombinant or heterologous enhancer refers also to an enhancer not normally associated with a nucleic acid sequence in its natural environment. Such a promoter and/or enhancer may include a promoter and/or enhancer of another gene, a promoter and/or enhancer isolated from any other prokaryotic, viral, or eukaryotic cell, a promoter and/or enhancer not “naturally occurring,” i.e., a promoter and/or enhancer comprising different elements of different transcriptional regulatory regions, and/or mutations that alter expression. In addition to producing a nucleic acid sequence comprising a promoter and/or enhancer synthetically, a sequence may be produced using recombinant cloning and/or nucleic acid amplification technology, including PCR™, in connection with the compositions disclosed herein (U.S. Pat. No. 4,683,202, U.S. Pat. No. 5,928,906).

It will be important to employ a promoter and/or enhancer that effectively directs the expression of the nucleic acid sequence in the cell type, chosen for expression. Those of skill in the art of molecular biology generally know the use of promoters, enhancers, and cell type combinations for expression. Furthermore, it is contemplated the control sequences that direct transcription and/or expression of sequences within non-nuclear organelles, including eukaryotic organelles such as mitochondria, chloroplasts, and the like, can be employed as well.

Vectors can include a multiple cloning site (“MCS”), which is a nucleic acid region that contains multiple restriction enzyme sites, any of which can be used in conjunction with standard recombinant technology to digest the vector. “Restriction enzyme digestion” refers to catalytic cleavage of a nucleic acid molecule with an enzyme which functions only at specific locations in a nucleic acid molecule. Many of these restriction enzymes are commercially available. Use of such enzymes is widely understood by those of skill in the art. Frequently, a vector is linearized or fragmented using a restriction enzyme that cuts within the MCS to enable an exogenous nucleic acid sequence to be ligated to the vector. “Ligation” refers to the process of forming phosphodiester bonds between two nucleic acid fragments, which may or may not be contiguous with each other. Techniques involving restriction enzymes and ligation reactions are well known to those of skill in the art of recombinant technology.

A “fusion protein,” as used herein,.is an expressed contiguous amino acid sequence comprising a proteinaceous molecule of interest and one or more additional peptide or polypeptide sequences. The additional peptide or polypeptide sequence generally provides an useful additional property to the fusion protein, including but not limited to, targeting the fusion protein to a particular location within or external to the host cell (e.g., a signal peptide); promoting the ease of purification and/or detection of the fusion protein (e.g., a tag, a fusion partner); promoting the ease of removal of one or more additional sequences from the peptide or polypeptide of interest (e.g., a protease cleavage site); and separating one or more sequences of the fusion protein to allow optimal activity or function of the sequence(s) (e.g., a linker sequence).

As used herein a “tag” is a peptide sequence operatively associated to the sequence of another peptide or polypeptide sequence. Examples of a tag include a His-tag, a strep-tag, a flag-tag, a T7-tag, a S-tag, a HSV-tag, a polyarginine-tag, a polycysteine-tag, a polyaspartic acid-tag, a polyphenylalanine-tag, or a combination thereof. A His-tag is 6 or 10 amino acids in length, and can be incorporated at the N-terminus, C-terminus or within an amino acid sequence for use in detection and purification. A His tag binds affinity colurns comprising nickel, and is eluted using low pH conditions or with imidazole as a competitor (Unger, T. F., 1997). A strep-tag is 10 amino acids in length, and can be incorporated at the C-terminus. A strep-tag binds streptavidin or affinity resins that comprise streptavidin. A flag-tag is 8 amino acids in length, and can be incorporated at the N-terminus or C-terminus of an amino acid sequence for use in purification. A T7-tag is 11 or 16 amino acids in length, and can be incorporated at the N-terminus or within an amino acid sequence for use in purification. A S-tag is 15 amino acids in length, and can be incorporated at the N-terminus, C-terminus or within an amino acid sequence for use in detection and purification. A HSV-tag is 11 amino acids in length, and can be incorporated at the C-terminus of an amino acid sequence for use in purification. The HSV tag binds an anti-HSV antibody in purification procedures (Unger, T. F., 1997). A polyarginine-tag is 5 to 15 amino acids in length, and can be incorporated at the C-terminus of an amino acid sequence for use in purification. A polycysteine-tag, is 4 amino acids in length, and can be incorporated at the N-terminus of an amino acid sequence for use in purification. A polyaspartic acid-tag can be 5 to 16 amino acids in length, and can be incorporated at the C-terminus of an amino acid sequence for use in purification. A polyphenylalanine-tag is 11 amino acids in length, and can be incorporated at the N-terminus of an amino acid sequence for use in purification.

In one example, a (His)6 tag sequence has been used to purify fusion proteins comprising GFP-OPH or OPH using immobilized metal affinity chromatography (“IMAC”) (Wu, C.-F. et al., 2000b; Wu, C.-F. et al., 2002). In a further example, a (His)6 tag sequence followed by a thrombin cleavage site has been used to purify fusion proteins comprising squid-type DFPase using IMAC (Hartleib, J. and Rutedjans, H., 2001 a). In a further example, an OPH fusion protein comprising a C-terminal flag has been expressed (Wang, J. et al., 2001).

As used herein a “fusion partner” is a polypeptide that is operatively associated to the sequence of another peptide or polypeptide of interest. Properties that a fusion partner can confer to a fusion protein include, but are not limited to, enhanced expression, enhanced solubility, ease of detection, and/or ease of purification of a fusion protein. Examples of a fusion partner include a thioredoxin, a cellulose-binding domain, a calmodulin binding domain, an avidin, a protein A, a protein G, a glutathione-S-transferase, a chitin-binding domain, an ELP, a maltose-binding domain, or a combination thereof. Thioredoxin can be incorporated at the N-terminus or C-terminus of an amino acid sequence for use in purification. A cellulose-binding domain binds a variety of resins comprising cellulose or chitin (Unger, T. F., 1997). A calmodulin-binding domain binds affinity resins comprising calmodulin in the presence of calcium, and allows elution of the fusion protein in the presence of ethylene glycol tetra acetic acid (“EGTA”) (Unger, T. F., 1997). Avidin is useful in purification or detection. A protein A or a protein G binds a variety of anti-bodies for ease of purification. Protein A is generally bound to an IgG sepharose resin (Unger, T. F., 1997). Streptavidin is useful in purification or detection. Glutathione-S-transferase can be incorporated at the N-terminus of an amino acid sequence for use in detection or purification. Glutathione-S-transferase binds affinity resins comprising glutathione (Unger, T. F., 1997). An elastin-like polypeptide comprises repeating sequences (e.g., 78 repeats) which reversibly converts itself, and thus the fusion protein,-from an aqueous soluble polypeptide to an insoluble polypeptide above an empirically determined transition temperature. The transition temperature is affected by the number of repeats, and can be determined spectrographically using techniques known in the art, including measurements at 655 nano meters (“nm”) over a 4° C. to 80° C. range (Urry, D. W. 1992; Shimazu, M. et al., 2002). A chitin-binding domain preferable comprises an intein cleavage site sequence, and can be incorporated at the C-terminus for purification. The chitin-binding domain binds affinity resins comprising chitin, and an intein cleavage site sequence allows the self-cleavage in the presence of thiols at reduced temperature to release the peptide or polypeptide sequence of interest (Unger, T. F., 1997). A maltose-binding domain can be incorporated at the N-terminus or C-terminus of an amino acid sequence for use in detection or purification. A maltose-binding domain sequence usually further comprises a ten amino acid poly asparagine sequence between the maltose binding domain and the sequence of interest to aid the maltose-binding domain in binding affinity resins comprising amylose (Unger, T. F., 1997).

In an example, a fusion protein comprising an elastin-like polypeptide sequence and an OPH sequence has been expressed (Shimazu, M. et al., 2002). In a further example, a cellulose-binding domain-OPH fusion protein has also been recombinantly expressed (Richins, R. D. et al., 2000). In an additional example, a maltose binding protein-E3 carboxylesterase fusion protein has been recombinantly expressed (Claudianos, C. et al., 1999)

A protease cleavage site promotes proteolytic removal of the fusion partner from the peptide or polypeptide of interest. Often, a fusion protein is bound to an affinity resin, and cleavage at the cleavage site promotes the ease of purification of a peptide or polypeptide of interest with most or all of the tag or fusion partner sequence removed (Unger, T. F., 1997). Protease cleavage sites are well known in the art, and examples of protease cleavage sites include the factor Xa cleavage site, which is four amino acids in length; the enterokinase cleavage site, which is five amino acids in length; the thrombin cleavage site, which is six amino acids in length; the rTEV protease cleavage site, which is seven amino acids in length; the 3C human rhino virus protease, which is eight amino acids in length; and the PreScission™ cleavage site, which is eight amino acids in length. In an example, an enterokinase recognition site was used to separate an OPH sequence from a fusion partner (Wu, C.-F. et al., 2000b; Wu, C.-F. et al., 2001b).

In an eukaryotic expression system (e.g., a fungal expression system), the “terminator region” or “terminator” may also comprise a specific DNA sequence that permits site-specific cleavage of the new transcript so as to expose a polyadenylation site. This signals a specialized endogenous polymerase to add a stretch of adenosine nucleotides (“polyA”) of about about 200 in number to the 3′ end of the transcript. RNA molecules modified with this polyA tail appear to more stable and are translated more efficiently. Thus, in other embodiments involving an eukaryote, it is preferred that that terminator comprises a signal for the cleavage of the RNA, and it is more preferred that the terminator signal promote polyadenylation of the message. The terminator and/or polyadenylation site elements can serve to enhance message levels and/or to minimize read through from the cassette into other sequences.

A terminator contemplated for use in the invention include any known terminator of transcription described herein or known to one of ordinary skill in the art, including but not limited to, for example, a termination sequence of a gene, such as for example, a bovine growth hormone terminator or a viral termination sequence, such as for example a SV40 terminator. In certain embodiments, the termination signal may be a lack of transcribable or translatable sequence, such as due to a sequence truncation. In one example, a trpC terminator from Aspergillus nidulans has been used in the expression of recombinant OPH (Dave, K. I. et al., 1994b).

In expression, particularly eukaryotic expression, one will typically include a polyadenylation signal to effect proper polyadenylation of the transcript. The nature of the polyadenylation signal is not believed to be crucial to the successful practice of the invention, and/or any such sequence may be employed. Preferred embodiments include the SV40 polyadenylation signal and/or the bovine growth hormone polyadenylation signal, convenient and/or known to function well in various target cells. Polyadenylation may increase the stability of the transcript or may facilitate cytoplasmic transport.

In order to propagate a vector in a host cell, it may contain one or more origins of replication sites (“ori”), which is a specific nucleic acid sequence at which replication is initiated. Alternatively an autonomously replicating sequence (“ARS”) can be employed if the host cell is yeast.

Various types of prokaryotic and/or eukaryotic expression vectors are known in the art. Examples of types of expression vectors include a bacterial artificial chromosome (“BAC”), a cosmid, a plasmid [e.g., a pMB1/colE1 derived plasmid such as pBR322, pUC18; a Ti plasmid of Agrobacterium tumefaciens derived vector (Rogers, S. G. et al., 1987)], a virus (e.g., a bacteriophage such as a bacteriophage M13, an animal virus, a plant virus), or a yeast artificial chromosome (“YAC”). Some vectors, known herein as “shuttle vectors” may employ control sequences that allow it to be replicated and/or expressed in both prokaryotic and eukaryotic cells [e.g., a wheat dwarf virus (“WDV”) pW1-11 or pW1-GUS shuttle vector (Ugaki, M. et al., 1991)]. An expression vector operatively linked to a nucleic acid sequence encoding an enzymatic sequence of the present invention may be constructed using techniques known to those of skill in the art in light of the present disclosures [In “Molecular Cloning” (Sambrook, J., and Russell, D. W., Eds.) 3rd Edition, Cold Spring Harbor, N.Y.: Cold Spring Harbor Laboratory Press, 2001; In “Current Protocols in Molecular Biology” (Chanda, V. B. Ed.) John Wiley & Sons, 2002; In “Current Protocols in Nucleic Acid Chemistry” (Harkins, E. W. Ed.) John Wiley & Sons, 2002; In “Current Protocols in Protein Science” (Taylor, G. Ed.) John Wiley & Sons, 2002; In “Current Protocols in Cell Biology” (Morgan, K. Ed.) John Wiley & Sons, 2002].

Numerous expression systems exist that comprise at least a part or all of the compositions discussed above. Prokaryote- and/or eukaryote-based systems can be employed for use with the present invention to produce nucleic acid sequences, or their cognate polypeptides, proteins and peptides. Many such systems are widely available, including those provide by commercial vendors, as would be known to those of skill in the art. For example, an insect cell/baculovirus system can produce a high level of protein expression of a heterologous nucleic acid sequence, such as described in U.S. Pat. Nos. 5,871,986, 4,879,236, both incorporated herein by reference, and which can be bought, for example, under the name MAXBAC® 2.0 from INVITROGEN® and BACPACK™ BACULOVIRUS EXPRESSION SYSTEM FROM CLONTECH®. In an addition example of an expression system include STRATAGENE®'S COMPLETE CONTROL™ Inducible Mammalian Expression System, which involves a synthetic ecdysone-inducible receptor, or its pET Expression System, an Escherichia coli expression system. Another example of an inducible expression system is available from INVITROGEN®, which carries the T-REX™ (tetracycline-regulated expression) System, an inducible mammalian expression system that uses the full-length CMV promoter. INVITROGEN® also provides a yeast expression system called the Pichia methanolica Expression System, which is designed for high-level production of recombinant proteins in the methylotrophic yeast Pichia methanolica. In a specific example, E3 carboxylesterase enzymatic sequences and phosphoric triester hydrolase functional equivalents have been recombinantly expressed in a BACPACK™ Baculovirus Expression System From CLONTECH® (Newcomb, R. D. et al., 1997; Campbell, P. M. et a., 1998). In certain embodiments, a biomolecule may be expressed in a plant cell (e.g., a corn cell), using techniques such as those described in U.S. Pat. Nos. 6,504,085, 6,136,320, 6,087,558, 6034,298, 5,914,123, and 5,804,694.

In preferred embodiments, a prokaryote such as a bacterium comprises a host cell. In specific aspects, the bacterium host cell comprises a Gram-negative bacterium cell. Various prokaryotic host cells have been used in the art with expression vectors, and it is contemplated that any prokaryotic host cell known in the art may be used to express a peptide or polypeptide comprising an enzyme sequence of the present invention.

An expression vector for use in prokaryotic cells generally comprises nucleic acid sequences such as, a promoter, a ribosome binding site;(e.g., a Shine-Delgarno sequence), a start codon, a multiple cloning site, a fusion partner, a protease cleavage site, a stop codon, a transcription terminator, an origin of replication, a repressor, and/or any other additional nucleic acid sequence that would be used in such an expression vector, as would be known to one of ordinary skill in the art [Makrides, S. C., 1996; Hannig, G. and Makrides, S. C., 1998; Stevens, R. C., 2000; In “Molecular Cloning” (Sambrook, J., and Russell, D. W., Eds.) 3rd Edition, Cold Spring Harbor, N.Y.: Cold Spring Harbor Laboratory Press, 2001; In “Current Protocols in Molecular Biology” (Chanda, V. B. Ed.) John Wiley & Sons, 2002; In “Current Protocols in Nucleic Acid Chemistry” (Harkins, E. W. Ed.) John Wiley & Sons, 2002; In “Current Protocols in Protein Science” (Taylor, G. Ed.) John Wiley & Sons, 2002; In “Current Protocols in Cell Biology” (Morgan, K. Ed.) John Wiley & Sons, 2002].

A promoter generally is positioned 10 to 100 nucleotides 5′ to a nucleic acid sequence comprising a ribosome binding site. Examples of promoters that have been used in a prokaryotic cell includes a T5 promoter, a lac promoter, a tac promoter, a trc promoter, an araBAD promoter, a P_{L} promoter, a T7 promoter, a T7-lac operator promoter, and variations thereof. The T5 promoter is regulated by the lactose operator. A lac promoter (e.g., a lac promoter, a lacUV5 promoter), a tac promoter (e.g., a tacI promoter, a tacII promoter), a T7-lac operator promoter or a trc promoter are each suppressed by a lacl repressor, a more effective lacl^{Q} repressor or an even stronger lacl^{Q1} repressor (Glascock, C. B. and Weickert, M. J., 1998). Isopropyl-β-D-thiogalactoside (“IPTG”) is used to induce lac, tac, T7-lac operator and trc promoters. An araBAD promoter is suppressed by an araC repressor, and is induced by 1-arabinose. A P_{L} promoter or a T7 promoter are each suppressed by a λcIts857 repressor, and induced by a temperature of 42° C. Nalidixic acid may be used to induce a P_{L} promoter.

In an example, recombinant amino acid substitution mutants of OPH have been expressed in Escherichia coli using a lac promoter induced by IPTG (Watkins, L. M. et al., 1997b). In another example, recombinant wild type and a signal sequence truncation mutant of OPH was expressed in Pseudomonas putida under control of a lactac and tac promoters (Walker, A. W. and Keasling, J. D., 2002). In a further example, an OPH-Lpp-OmpA fusion protein has been expressed in Escherichia coli strains JM105 and XL1-Blue using a constitutive /pp-lac promoter or a tac promoter induced by IPTG and controlled by a lacl^{Q} repressor (Richins, R. D. et al., 1997; Kaneva, I. et al., 1998; Mulchandani, A. et al., 1999b). In an additional example, a cellulose-binding domain-OPH fusion protein has also been recombinantly expressed under the control of a T7 promoter (Richins, R. D. et al., 2000). In a further example, recombinant Altermonas sp. JD6.5 OPAA has been expressed under the control of a trc promoter in Escherichia coli (Cheng, T.-C. et al., 1999). In an additional example, a (His)6 tag sequence-thrombin cleavage site-squid-type DFPase has been expressed using a Ptac promoter in Escherichia coli (Hartleib, J. and Ruteijans, H., 2001 a).

A ribosome binding site is important for transcription initiation, and is usually positioned 4 to 14 nucleotides 5′ from the start codon. A start codon signals initiation of transcription. A multiple cloning site comprises restriction sites for incorporation of a nucleic acid sequence encoding a peptide or polypeptide of interest.

A stop codon signals translation termination. The vectors or constructs of the present invention will generally comprise at least one termination signal. A “termination signal” or “terminator” is comprised of the DNA sequences involved in specific termination of an RNA transcript by an RNA polymerase. Thus, in certain embodiments a termination signal that ends the production of an RNA transcript is contemplated. A terminator may be necessary in vivo to achieve desirable message levels. A transcription terminator signals the end or transcription and often enhances mRNA stability. Examples of a transcription terminator include a rrnB T1 or a rrnB T2 transcription terminator (Unger, T. F., 1997). An origin of replication regulates the number of expression vector copies maintained in a transformed host cell.

A selectable marker usually provides a transformed cell resistance to an antibiotic. Examples of a selectable marker used in a prokaryotic expression vector include a β-lactamase, which provides resistance to antibiotic such as an ampicillin or a carbenicillin; a tet gene product, which provides resistance to a tetracycline, or a Km gene product, which provides resistance to a kanamycin. A repressor regulatory gene suppresses transcription from the promoter. Examples of repressor regulatory genes include the lacl, lacl^{q}, or lacl^{Q1} repressors (Glascock, C. B. and Weickert, M. J., 1998). Often, the host cell's genome, or additional nucleic acid vector co-transfected into the host cell, may comprise one or more of these nucleic acid sequences, such as, for example, a repressor.

It is contemplated that an expression vector for a prokaryotic host cell will comprise a nucleic acid sequence that encodes a periplasmic space signal peptide. In preferred aspects, this nucleic acid sequence will be operatively linked to a nucleic acid sequence comprising an enzymatic peptide or polypeptide of the present invention, wherein the periplasmic space signal peptide directs the expressed fusion protein to be translocated into a prokaryotic host cell's periplasmic space. Fusion proteins secreted in the periplasmic space may be obtained through simplified purification protocols compared to non-secreted fusion proteins. A periplasmic space signal peptide are usually operatively linked at or near the N-terminus of an expressed fusion protein. Examples of a periplasmic space signal peptide include the Escherichia coli ompA, ompT, and malel leader peptide sequences and the T7 caspid protein leader peptide sequence (Unger, T. F., 1997).

Mutated and/or recombinantly altered bacterium that release a peptide or polypeptide comprising an enzyme sequence of the present invention into the environment may be particularly advantageous for purification and/or contact of enzyme with a target chemical substrate. It is contemplated that a strain of bacteria, such as, for example, a bacteriocin-release protein mutant strain of Escherichia coli, may be used to promote release of expressed proteins targeted to the periplasm into the extracellular. environment (Van der Wal, F. J. et al., 1998). In other aspects, it is contemplated that a bacterium may be transfected with an expression vector that produces a gene and/or a gene fragment product that promotes the release of a protenaceous molecule of interest from the periplasm into the extracellular environment. For example, a plasmid encoding the third topological domain of TolA has been described as promoting the release of endogenous and recombinantly expressed proteins from the periplasm (Wan, E. W. and Baneyx, F., 1998).

Many host cells from various cell types and organisms are available and would be known to one of skill in the art. As used herein, the terms “cell,” “cell line,” and “cell culture” may be used interchangeably. All of these terms also include their progeny, which is any and all subsequent generations. It is understood that all progeny may not be identical due to deliberate or inadvertent mutations. In the context of expressing a heterologous nucleic acid sequence, “host cell” refers to a prokaryotic or eukaryotic cell, and it includes any transformable organism that is capable of replicating a vector and/or expressing a heterologous gene and/or gene fragment encoded by a vector. A host cell can, and has been, used as a recipient for vectors. A host cell may be “transfected” or “transformed,” which refers to a process by which exogenous nucleic acid sequence is transferred or introduced into the host cell. A transformed cell includes the primary subject cell and its progeny. Techniques for transforming a cell are extremely well known in the art, and include, for example calcium phosphate precipitation, cell sonication, diethylaminoethanol (“DEAE”)-dextran, direct microinjection, DNA-loaded liposomes, electroporation, gene bombardment using high velocity microprojectiles, receptor-mediated transfection, viral-mediated transfection, or a combination thereof [In “Molecular Cloning” (Sambrook, J., and Russell, D. W., Eds.) 3rd Edition, Cold Spring Harbor, N.Y.: Cold Spring Harbor Laboratory Press, 2001; In “Current Protocols in Molecular Biology” (Chanda, V. B. Ed.) John Wiley & Sons, 2002].

Once a suitable expression vector is transformed into a cell, the cell may be grown in an appropriate environment, and in some cases, used to produce a tissue or whole multicellular organism. As used herein, the terms “engineered” and “recombinant” cells or host cells are intended to refer to a cell into which an exogenous nucleic acid sequence has been introduced. Therefore, engineered cells are distinguishable from naturally occurring cells that do not contain a recombinantly introduced exogenous nucleic acid sequence. Engineered cells are thus cells having a nucleic acid sequence introduced through the hand of man. Recombinant cells include those having an introduced cDNA or genomic gene and/or a gene fragment positioned adjacent to a promoter not naturally associated with the particular introduced nucleic acid sequence, a gene, and/or a gene fragment. An enzyme or proteinaceous molecule produced from the introduced gene and/or gene fragment is referred to as a recombinant enzyme or recombinant proteinaceous molecule, respectively. All tissues, offspring, progeny or descendants of such a cell, tissue, and/or organism that comprise the transformed nucleic acid sequence thereof are considered part of the present invention.

Though it is possible to purify an expressed enzyme from cellular material, the discovery disclosed herein of the properties of an enzyme composition comprising, in preferred embodiments, an enzyme expressed and retained, whether naturally or through recombinant expression, within a cell. In preferred embodiments, an enzyme is produced using recombinant nucleic acid expression systems in the cell. Cells are known herein based on the type of enzyme expressed within the cell, whether endogenous or recombinant, so that, for example, a cell expressing an enzyme of interest would be known as an enzyme⁺ cell, a cell expressing a phosphoric triester hydrolase would be known herein as a “phosphoric triester hydrolase⁺ cell,” etc. Additional examples of such nomenclature include an aryldialkylphosphatase⁺ cell, an OPH⁺ cell, an OPAA⁺ cell, a human paraoxonase⁺ cell, a carboxylase⁺ cell, a prolidase⁺ cell, an aminopeptideases+cell, a PepQ⁺ cell, a mpd product⁺ cell, a “B” esterase⁺ cell, an acetycholinesterase⁺ cell, a butyrylcholinesterase⁺ cell, diisopropyl-fluorophosphatase⁺ cell, Mazur-type DFPase⁺ cell, or a squid-type DFPase⁺ cell, respectively denoting cells that comprise, an aryldialkylphosphatase, an OPH, a OPAA, a human paraoxonase, a carboxylase, a prolidase, an aminopeptidease, a PepQ, a mpd product, a “B” esterase, an acetycholinesterase, a butyrylcholinesterase, a diisopropyl-fluorophosphatase, a Mazur-type DFPase, or a squid-type DFPase, etc.

In preferred embodiments, an enzyme⁺ cell comprises a bacterial cell, a yeast cell, an insect cell, a plant cell, or a combination thereof. In preferred aspects, the cell comprises a cell wall. Contemplated enzyme⁺ cells that comprise cell walls include, but are not limited to, a bacterial cell, a fungal cell, a plant cell, or a combination thereof. In preferred facets, a microorganism comprises the enzyme⁺ cell. Examples of contemplated microorganisms include a bacterium, a fungus, or a combination thereof. Examples of a bacterial host cell that have been used with expression vectors include an Aspergillus niger, a Bacillus (e.g., B. amyloliquefaciens, B. brevis, B. licheniformis, B. subtilis), an Escherichia coli, a Kluyveromyces lactis, a Moraxella sp., a Pseudomonas (e.g., fluorescens, putida), Flavobacterium cell, a Plesiomonas cell, an Alteromonas cell, or a combination thereof. Examples of a yeast cell include a Streptomyces lividans cell, a Gliocladium virens cell, a Saccharomyces cell, or a combination thereof.

Host cells may be derived from prokaryotes or eukaryotes, depending upon whether the desired result is replication of the vector or expression of part or all of the vector-encoded nucleic acid sequences. Numerous cell lines and cultures are available for use as a host cell, and they can be obtained through the American Type Culture Collection, which is an organization that serves as an archive for living cultures and genetic materials. An appropriate host can be determined by one of skill in the art based on the vector backbone and the desired result. A plasmid or cosmid, for example, can be introduced into a prokaryote host cell for replication of many vectors. Examples of a bacterial cell used as a host cell for vector replication and/or expression include DH5a, JM109, and KC8, as well as a number of commercially available bacterial hosts such as Novablue™ Escherichia coli cells (NOVAGENE®), SURE® Competent Cells and SOLOPACK™ Gold Cells (STRATAGENE®). However, Escherichia coli cells have been the most common cell types used to express both wild type and mutant forms of OPH (Dumas, D. P. et al., 1989a; Dave, K. I. et al., 1993; Lai, K. et al., 1994; Wu, C. F. et al., 2001). In an example, the OPH I106A/F132A/H257Y and G60A mutants have been expressed in Escherichia coli BL-21 host cells (Kuo, J. M. and Raushel, F. M., 1994; Li, W.-S. et al., 2001). In a further example, maltose-binding domain-E3 carboxylesterase and phosphoric triester hydrolase functional equivalents have been expressed in Escherichia coli TB1 cells (Claudianos, C. et al., 1999). In another example, the OPH mutants designated W131F, F132Y, L136Y, L140Y, H257L, L271Y, F306A, and F306Y each have been expressed in Novablue™ Escherichia coli cells (Gopal, S. et al., 2000). In an addition example, OPAA from Alteromonas sp JD6.5 has been recombinantly expressed in Escherichia coli cells (Hill, C. M., 2000). In a further example, recombinant Altermonas sp. JD6.5 OPAA has been expressed in Escherichia coli (Cheng, T. C. et al., 1999). In a further example, the mpd gene has been recombinantly expressed in Escherichia coli, and the encoded enzyme demonstrated methyl parathion degradation activity (Zhongli, C. et al., 2001). In an additional example, a recombinant squid-type DFPase fusion protein has been expressed Escherichia coli BL-21 cells (Hartleib, J. and Ruterjans, H., 2001a). Alternatively, bacterial cells such as Escherichia coli LE392 could be used as host cells for phage viruses. Of course, one of skill in the art may select a bacterium species to express a proteinaceous molecule due to a particular desirable property. In an example, Moraxella sp. that degrades p-nitrophenol, a toxic cleavage product of parathion and methyl parathion, has been used to recombinantly express an OPH-InaV fusion protein. The resulting recombinant bacterial degrades both toxic OP compounds and their cleavage byproduct (Shimazu, M. et al., 2001b).

Examples of eukaryotic host cells for replication and/or expression of a vector include yeast cells HeLa, NIH3T3, Jurkat, 293, Cos, CHO, Saos, and PC12. In an example, OPH has been expressed in the host yeast cells of Streptomyces lividans (Steiert, J. G. et al., 1989). In another example, OPH has been expressed in host insect cells, including Spodoptera frugiperda sf9 cells (Dumas, D. P. et al., 1989b; Dumas, D.

P. et al., 1990). In a further example, OPH has been expressed in the cells of Drosophila melanogaster (Phillips, J. P. et al., 1990). In an additional example, OPH has been expressed in the fungus Gliocladium virens (Dave, K. I. et al., 1994b). In a further example, the gene for human paraoxonase, PONI, has been recombinantly expressed in human embryonic kidney cells (Josse, D. et al., 2001; Josse, D. et al., 1999). In a further example, E3 carboxylesterase and phosphoric triester hydrolase functional equivalents have been expressed in host insect Spodoptera frugiperda sf9 cells (Campbell, P.

M. et al., 1998; Newcomb, R. D. et al., 1997). In an additional example, a phosphoric triester hydrolase functional equivalent of a butyrylcholinesterase has been expressed in. Chinese hamster ovary (“CHO”) cells (Lockridge, O. et al., 1997). In certain embodiments, an eukaryotic cell that may be selected for expression is a plant cell, such as, for example, a corn cell.

It is contemplated that any size flask or fermentor may be used to grow a tissue or organism that can express a recombinant proteinaceous molecule of the present invention. In certain embodiments, bulk production of compositions with enzymatic sequences is contemplated.

In an example, a fusion protein comprising, N-terminus to C-terminus, a (His)6 polyhistidine tag, a green fluorescent protein (“GFP”), an enterokinase recognition site, and a OPH lacking the 29 amino acid leader sequence, has been expressed in Escherichia coli. The GFP sequence produced fluorescence that was proportional both the quantity of the fusion protein, and the activity of the OPH sequence. The fusion protein was more soluble than OPH expressed without the added sequences, and was expressed within the cells (Wu, C.-F. et al., 2000b; Wu, C.-F. et al., 2001a).

It is contemplated that the temperature selected may influence the rate and/or quality of recombinant enzyme production. It is contemplated that in some embodiments, expression of an enzyme may be conducted at 4° C. to 50° C., including all intermediate ranges and combinations thereof. Such combinations may include a shift from one temperature (e.g., 37° C.) to another temperature (e.g., 30° C.) during the induction of the expression of proteinaceous molecule. For example, both eukaryotic and prokaryotic expression of OPH may be conducted at temperatures 30° C., which has increased the production of enzymatically active OPH by reducing protein misfiling and inclusion body formation in some instances (Chen-Godspeed, M. et al., 2001b; Wang, J. et al., 2001; Omburo, G. A. et al., 1992; Rowland, S. S. et al., 1991). In an additional example, prokaryotic expression of recombinant squid-type DFPase fusion protein at 30° C. also enhanced yields of active enzyme (Hartleib, J. and Rutedjans, H., 2001a). It is contemplated that fed batch growth conditions at 30° C., in a minimal media, using glycerol as a carbon source, will be suitable for expression of various enzymes.

After production of a biomolecule by a living cell, the composition comprising the biomolecule may undergo one or more processing steps to prepare a biomolecule composition of the present invention. Examples of such steps include permeabilizing, disrupting, sterilizing, concentrating, drying, resuspending, or a combination thereof. Various embodiments of a biomolecule composition of the present invention are contemplated after one or more such processing steps. However, it is further contemplated that each processing step will increase economic costs and/or reduce total biomolecule yield, so that embodiments comprising fewer steps are preferred. It is further contemplated that the order of steps may be varied and still produce a biomolecule composition of the present invention.

In certain embodiments, a biomolecule composition of the present invention may comprise various cellular components (e.g., cell wall material, cell membrane material, nucleic acids, sugars, polysacharrides, peptides, polypeptides, proteins, lipids, etc). Such a biomolecule composition of the present invention is known herein as a “crude cell preparation”. A -“a crude cell preparation comprises the biomolecule within or otherwise in contact with a cell and/or cellular debris. In certain aspects, it is contemplated that the total content of desired biomolecule (e.g., an active biomolecule) may range from 0.0001% to 99.9999% of a crude cell preparation, including all intermediate ranges and combinations thereof, by volume or dry weght, depending upon factors such as expression efficiency of the biomolecule in the cell and the amount of processing and/or purification steps. A higher content of desired biomolecule in the biomolecular composition is preferred. But, in certain embodiments, it is also preferred that the biomolecule composition comprise cellular components, particularly cell wall and/or cell membrane material, to provide material that may be protective to the biomolecule, enhances the particulate nature of the biomolecule composition, or a combination thereof. Thus, the biomolecule composition may comprise 0.0001% to 99.9999% of cellular components, including all intermediate ranges and combinations thereof, by volume or dry weight. However, in certain embodiments, lower ranges of cellular components is preferred, as the biomolecular composition would therefore comprise a greater percentage of a desired biomolecule.

In embodiments wherein the cellular material is derived from a microorganism, such as through expression of the biomolecule by a microorganism, the biomolecular composition is known herein as a “microorganism based particulate material”. The association of a biomolecule with a cell or cellular material is generally produced through endogenous expression, expression due to recombinant engineering, or a combination thereof. In preferred embodiments, a crude cell preparation comprises a biomolecule partly or whole encapsulated by a cell membrane and/or cell wall, whether naturally so and/or through recombinant engineering. Such a biomolecule (e.g., the active biomolecule) encapsulated within or as a part of a cell wall and/or cell membrane is referred to herein as a “whole cell material” or “whole cell particulate material”.

It is contemplated that a biomolecule prepared as a crude cell preparation may have greater stability than a preparation wherein the biomolecule has been substantially separated from a cell membrane and/or cell wall. It is further contemplated that a biomolecule prepared as a crude cell preparation, wherein the biomolecule is localized between the cell wall and cell membrane and/or within the cell so that the cell wall separates the biomolecule from the extracellular environment, may have greater stability than a preparation wherein the biomolecule has been substantially separated from a cell membrane and/or cell wall.

Additionally, it is contemplated that a biomolecule composition of the present invention may be encapsulated using a microencapsulation technique as would be known to one of ordinary skill in the art. Such encapsulation may enhance or confer the particulate nature of the biomolecule composition, provide protection to the biomolecule, increase the average particle size to a desired range, allow release of the biomolecule from the encapsulating material, alter surface charge, hydrophobicity, hydrophilicity, solubility and/or disperability of the particulate material, or a combination thereof. Examples of microencapulation (e.g., microsphere) compositions and techniques are described in Wang, H. T. et al., J. of Controlled Resease 17:23-25, 1991; and U.S. Pat. Nos. 4,324,683; 4,839,046; 4,988,623; 5,026,650; 5153,131; 6,485,983; 5,627,021; and 6,020,312).

In preferred aspects, a biomolecular composition of the present invention comprises a crude cell preparation wherein the cell membrane and/or cell wall has been altered through a permeablizating process, a disruption process, or a combination thereof. An example of such an altered crude cellular preparation includes disrupted cells, permeabilized cells, or a combination thereof. As used herein, a “disrupted cell” is a crude cell preparation wherein wherein the cell membrane and/or cell wall has been altered through a disruption process. As used herein, a “permeabilized cell” is a crude cell preparation wherein the cell membrane and/or cell wall has been altered through a permeabilizating process. It is contemplated that a biomolecule composition of the present invention prepared as a crude cellular preparation may have greater stability than a preparation wherein the biomolecule has been substantially purified from the cell wall and/or membrane.

A processing step may comprise a permeabilizing step, wherein a cell is contacted with a permeabilizing agent such as dimethyl sulfoxide (“DMSO”), ethylenediaminete-traacetic acid (“EDTA”), tributyl phosphate, or a combination thereof. A permeabilizing step may increase the mass transport of a substrate into the interior of a cell, where an enzyme localized inside the cell can catalyze a chemical reaction with the substrate. (Martinez, M. B. et al., 1996; Martinez, M. B. et al., 2001; Hung, S.-C. and Liao, J. C., 1996). Cell permeabilizing using EDTA (Leduc, M. et al., 1985).

OP compound degradation rate has been limited by OPH intracellularly expressed in whole cells (Elashvili, I. and DeFrank, J. J., 1996; Elashvili, I. et al., 1998; Hung, S.-C. and Liao, J. C., 1996; Richins, R. et al., 1997). However, it is contemplated that a composition of the present invention comprising a whole cell particulate material will provide protection from diffusion of compounds that may damage a biomolecule, while allowing sufficient permeability to allow biomolecule function.

In some embodiments, a processing step comprises disrupting a cell. A cell may be disrupted by any method known in the art, including, for example, a chemical method, a mechanical method, a biological method, or a combination thereof. Examples of a chemical cell disruption method include suspension in a solvent for certain cellular components. In specific facets, such a solvent may comprise an organic solvent (e.g., acetone), a volatile solvent, or a combination thereof. In a particular facet, a cell be be disrupted by acetone (Wild, J. R. et al., 1986; Albizo, J. M. and White, W. E., 1986). In certain preferred facets, the cells are disrupted in a volatile solvent for ease in evaporation. Examples of a mechanical cell disruption method include pressure (e.g., processing through a French press), sonication, mechanical shearing, or a combination thereof. An example of a pressure cell disruption method includes processing through a French press. Examples of a biological cell disruption method include contacting the cell with one or more enzymes (e.g., lysozyme) that weaken, damage, and/or permeabilize a cell membrane, cell wall or combination thereof. Biological material comprising a proteinaceous molecule of the present invention may be homogenized, sheared, undergo one or more freeze thaw cycles, be subjected to enzymatic and/chemical digestion of cellular materials (e.g., cell walls, sugars, etc), undergo extraction with organic or aqueous solvents, etc, to weaken interactions between the proteinaceous molecule and other cellular materials and/or partly purify the proteinaceous molecule. A processing step may comprise sonicating a composition comprising an enzyme. Other dissepting and drying will be done by freezedrying with or without a cryoprotector (typically a sugar).

A processing step may comprise sterilizing an enzyme composition of the present invention. Sterilizing kills living matter, and may be desirable as continued post expression growth of a host cell and/or a contaminating organism may detrimentally affect the composition. For example, one or more properties of a coating may be undesirably altered by the presence of a living organism. Additionally, sterilizing reduces the ability of a living recombinant organism to be introduced into the environment, when such an event is not desired. Sterilizing may be accomplished by any method known in the art. Examples of sterilizing may include contacting the living matter with a toxin, irradiating the living matter, heating the living matter above 100° C., or a combination thereof. It is preferred that sterilizing comprises irradiating the living matter, as radiation generally does not leave a toxic residue, and is not contemplated to detrimentally affect the enzymes stability such as that which might occur during heating. Examples of radition include infrared (“IR”) radiation, ionizing radiation, microwave radiation, ultra-violet (“UV”) radiation, particle radiation, or a combination thereof. Particle radiation, UV radiation and/or ionizing radiation are preferred, and particle radiation is particularly preferred. Examples of particle radiation include alpha radiation, electron beam/beta radiation, neutron radiation, proton radiation, or a combination thereof.

A processing step may comprise concentrating a biomolecule composition of the present invention. As used herein, “concentrating” refers to any process wherein the volume of a composition is reduced. Often, undesired components that comprise the excess volume are removed, the desired composition is localized to a reduced volume, or a combination thereof.

For example, it is contemplated that a concentrating step may be used to reduce the amount of a growth and/or expression medium component from a composition of the present invention. It is contemplated that nutrients, salts and other chemicals that comprise a biological growth and/or expression medium may be unnecessary and/or unsuitable in a composition of the present invention, and reducing the amount of such compounds is preferred. A growth medium may promote undesirable microorganism growth in a composition of the present invention, while salts or other chemicals may undesirably alter the formulation of a coating.

Concentrating a biomolecule composition may be by any method known in the art, including, for example, filtrating, a gravitational force, a gravimetric force, or a combination therof. An example of a gravitational force is normal gravity. An example of a gravimetric force is the force exerted during centrifugation. Often a gravitational or gravimetric force is used to concentrate a composition comprising the desired biomolecule from undesired components that are retained in the volume of a liquid medium. After cells are localized to the bottom of a centrufugation devise, the media may be removed via such techniques as decanting, aspiration, etc.

In additional embodiments, the disrupted cells and/or cell debris are dried, ground and/or milled to a powder. In specific facets, the cells added to the paint comprise disrupted cells, cell debris, and/or powder. The powder may be Preferrably stored at room temperature without need for dessication.

A purification step may comprise resuspending a precipitated composition comprising an enzyme from cell debris.

The invention provides, in certain preferred embodiments, a composition comprising a coating and an enzyme prepared by the following steps: obtaining a culture of cells that express the enzyme; concentrating the cells and removing the culture media; disrupting the cell structure; drying the cells; and adding the cells to the coating. In some aspects, the composition is prepared by the additional step of suspending the disrupted cells in a solvent prior to adding the cells to the coating.

In certain aspects, the composition is prepared by adding the cell culture powder to glycerol, admixing with glycerol and/or suspending in glycerol. In other facets, the glycerol is at a concentration of about 50%. In specific facets, the cell culture powder comprised in glycerol at a concentration of about 3 mg of the milled powder to 3 ml of 50% glycerol. In certain facets, the composition is prepared by adding the powder comprised in glycerol to the paint at a concentration of about 3 ml glycerol comprising powder to 100 ml of paint. The powder may also be added to a liquid component such as glycerol prior to addition to the paint. The numbers are exemplary only and do not limit the use of the invention. The concentration was chosen merely to be compatible with the amount of substance that can be added to one example of paint without affecting the integrity of the paint itself. Any compatible amount may used within the scope of the present invention.

It is contemplated that in some embodiments, processing of an enzyme composition may be conducted at 4° C. to 50° C., including all intermediate ranges and combinations thereof In preferred embodiments, a processing step may comprise maintaining a composition comprising an enzyme at a temperature less than the optimum temperature for the activity of a living organism and/or enzyme that may detrimentially affect an enzyme of the present invention. Often 37° C. is the maximum temperature for the processing of a eukarotic biomolecule (e.g., an enzyme). Thus temperatures less than 37° C. are preferred, temperatures less than 30° C. are more preferred, temperatures less than 20° C. even more preferred, temperatures less than I 0C are particularly preferred, and temperatures of 4° C. more preferred.

In other embodiments, a proteinaceous molecule of the present invention may be a purified a proteinaceous molecule. A “purified proteinaceous molecule” as used herein refers to any proteinaceous molecule of the present invention removed in any degree from other extraneous materials (e.g., cellular material, nutrient or culture medium used in growth and/or expression, etc). In certain aspects, removal of other extraneous material may produce a purified proteinaceous molecule of the present invention wherein its concentration has been enhanced 2- to 10,000-fold or more, including all intermediate ranges and combinations thereof, from its original concentration in a material (e.g., a recombinant cell, a nutrient or culture medium, etc). In other embodiments, a purified proteinaceous molecule of the present invention may comprise 0.001% to 100%, including all intermediate ranges and combinations thereof of a composition comprising a proteinaceous molecule of the present invention. The degree or fold of purification may be determined using any method known to those of skill in the art or described herein. For example, it is contemplated that techniques such as measuring specific activity of a fraction by an assay described herein, relative to the specific activity of the source material, or fraction at an earlier step in purification, may be used.

Techniques for preparation of a proteinaceous molecule of the present invention are described herein. However, it is contemplated that one or more additional methods for purification of biologically produced molecule(s) that are known in the art or described herein may be applied to obtain a purified proteinaceous molecule of the present invention [Azzoni, A. R. et al., 2002; In “Current Protocols in Molecular Biology” (Chanda, V. B. Ed.) John Wiley & Sons, 2002; In “Current Protocols in Nucleic Acid Chemistry” (Harkins, E. W. Ed.) John Wiley & Sons, 2002; In “Current Protocols in Protein Science” (Taylor, G. Ed.) John Wiley & Sons, 2002; In “Current Protocols in Cell Biology” (Morgan, K. Ed.) John Wiley & Sons, 2002; In “Current Protocols in Pharmacology” (Taylor, G. Ed.) John Wiley & Sons, 2002; In “Current Protocols in Cytometry” (Robinson, J. P. Ed.) John Wiley & Sons, 2002; In “Current Protocols in Immunology” (Coico, R. Ed.) John Wiley & Sons, 2002]. A biological material comprising a proteinaceous molecule of the present invention may be homogenized, sheared, undergo one or more freeze thaw cycles, be subjected to enzymatic and/chemical digestion of cellular materials (e.g., cell walls, sugars, etc), undergo extraction with organic or aqueous solvents, etc, to weaken interactions between the proteinaceous molecule and other cellular materials and/or partly purify the proteinaceous molecule. A processing step may comprise sonicating a composition comprising an enzyme.

Cellular materials may be further fractionated to separate a proteinaceous molecule of the present invention from other cellular components using chromatographic e.g., affinity chromatography (e.g., antibody affinity chromatography, lectin affinity chromatography), fast protein liquid chromatography, high performance liquid chromatography “HPLC”), ion-exchange chromatography, exclusion chromatography; or electrophoretic (e.g., polyacrylamide gel electrophoresis, isoelectric focusing) methods. It is contemplated that a proteinaceous molecule of the present invention may be precipitated using antibodies, salts, heat denaturation, centrifugation and the like. A purification step may comprise dialyzing a composition comprising an enzyme from cell debris.

For example, the molecular weight of a proteinaceous molecule can be calculated when the sequence is known, or estimated when the approximate sequence and/or length is known. SDS-PAGE and staining (e.g., Coomassie Blue) has been commonly used to determine the success of recombinant expression and/or purification of OPH, as described (Kolakowski, J. E. et al., 1997; Lai, K. et al., 1994).

In certain embodiments, an enzyme may be in the form of a crystal. In other aspects, one or more enzyme crystals may be cross-linked to form a crosslinked enzyme crystal (“CLEC”) (Hoskin, F. C. G. et al., 1999).

In preferred embodiments, a coating comprises a biomolecule composition of the present invention. A coating (“coat,” “surface coat,” “surface coating”) is “a liquid, liquefiable or mastic composition that is converted to a solid protective, decorative, or functional adherent film after application as a thin layer” (“Paint and Coating Testing Manual, Fourteenth Edition of the Gardner-Sward Handbook” (Koleske, J. V. Ed.), p. 696, 1995; and in “ASTM Book of Standards, Volume 06.01, Paint—Tests for Chemical, Physical, and Optical Properties; Appearance,” DI 6-00, 2002). Additionally, a thin layer is 5 um to 1500 um thick, including all intermediate ranges and combinations thereof. However, in most embodiments, it is contemplated that a coating will form a thin layer 15 um to 150 um thick, including all intermediate ranges and combinations thereof. Examples of a coating of the present invention include a clear coating or a paint.

As used herein, a surface is the physical boundary of an object or body. As would be known to those of ordinary skill in the art, the term “substrate,” in the context of a coating, is synonymous with the term “surface.” However, as “substrate” has a different meaning to those of skill in arts of enzymology and coatings, the term “surface” will be preferentially used herein for clarity. A surface wherein a coating has been applied, whether or not film formation has occurred, is known herein as a “coated surface.”

Suitable Coatings for use in the present invention include: paints and clear-coatings. Clear coatings include varnishes, lacquers, shellacs, stains, and water repellent-coatings.

Additionally, suitable coatings may be defined by their use and include those coatings known in the art as architectural coatings, industrial coatings, and specification Coatings. Architectural coatings include wood coatings, masonry coatings, and artist's coatings. Industrial coatings include automotive coatings, can coatings, sealant coatings, and marine coatings. Specification coatings include pipeline coatings, traffic marker coatings, aircraft coatings, nuclear power plant coatings, and military specification coatings.

Suitable coatings for use in the present invention may have one or more of the coating components. Coating Components include Binders, Liquid Components, Colorants, and Coating Additives.

Binders include Oils, Alkyd Resins, Oleoresinous Binders, Fatty Acid Epoxy Esters, Polyester Resins, Modified Cellulose Binders, Polyamide and amidoamine binders, Amino Resins, Urethane Binders, Phenolic Resins, Epoxy Resins, Polyhydroxyether Binders, Acrylic Resins, Thermoplastic Acrylic Resins, Thermosetting Acrylic Resins, Acrylic-Epoxy Combinations, Acrylic-Amino Combinations, Acrylic-Urethane Combinations, Water-Borne Thermosetting Acrylics, Polyvinyl Binders, Rubber Resins, Bituminous Binders, Polysulfide Binders, and Silicone Binders.

Liquid Components include Solvents, Thinners, Diluents, and Plasticizers. These include Hydrocarbons (Aliphatic Hydrocarbons, Cycloaliphatic Hydrocarbons, Terpene Hydrocarbons, Aromatic Hydrocarbons), Oxygenated Solvents (Alcohols, Ketones, Esters, Glycol Ethers, Ethers), Cholrinated Hydrocarbons, and Nitrated Hydrocarbons.

Colorants include Pigments and Dyes.

Coating Additives include Preservatives, Wetting Additives and Dispersants, Buffers, Rheology Modifiers, Defoamers, Catalysts, Antiskinning Agents, Light Stabilizers, Corrosion Inhibitors, Dehydrators, Electrical Additives, and Anti-Insect Additives.

U.S. Publication No. 2004/0109853 contains an extensive disclosure of coatings and coating components that are suitable for use in the present invention. All such coatings and coating components are incorporated herein by reference and are contemplated for use in achieving the benefits of the present invention. Without limiting the present invention, a selection of preferred coatings is discussed below.

A set of preferred coatings are latex based coatings. Particularly preferred are commercially available latex acrylic paints. The cell powder of the present invention may be added directly to latex acrylic paint to produce a bioactive coating. Mixing of the paint and cell powder until the resulting bioactive coating is approximately homogenous is preferred.

Optionally, a cell powder may be added to a coating component and/or another compound or solution that is being added to the coating. The coating components and/or other compounds and solutions that the cell powder may be added to are those known in the art of coating formulation that are used to impart desired physical and/or chemical characteristics to the resulting coating, for example a plasticizing agent. A preferred solution for the cell powder to be added to is a glycerol solution.

It will be understood by those of skill in the art that the cell powder may be: 1) added to a coating component, compound and/or solution prior to the coating component, compound and/or solution being added to the coating, 2) added to the coating simultaneously with a coating component, compound and/or solution, 3) added in an alternating fashion with a coating component, compound or solution being added to the coating, or 4) some combination thereof.

For preparation of smaller quantities of bidactive coating (e.g., less than a liter of coating) adequate mixing (i.e., an acceptably homogeneous bioactive coating) has been achieved by hand mixing in ordinary laboratory vessels using common stirring devices (e.g., beaker and a stirring rod). When preparing volumes of bioactive coating greater than a gallon, it is preferred to use commercially available devices for stirring such quantities of coating. For example, adequate homogeneous mixing of a bioactive latex acrylic paint in volume greater than a gallon has been achieved using a commonly available paint blending attachment designed for use with a power drill. Such suitable attachments are commonly available from most hardware stores.

In a preferred method the cell powder is first added into a glycerol solution and the combined glycerol solution and enzyme powder are then mixed into a coating.

There are various methods of coating application, including but not limited to brush application, roller application, conventional spray, high volume-low pressure spray, airless spray, plural component spray, and electrostatic spray. The most common technologies, techniques, advantages and limitations, equipment, typical coating types involved, and safety considerations for each type of application method are discussed below.

With regard to brush application, there are a variety of brush sizes, shapes, bristle types, and uses. The brush most commonly used for'structural steel and similar surface applications is the conventional wall brush. Oval brushes are commonly used for structural and marine applications, particularly around irregular surfaces such as rivets, boltheads, piping, railing, and similar areas. Widths for the conventional wall brush vary from 25.4 to 152.4 mm (I to 6 in.), but the most commonly used size is 101.62 mm (4 in.) The two types of bristles used in brush assemblies are synthetic (nylon) fibers and natural (hog) bristle fibers. Synthetic bristles have excellent abrasion resistance when coatings are applied to rough, uneven steel; concrete; and masonry surfaces. Although not affected by most solvents, coatings containing such strong solvents as ketones may affect the synthetic fibers. Natural (hog) bristles, although more expensive and water sensitive, provide the best leveling application characteristics and strong solvent resistance. Proper brush and bristle selection for a specific coating application is imperative for a quality application.

Good brush loading and coating distribution techniques will provide an even application free of laps, runs, drips, and other unacceptable finish characteristics. The brush should be held lightly but firmly, and the paint should be spread over the surface with moderate, even pressure by stroking in one direction, followed by stroking at right angles to the previous coat.

An advantage of brush application is the ability to stripe coat. In many instances, brushing difficult areas (e.g., edges, rivets, corners, boltheads, and welds) prior to the application of a general spray coat is recommended; this process is known as striping. Striping is performed to assure adequate coverage and thickness of the applied coating for areas that are difficult to coat properly by general spray application alone. However, brushing, including brush striping, is not recommended for application of vinyl zinc-rich and epoxy zinc-rich coatings because the zinc must be kept in suspension during application. This is accomplished using agitators in the spray pot or pump. Another advantage of brush application is that it aids in thorough wetting of the surface, particularly on surfaces that are porous.

Limitations of brush application are that it is slow and tedious, and it may not produce a uniform coating thickness. Brush application of a coating is not practical for large surfaces, and it may leave unsightly brush marks with coatings that do not level well. Brush application of certain coatings, such as high-solids and fast-drying coatings, is difficult and generally is not recommended.

Oil-based and waterborne coatings typically are the most common coating types applied by brush, and their application characteristics are considered good to excellent. The oil-based, slow-drying paint should be brushed out thoroughly to work the coating into cracks, crevices, or other irregular surfaces. Faster drying paints (waterborne) should be brushed out quickly and evenly; otherwise, overbrushing will leave brush marks as the paint dries.

With rgard to roller application, the roller assembly consists of a cover and core. Roller covers vary in diameter, length, type of fabric, and fiber length (nap). The 38.1-mm (1½-in.) diameter and 228.6-mm (9-in.) length is the most common size. Polyester, nylon, mohair, and lambskin are typical cover fabrics. Selection of fabric and fiber length depends on the type of coating and the condition of the surface. Woven fabrics shed fewer lint particles, so they typically are designated for all coatings, especially gloss coating. In addition, longer fibers hold more coating, but they do not provide as smooth a finish. The length of fiber used on steel surfaces varies from 6.35 to 19.05 mm (¼ to ¾ in.). Additionally, the roller core must be resistant to strong solvents when applying epoxies, vinyls, urethanes, and similar materials. There are three special types of rollers, including the pipe roller, fence roller, and pressure roller.

The pipe roller is constructed of two to five narrow rollers on a single spring spindle. The rollers readily conform to contoured surfaces, such as piping. The size of the pipe determines the number of segments required, and the threaded handle accommodates the use of an extension pole.

Fence rollers require roller covers with extra long nap (31.75 mm [1¼ in.]). These covers enable rapid coating of wire fence from one side because the long nap surrounds the fence wire and coats it on both sides concurrently.

A pressure roller permits continuous coating by steadily supplying coating from a pressurized tank to directly inside the roller. The roller cover is made of a perforated core that enables a coating to pass from inside the roller to the nap. The valve that controls the pressure is located on either the roller handle or the tank.

The roller should be uniformly loaded with paint to provide even application. Skipping will occur when paint is inadequately loaded onto the roller. However, tracking will occur if an excessive amount of paint is loaded onto the roller. Proper application pressure and technique should be used; initially, a zigzag overlapping application should be performed followed by a second coat applied at right angles to the first coat.

Rollers are excellent for large, flat areas (e.g., tank sidewalls and tops, decks, ship hulls, walls, and ceilings) or whenever application does not require the skill needed for brush or spray application. Rollers also are recommended for use in windy conditions to eliminate excessive material loss and overspray. Rollers may be used for indoor application when overspray cannot be tolerated. Roller application on concrete cracks and voids is difficult because of the shape of the roller; therefore, a brush is recommended to work the coating into these areas. Roller application is more rapid than brush application but slower than spray application. A roller generally holds more coating than a brush, and it will provide a more satisfactory finish on smooth surfaces compared with rough or irregular surfaces. Brush or spray application is the preferred method for rough or irregular surfaces.

Roller application characteristics for oil-based and waterborne coatings are excellent, and epoxies and urethanes are considered to be fair to good. Roller application characteristics for high solids coatings and inorganic zinc rich coatings are considered poor. High performance coatings/linings for immersion are seldom applied by roller because of nonuniform thickness and wicking caused by roller nap residue.

With regard to conventional spray application, the conventional method of spraying relies on air for coating atomization. Jets of compressed air introduced into the stream of coating at the nozzle break the coating into tiny droplets that are carried to the surface by the current of air. The transfer efficiency is estimated to be 25 to 30 percent. A typical, conventional spray setup consists of: air compressor, oil and water extractor (separation), pressure feed tank (pressure pot) or paint pump, connecting hoses, and spray gun.

Although the pot regulates both the air and fluid pressures fed to the spray gun, the air compressor generates the necessary pressure for these two flow operations. Air compressors can be of various types, and the-size usually depends on the amount of air required in cubic feet per minute to operate the spray gun. Hoses must be properly sized to deliver the right amount of air volume and pressure to the spray gun. Approximately 275.6 to 413.4 kPa (40 to 60 psi) and 4.012 liters/sec (8.5 cfin) are needed to operate most production conventional spray guns with a medium viscosity coating such as latex paints, some lacquers, stains, sealers, alkyds, and conventional epoxies, for example, such as those specified in MIL-P-24441A.

A separator should be in line, between the air compressor and the pressure pot, to prevent moisture and oil from reaching the coating. Moisture/oil separation for conventional spray should be considered mandatory. The use of properly sized and maintained moisture and oil separators helps ensure the quality of the finished product. In addition to adhesion defects, oil or moisture in the compressed air will mix with the coating during atomization and create voids, pinholes, and/or fisheyes in the applied film. A blotter test should be conducted at the spray gun prior to application to ensure a clean, dry supply of atomized air.

The amount of fluid material delivered to the spray gun is controlled by the fluid pressure regulator of the feed tank pressure pot, which is a double regulator type. The pressure pot should be 19 or 38 liters (5 or 10 gallons) in size for most jobs. For the application of certain coatings such as zinc-rich coatings, the pot should be equipped with a mechanical agitator to keep the zinc-rich coating in suspension so the zinc does not settle on the bottom of the pot. If application stops and resumes after 15 minutes when spraying zinc-rich coatings, the entire length of the hose should be whipped to redisperse the coating in the line. If more than 1 hour has passed, all the coating in the line should be blown back into the pot and reagitated prior to use. When coating tall structures, the pot should be kept at nearly the same level as the spray gun so lower pot pressures (55.12 to 82.68 kPa [8 to 12 psi]) can be used. Longer hoses and higher pot pressures are required when the pot is not at the work level. Excessive fluid pressure may cause the fluid stream to exit the fluid nozzle at a higher velocity than the air jets in the air nozzle can properly atomize. When the pot is not placed at or near the work level, the lower pot pressures can be maintained by using a fluid pump to pump the coating from the pot to the gun. These pumps are commonly used with hot spray setups.

Two types of hoses are used in conventional spray coating: the air hose and the fluid hose. The air hose (supply line) from the compressor to the pot typically is red and usually is 19 to 25 mm (¾ to 1 in.) i.d. The air hose from the pot to the spray gun also typically is red and it is preferred to be 6.35- to 7.9-mm (¼- to 5/16-in.) i.d. and as short as possible. The fluid hose usually is black and has a solventresistant liner. The inside diameter is preferred to be 7.9 to 9.5 mm ( 5/16 to ⅜ in.) for medium viscosity materials and also should be as short as possible. Hoses up to 12.7-mm (½-in.) i.d. are commonly used. Excessive hose length allows the solids to settle in the line prior to reaching the spray gun. This leads to clogging and the application of a nonhomogeneous film.

With regard to conventional hot spray, this technique is similar to the standard conventional spray and is used during cooler temperatures to lower viscosity of the paint without having to add additional thinners. This reduction in paint viscosity is achieved, typically, by heating the coating to approx66 to 71° C. (150 to 160° F.). The paint is hot when it leaves the spray gun, but the atomizing air cools the paint and evaporates the solvents. When the paint reaches the surface, it usually is only a few degrees warmer than if it was not heated. This process also provides less overspray because the material can be atomized at lower pressures. The hot spray process eliminates the need for additional thinners for application at colder temperatures. Excessive thinners reduce film buildup and cause solvent popping (craters) and orange peel. The equipment used in this process, in addition to the typical equipment, involves a heater and a hose from the heater to the spray gun; therefore, two material hoses are required. Hot spray application generally is restricted to the shop. Application without heating is used in the field because all types of paints can be used, including catalyzed paints. On the other hand. catalyzed coatings cannot be used with the hot spray method because the heat will cause the coatings to set up in the equipment.

By varying the volume of air and coating at the spray gun, the amount of atomized coating can be regulated. The selection of a fluid nozzle and needle size is another way to regulate the amount of coating exiting the fluid nozzle. Excessive amounts of coating flowing through the fluid nozzle at low pressures (55.12 to 82.68 kPa [8 to 12 psi]) can be reduced by adjusting the material flow knob on the gun. Alternatively, a smaller fluid nozzle/needle combination may be used. Coating manufacturers normally recommend at least one set of sizes known to work for their product. The air nozzle cap can be for either internal mix or external mix. The internal mix involves mixing of the coating and air inside the spray nozzle. The external mix involves mixing of air and paint outside the nozzle between the horns. The most common method is the external mix because it produces a fine atomization and, if properly controlled, will provide the best quality finish. Internal mix nozzles do not provide the same quality finish as the external mix, and they are not recommended for fast-dry-type coatings (lacquer) because the coating tends to clog the nozzle tip, which results in distorted spray patterns. With both types, the atomized air breaks the streams into tiny paint droplets and provides the velocity for the coating to reach the surface. The pattern of the spray (round or oval) is determined primarily by the air adjustments on the gun and the air cap design. The needle valve regulates the amount of coating material that flows through the fluid nozzle. The distance that the needle can be withdrawn from the fluid nozzle is controlled by the fluid control knob on the back of the spray gun. The air valve is operated by the gun trigger. When the trigger is pulled, the air flow begins then the fluid flow follows. This is a major advantage of conventional (air) spray. By half-triggering the gun, the atomized air flows (without coating). This airstream is used to remove dust and loose debris from the surface prior to the coating application. The trigger is fully depressed to apply the coating.

With regard to spray application techniques, after the fluid and air pressures are properly adjusted, several basic spray techniques should be used to ensure the application of a consistent film of coating. A spray pattern 203.2 to 254 mm (8 to 10 in.) wide should be created by adjusting the air pattern control knob. The spray gun should be held at right angles to the work surface. “Arcing” the gun or flipping the wrist at each end of a pass results in a nonuniform coating film and excessive overspray.

For large flat areas, each stroke should overlap the previous one by 50 percent. This produces a more uniform coating thickness. The stroke length may vary from 457.2 to 914.4 mm (18 to 36 in.), depending on the sprayer's arm length. To build a uniform coating thickness, a cross-hatch technique is usually used. The cross-hatch spray technique consists of a wet spray coat, using 50 percent overlap, followed by another full wet spray coat at right angles to the first.

The spray gun trigger should be released at the end of each pass. At the beginning of a pass, the gun should be in motion prior to pulling back on the spray gun trigger and continued briefly after releasing the trigger at the end of the stroke. This produces a uniform, continuous film. Proper triggering also reduces coating loss; prevents heavy buildup of coating at corners, edges, and ends of strokes; eliminates buildup of fluid on the nozzle and tip; and prevents runs and sags at the start of each stroke.

Proper spray techniques, which are necessary to produce a quality coating application, typically are acquired with experience. Quality coating application also depends on proper thinning of the coating, correct fluid pressure, and proper fluid nozzle size. Using proper techniques, a uniform coating thickness should be attained. Most types of paints, including epoxies and vinyls, can be effectively applied with a nozzle orifice size of 0.070 in. When spraying normal viscosity coatings, the orifice size generally should not exceed 0.070 in. because flooding may occur. Coal tar epoxies can be applied effectively using a 0.086-in. nozzle orifice.

The proper gun-to-surface distance for a uniform wet film generally varies from 203.2 to 254 mm (8 to 10 in.) for conventional spray (compared to 12 to 18 in. for airless spray). If the spray gun is held too close to the surface, the gun must be readjusted or heavy coating application with sags and runs will occur. If the spray gun is held too far from the surface, dry spray will result and cause holidays or microscopic pores in the coating.

Striping by spray also can be performed. A good practice is to apply an extra spray pass (stripe coat) prior to the first general spray coat not only on the edges but also on corners, interior angles, seams, crevices, junctions of joint members, rivets, weld lines, and similar irregular surfaces. This technique will assure adequate film buildup within complex, irregular areas. A full cross-hatch spray coat is applied after this striping.

An advantage of spray application of coatings is that it is a highly efficient method of applying high performance coating systems to a surface, and it results in a smoother, more uniform surface than obtained by brushing or rolling because these application methods tend to leave brush or stipple marks and result in irregular thicknesses. Large amounts of material can be applied in very short periods of time with spray application compared to brush and roller application. The ability to independently vary fluid and air gives conventional spray the ability to provide a wide selection of pattern shapes and coating wetness by infinitely varying the atomization at the gun. Conventional spray application has a high degree of versatility and relies on a combination of air caps and fluid nozzles available for different coatings. Spray gun triggering is more easily controlled for precise spraying of irregular shapes, corners, and pipes than with airless spray. The spray gun also can be used to blow off dust from the surface with compressed air prior to applying the coating. Conventional spraying provides a finer degree of atomization and a higher quality surface finish necessary for vinyl applications.

Limitations of spraying are that because larger amounts of air are mixed with the coating during application using conventional spray, coating losses from “bounce back” or “overspray material” that miss the surface can be high, depending on the configuration of the surface. This bounce back effect makes coating corners and crevices difficult. Conventional spray also is slower than airless spray application.

Most industrial coating materials can be applied using a conventional spray. Fluid tips with various orifice sizes can be used effectively with epoxies, vinyls, and coal tar epoxies. Larger size tips can be selected for more viscous, mastic-type coatings. The coating manufacturer often recommends application equipment and will specify tip sizes for optimum application characteristics.

When coating application is completed, all equipment components should be thoroughly cleaned. To properly care for the spray application equipment, the gun, hoses, and auxiliary equipment should be flushed thoroughly with an appropriate solvent after each use; otherwise, dried/cured coating materials will accumulate and cause the equipment to become inoperable. Thinner or a suitable solvent should be run through the tank, hose, and gun until the solvent runs clean with no visible coating color. All pressure should be released from the tank, line, and gun; and the gun should be disconnected from the line and disassembled. All components should be thoroughly cleaned with solvent, air blown, and reassembled for future use. The exterior surface of the gun should be wiped down with solvent-dampened rags.

Only recommended pressure and equipment should be used for conventional spray. Also, hose fittings should never be loosened while under pressure.

With regard to High volume-low pressure sprayin, a high volumelow pressure (HVLP) setup consists of a high volume air source (turbine generator or compressed air), a material supply system, and an HVLP spray gun. The spray techniques associated with HVLP are closely compared to that of conventional spray and are a growing trend in coating application techniques. HVLP uses approximately the same volume of air as conventional spray, but lower pressures are used to atomize the fluid. Reducing air pressure at the nozzle effectively reduces the velocity of the airstream and atomized fluid. This reduces the bounce back of coating material from the surface, which results in a significantly higher transfer efficiency (55 to 70 percent) and application into recessed areas. The high transfer efficiency attained reduces material costs and waste, and an HVLP spray is easy to set up and simple to operate. However, HVLP spray has a lower production rate than airless spray; and some coatings are difficult to atomize, which can limit the use-of HVLP spray.

With regard to Airless spray, Airless spray equipment consists of a power source (an electric motor or air compressor), an air hose and siphon hose, a high pressure fluid pump with air regulator (if a compressor is used), a fluid filter, a high pressure fluid hose, and an airless spray gun with spray tip and safety tip extension. Each of these components will be discussed.

The power source may consist of either an electric motor or an air compressor. An electric motor may be used to drive the fluid pump. The electric airless is a selfcontained spray outfit mounted on wheels that operates on 120-V electrical power. Conversely, a remote air compressor can be used to drive the fluid pump. The larger, air-operated units are more commonly used on large USACE structures, and the smaller mobile units are used on small projects. The larger units are required to operate multiple pumps or other air-driven devices; they also provide the larger air supplies necessary to apply mastics and high-build coatings.

A 12.7-mm (½-in.) air hose generally is used to deliver air from the compressor to the pump. The most common hose length is 50 ft. However, as hose length and pump size increase, a larger diameter hose should be used.

The material siphon hose should be 12.7- to 19.05-mm (½- to ¾-in.) i.d. to provide adequate fluid delivery. The hose must be resistant to the solvent and coating being used. A paint filter, often with the spray gun, should be used to prevent dirt or other contaminants-including improperly dispersed pigment (slugs)—from clogging the tip. In some instances the siphon hose is eliminated and the pump is immersed directly into the paint. This is known as a submersible airless pump.

The fluid pump is the most important part of the hydraulic airless system. The fluid pump multiplies the air input pressure to deliver material at pressures up to 31,005 kPa (4,500 psi). A common airless pump has an output-to-input pressure ratio of 30:1; that is, for every pound of input pressure, the pump provides 30 lb of output pressure; therefore, this unit will deliver 20,670 kPa (3,000 lb/in.) of hydraulic pressure with 689 kPa (100 psi) of air pressure. Other pumps with a ratio of 45:1 provide pressures up to 31,005 kPa (4,500 psi) (689 kPa [100 psi] input). Air-operated pumps can produce material output ranging from 793.8 g (28 oz) per minute (one spray gun) up to 11.34 liters (3 gallons) per minute (three to four spray guns).

A double-action, airless pump incorporates an air motor piston, which reciprocates by alternate application of air pressure on the top then the bottom of the piston. The air motor piston is connected directly to the fluid pump by a connecting rod. The fluid section, or pump, delivers fluid on both the up and down strokes.

The high pressure fluid hose is manufactured to safely withstand high fluid operating pressures. The hose typically is constructed of vinyl-covered, reinforced nylon braid and can withstand pressures up to 31,005 kPa (4,500 psi); therefore, it is important not to bend the hose or restrict the material flow in any way or the hose may rupture. The hose also is constructed to resist strong solvents. A wire may be molded into the hose assembly to prevent a possible static electrical charge. The spray gun should be equipped with a high pressure swivel to accommodate any twisting action of the hose. The inside diameter of the hose should be at least ¼ in. for most common coatings, except the viscous mastic-type coatings. The hose should not be longer than necessary; however, this is not as critical as for conventional spray. High pressure hose diameters up to 12.7 mm (½ in.) are used for more viscous mastic-type coatings.

The airless spray gun is designed for use with high fluid pressures. The airless spray gun is similar to a conventional spray gun in appearance, but it has only a single hose for the fluid. The hose may be attached to the front of the spray gun or to the handle. The resulting airless spray (atomization) occurs when fluid is forced through the small orifice of the fluid tip at high pressures.

An airless hot spray can be used to apply coatings at higher temperatures to reduce viscosity without additional thinners. Equipment is similar to that used in the standard airless spray setup, except that a unit to heat the material is required.

Regarding tip size nomenclature, a variety of airless spray tips are available. Tip selection is based on the type of material being sprayed and the size of spray pattern desired. The tip orifice opening and the fan angle control the pattern size and fluid flow. There are no controls on the spray gun itself. Tip orifices vary in size to accommodate the viscosity of the coating being applied. Fan angles range from 10 degrees (101.6 mm [4 in.] spray width) to 95 degrees (431.8 mm [17 in.] spray width). For example, two nozzle tips with the same size orifice but with different spray angles will deliver the same amount of coating over a different area width. For example, two tips with an identical orifice size of 0.381 mm (0.015 in.) but different spray angles (10 and 40 degrees) will provide fan widths of 101.6 and 215.9 mm [4 and 8½ in.], respectively, and will have identical flow rates of 0.0145 liters/sec (0.23 gallons per minute) at 13,780 kPa (2000 psi). Typically, when spraying a dam gate with an epoxy using a 0.381-mm (0.015-in.) orifice tip, fan angles ranging from 10 degrees (101.6 mm [4 in.]) to 50 degrees (254 mm [10 in.]) would be used. The quantity of sprayed coating is determined by the orifice size of the spray tip. A larger orifice results in more fluid being delivered at a faster speed; however, this leads to poorer atomization. Dual or adjustable tips can be used with airless spray equipment. Dual tips frequently are ball tips with two separate orifices. This feature provides the sprayer with the option of two different spray patterns: a narrow fan for smaller surfaces and a wide fan for production spraying. Adjustable tips vary the spray fan and, simultaneously, the tip orifice. The tip size increases as the fan width increases.

Application techniques for airless spray are similar to those for conventional spray, except that the spray gun should be held 304.8 to 457.2 mm (12 to 18 in.) from the surface as opposed to 203.2 to 254 mm (8 to 10 in.) for conventional spray because of the increase in the amount of coating being applied.

Airless spray equipment provides higher film buildup capabilities, greater surface penetration, and rapid coverage; it can handle products formulated with higher viscosity without the addition of large quantities of solvents; and it has low pressure loss when the pump is not at the same level as the actual spraying. Also, the single hose can be longer than a conventional sprayer and easier to handle. Mastic-type coatings such as coal tar epoxies (CTEs) are easily atomized by airless spray equipment. When spraying concrete and other masonry surfaces, airless spray efficiently and easily penetrates voids and general porous surfaces. Hydraulic pressure is used to force coating through an orifice in the spray nozzle. The high degree of pressure atomizes the coating as it is discharged through the spray nozzle without the need for atomized air. The coating beads into small droplets when released under these pressures (2,756 to 31,005 kPa [400 to 4,500 psi]) and results in a finely atomized spray and a transfer efficiency of 30 to 50 percent. Typical pressure for epoxies, for example such as those specified in MIL-P-24441A, are 12,402 to 17,225 kPa (1,800 to 2,500 psi), and 19,292 to 20,670 kPa (2,800 to 3,000 psi) for high solid epoxy mastics. Because of the high fluid pressure of airless spray, coatings can be applied more rapidly and at greater film buildup than with a conventional sprayer. The high pressure coating stream generated by an airless spray will penetrate cavities (which are typical on lightweight concrete blocks) and corners with little surface rebound.

Variances of the structure being painted in the field may create problems because of the difficulty in changing spray fan patterns and orifice openings in the field. For example, when spraying a large structure, a wide fan width will work well and provide l0 the desired finish; however, when a complex design of a small surface area is encountered (e.g., back-to-back angles and other attachments) a small fan width is necessary to provide a quality finish. Because an airless sprayer does not atomize coatings as well as a conventional sprayer, it should not be used for detail or fine finish work. Additionally, if painters use excessive pressure or improper technique, solvent entrapment, voids, runs, sags, pinholes, and wrinkles may occur.

The spray gun should not be removed from the hose, or the tip from the gun, until the pressure from the pump and in the line has been released. High pressure through a small orifice can cause paint to penetrate the skin if pressed against the body; therefore, spray gun tips are equipped with trigger locks and tip guards. All high pressure airless systems should be sprayed and flushed in a well ventilated area. These systems also should be grounded to avoid dangerous static sparking, explosion, or fire when spraying or flushing the lines.

With regard to Air-assisted airless spray, the air-assisted airless sprayer was developed to combine some of the advantages of an airless sprayer (e.g., increased production, ability to reach into recesses and cavities without blow-back) and the advantages of a conventional sprayer (finer atomization). An air-assisted airless spray system consists of a spray gun, pump, hoses, and clean, compressed air of adequate pressure and volume. An air-assisted airless sprayer may be used with small containers or with 207.9-liter (55-gallon) drums using a submersible pump. Basically, an air-assisted airless spray gun combines the features found with both air and airless spray guns. A special fluid nozzle tip similar to that used with the atomization principle of the airless sprayer initiates atomization. Atomization is completed with the introduction of compressed air through the horns and face of an air cap (similar to a conventional spray air cap) that surrounds the airless tip. Without the compressed air, a coarsely atomized and poorly defined pattern would result. The compressed air emitted from the air cap provides a finely atomized coating, which approaches the quality of conventional spray atomization. Therefore, an air-assisted airless sprayer is ideally suited for fillers, glazes, lacquers, and polyurethanes. Medium to heavy consistency coatings require atomizing air pressure close to 68.9 kPa (10 psi). Light consistency coatings only require a few pounds per square inch of air pressure. Equipment maintenance and safety considerations are similar to those for standard airless and conventional spray equipment.

Perhaps the most complex of all spray application methods is plural component spraying. Basically, plural component spray mixes the individual components through careful metering at the spray gun or at the spray tip rather than premixing in the pressure pot. Plural component spray is commonly used for 100 percent solids coating materials and coating materials with limited potlife (such as epoxies).

A plural component spray setup consists of six basic components: proportioning pump, mix manifold, mixer, spray gun, material supply containers, and solvent purge (flush) container. Plural component spray can be sprayed by conventional spray, airless spray, or air-assisted airless spray. The spray gun can be identical to those used with conventional sprayers, airless sprayers, or electrostatic sprayers. However, if the components are mixed at the gun, a special spray gun is required.

Three systems are used to spray polyester materials, including a side catalyst injector system, an air injection system, and a split batch or double nozzle spray system. The side catalyst injector system mixes the polyester components externally in front of the spray gun. With an air injection system, a measured quantity of catalyst is injected into the atomizing air supply. The split batch or double nozzle spray gun system involves two quantities of equal volumes of premixed resin. The two quantities, in equal volumes, are delivered separately to the spray gun and are atomized in such a way that the individual quantities are intimately intermixed either externally or internally.

Some types of plural component coating materials or adhesives that can be sprayed include polyesters, polyurethanes, vinyl esters, and epoxies. These materials may be mixed in varying ratios and viscosities.

The application technique associated with plural component sprayers essentially is no different than that of conventional air or airless sprayers. However, the prespray procedures require a certain level of expertise in ensuring proper mixing of the individual components and equipment maintenance.

Unlike conventional or airless sprayers, plural component sprayers combine separate fluids that are either mixed internally immediately preceding exit from the gun or externally; therefore, plural component spraying is the ideal system to use with coatings that have a short pot life (i.e., 30 minutes).

A plural component spray setup uses complicated equipment compared to that used in conventional or airless sprayers. Because of the knowledge necessary to successfully apply coatings using plural component sprayers, a more experienced applicator generally is required.

Whenever the equipment is stored, even for a short period of time, it must be cleaned thoroughly; different procedures may be required for overnight versus weekend storage. The system must be kept “wet” (filled with solvent) at all times to prevent the remaining material from setting up when it is exposed to the atmosphere. A solvent that is compatible with the resin materials should be used.

With regard to electrostatic spray, there are several types of electrostatic spray systems, although the typical system involves hand-operated, electrostatic spray guns using air atomization, airless atomization, or air-assisted airless atomization. The equipment used to atomize the coating is similar to that of conventional, airless, or air-assisted spray setups; however, an electrostatic, high voltage supply also is used.

Portable electrostatic spray units are used for coating applications to odd-shaped metal objects, such as wire fencing, angles, channels, cables, and piping. Electrostatic spray units impart an electrostatic charge to the coating, which causes the material to be attracted to a properly grounded object. The charged coating particles travel to the closest grounded object. The particles that miss the target wrap around to coat the opposite side of the target. Particles that strike the product and rebound are retracted to the surface.

Virtually any atomized fluid is capable of accepting an electrostatic charge. Careful consideration must be given to the type of electrostatic system being used. Each system demands paint formulation consideration acceptable to the process being used. Polar solvents (conductive) are required to improve the degree of atomization.

The advantages to using electrostatic spray include: this method of coating application reduces coating material loss as it utilizes overspray by rebound; it reduces cleanup and maintenance time, increases production rates, and reduces the number of application steps caused by wraparound; and it results in improved atomization.

The uniformity of coverage will vary depending on the size and contour of the object. Because of the electric field, the exterior corners of items being coated often receive a heavier coating; the interior corners are difficult to coat. Also, coating materials may require special formulation, such as adding special solvents to the coating, to enable it to accept the charge. The item(s) to be sprayed must be grounded at all times. Electrostatic spray guns are limited to the amount of fluid they can efficiently charge in a given period of time. Observing safe operating procedures is extremely important because of spark potential.

In certain embodiments, the layer of coating undergoes film formation (“curing,” “cure”), which is the physical and/or chemical change of a coating to a solid that is a preferred solid when in the form of a layer upon the surface. In certain aspects, a coating may be prepared, applied and cured at an ambient condition, a baking condition, or a combination thereof. An ambient condition is a temperature range between −10° C. to 40° C., including all intermediate ranges and combinations thereof. As used herein, a “baking condition” or “baking” is contacting a coating with a temperature above 40° C. and/or raising the temperature of a coating above 40° C., typically to promote film formation. Examples of baking the coating include contacting a coating and/or raising the temperature of coating to 40° C. to 300° C., or more, including all intermediate ranges and combinations thereof. Various coatings described herein or as would be known to one of ordinary skill in the art may be applied and/or cured at ambient conditions, baking conditions, or a combination thereof.

It is contemplated that in general embodiments, a coating comprising a microorganism based particulate material of the present invention may be prepared, applied and cured at any temperature range described herein or would be known to one of ordinary skill in the art in light of the present disclosures. An example of such a temperature range is −100° C. to 300° C., or more, including all intermediate ranges and combinations thereof. However, a microorganism based particulate material may further comprise a desired biomolecule (e.g., a colorant, an enzyme), whether endogenously or recombinantly produced, that may have a reduced tolerance to temperature. It is contemplated that the preferred temperature that can be tolerated by a biomolecule will vary depending on the specific biomolecule used in a coating, and will generally be within the range of temperatures tolerated by the living organism from which the biomolecule was derived. For example, it is preferred for a coating comprising a microorganism based particulate material of the present invention, wherein the microorganism based material comprises an desired enzyme, that the coating is prepared, applied and cured at −100° C. to 110° C., including all intermediate ranges and combinations thereof. For example, it is contemplated that a temperature of 100° C. to 40° C. including all intermediate ranges and combinations thereof, will be suitable for many enzymes (e.g., a wild-type sequence and/or a functional equivalent) derived from an eukaryote, while temperatures up to, for example −100° C. to 50° C. including all intermediate ranges and combinations thereof, may be tolerated by enzymes derived from many prokaryotes.

Preferred coating application methods include but are not limited to: brushing, rolling, spraying, misting, sponging, smearing, pouring, rubbing, fogging, dipping, and combinations thereof. A particularly preferred coating application method is spraying, including conventional spraying, airless spraying, and electrostatic spraying.

Those of skill in the art will recognize that the coating application method will be influenced by the type of coating to be applied and the surface that the coating is being applied to. Additionally, the consistency of some coatings may dictate a particular method. For example, coatings that are excessively viscous may not permit effective application by spray; or a low viscous coating may only be effectively applied by spray.

A facet of the present invention is a surface coated with a layer of bioactive coating. It is contemplated that any surface that is capable of being coated with a coating that is suitable for use in the present invention is capable of being coated with a bioactive coating and thus be a bioactive surface. For example, the exteriors, or a portion thereof, of buildings, vehicles, machinery, structures, and other objects may be coated with a bioactive coating to create a bioactive surface. Similarly, the interiors of buildings, vehicles, machinery, structures, vessels, and bodies may also be coated with a bioactive coating to produce a bioactive surface.

In preferred embodiments of the present invention, the interior, or some portion thereof, of vessels and associated structures used to handle and process fluids (e.g., chemical reactors, tubing, piping, ducting) are coated with a bioactive coating to create a bioactive surface within the vessel or structure. Preferred vessels are chemical reactors, pipes, tubing, hoses, tanks, ponds, pools, pumps, columns, and towers. In other preferred embodiments, the bioactive coating is applied to a support component. Particularly preferred are those support components that are capable of being disposed within chemical reactors, pipes, tubing, hoses, tanks, ponds, pools, pumps, columns, and towers.

The coated bioactive surface may be a portion of the interior of the reactor, for example, at least a portion of the reactor wall. Alternately, the coated bioactive surface may be at least a portion of a support component that is separate from the reactor, but is disposed within the reactor. Such a coated support is referred to herein as a bioactive support component.

The bioactive support component of the present invention may take the form of any device, body, or structure that is known in the art for providing a surface or increasing available surface area for promoting chemical reactions, improving mass transfer operations, improving heat transfer operations, or improving separation operations. For example, in a preferred embodiment the support component comprises at least one type of any packing material known in the art of separations, particularly distillation and demisting. Suitable packing materials include dumped packing, structured packing, and combinations thereof.

Dumped packing includes but is not limited to rings, saddles, beads, blocks, spheres, discs, tubes, rods, and all forms of random dumped packing known in the art. Particularly preferred dumped packing types are Rachig rings, Pall rings, and saddles.

Structured packing includes all structured packing known in the art including, but not limited to: mesh, screens, plates, vanes, ribs, fins, tubes, trays, sheets, pads, knitted materials, woven materials, and combinations thereof. A preferred structured packing material is mesh. Particularly preferred is a woven mesh.

The materials of construction for the support component may be any material that is capable of being coated with a bioactive coating of the present invention and that is compatible with the chemicals that the bioactive support will be exposed to. For example, the support component, when coated, should be solubly resistant to the fluids that the support component will be exposed to. Preferred support materials are metals, glass, wood, rubbers, plastics, and ceramics. Particularly preferred as a support component is stainless steel woven mesh. (Tex-Mesh by Amistco, 23147 Highway 6 Alvin, Tex. 77512; (281) 331-5956; amistco(amistco.com).

Singular or multiple layers of one or more bioactive coatings may be applied to the support component by any of the coating application methods known in the art.

It is contemplated as part of the present invention that bioactive surfaces may be created within chemical reactors and other vessels and structures associated with the handling and processing of fluids. As used herein fluids means both gases and liquids.

It is contemplated that any of the reactor designs known to those of skill in the art for the handling and treatment of fluids may be used as part of the present invention.

Contemplated reactor designs are semicontinuous reactors (i.e., batch reactors) and continuous reactors. Preferred reactors include stirred tank reactors, tube reactors, fixed bed reactors, and fluidized bed reactors. Also preferred are tubing, piping, ducting, and hoses used for the handling of fluids.

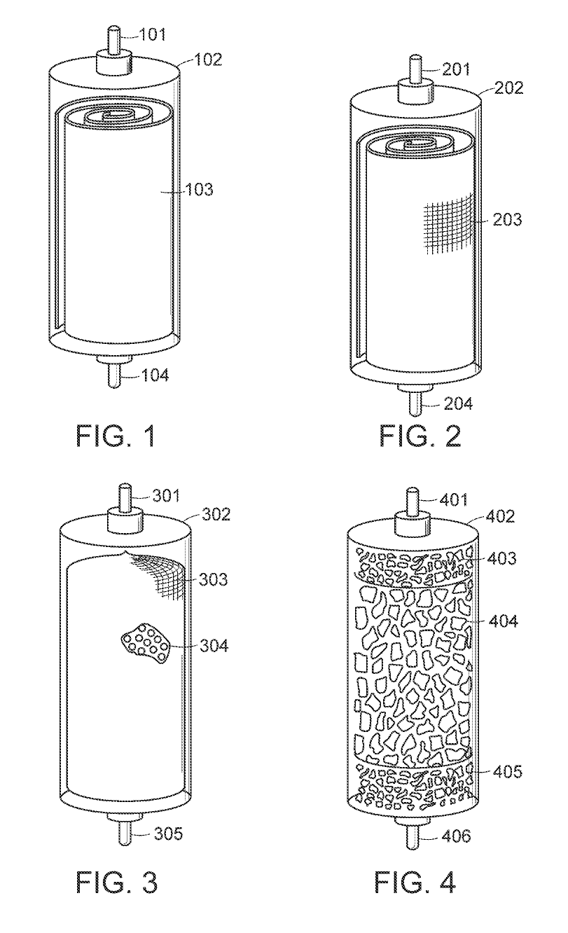

The present invention will be better understood by those skilled in the art by reference to FIG. 1-4 as illustrations. Refering to FIG. 1, a reactor for detoxifying a fluid stream containing an organophosphorus agent comprises a bioactive surface provided by a bioactive support that is disposed within the reactor. As shown the reactor (102) takes the form of a simple column having an inlet (101) and an outlet (102) for the fluid that is to be treated. The bioactive support component (103) takes the form of a simple solid, flexible, sheet that has been coated with a bioactive coating. The fluid is allowed to enter the reactor and contact the bioactive support. Contact with the boactive support initiates the hydrolysis (i.e., the detoxification) of any OP compounds that are present in the fluid stream. The residence time of the fluid within the reactor may be adjusted by altering the flowrate of the fluid through the reactor. One method of adjusting the fluid flowrate is by controlling the size of the outlet. The length of residence time will be dictated by the extent to which the hydrolysis of the OP agent is desired. It will be recognized by those of skill in the art that the fluid being treated may be recycled through the column if necessary to provide for additional detoxification of the fluid.

Refering to FIG. 2, the reactor (202) takes the form of a column having an inlet (201) and outlet (204). Disposed within the reactor is an alternate embodiment of a bioactive support component (203). Instead of a solid sheet, the support component is a bioactive coated mesh.

Refering to FIG. 3, the reactor (302) takes the form of a column having an inlet (301) and an outlet (305), disposed within the reactor is a multiplicity of spherical bioactive coated support components (304). As shown the bioactive support components are contained within a mesh container (303) for easy removal all at once from the reactor and to prevent clogging of the reactor outlet. While the shape of the support components are shown as coated spheres, it is contemplated that the support components could be of any shape and size that is suitable to be disposed within the reactor. Also, the support components need not be contained as shown, but instead may be disposed freely within the reactor.

Refering to FIG. 4, the reactor (402) takes the form of a column with an inlet (401) and an outlet (406). Disposed within the reactor are three separate layers; first layer (403), second layer (404), and third layer (405); of bioactive support components. As shown, the bioactive support components of each layer are random and irregular in shape. It is comtemplated that multiple layers of bioactive support components, each having differing properties may be used so that multiple OP compounds within a fluid stream may by detoxified at the same time.

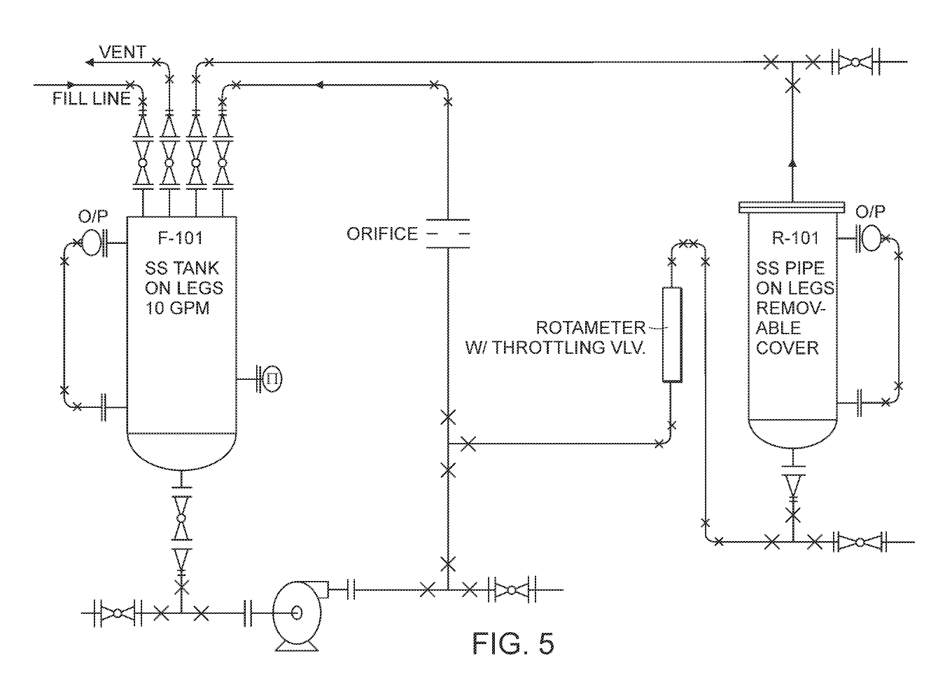

FIG. 5 is a schematic of a contemplated pilot scale batch reactor system; wherein the system is capable of delivering controlled flows of fluid from a holding tank to an attached reactor column. The system (599) provides for fluid to be introduced via a fill line (501) into fill tank (502). The fluid flow is regulated by control valve (503). The fill tank has a recirculation line (504) that includes an observation point (505) for monitoring the progress of the fluid treatment by a colormetric indicator. Fluid drains from the fill tank to pump (506). The pump returns fluid to the fill tank by line (507). A portion of the pumped fluid moves though line (507) and into rotometer (508). The rotometer can be used to precisely control the amount of fluid that is sent to reactor (509). The contemplated reactor design is a column inside which at least one bioactive coated support componet will be disposed. The reactor also has a recirculation line that includes an observation point for monitoring the progress of the fluid treatment process. Treated fluid from the reactor is sent back to the fill tank via line (510). If needed, any gases that build up in the system can be vented from the fill tank via vent line (511). Numerous sample points (520), (530), (540) and (550) are attached to the system and allow for collection of the fluid for analysis or disposal at different points in the system.

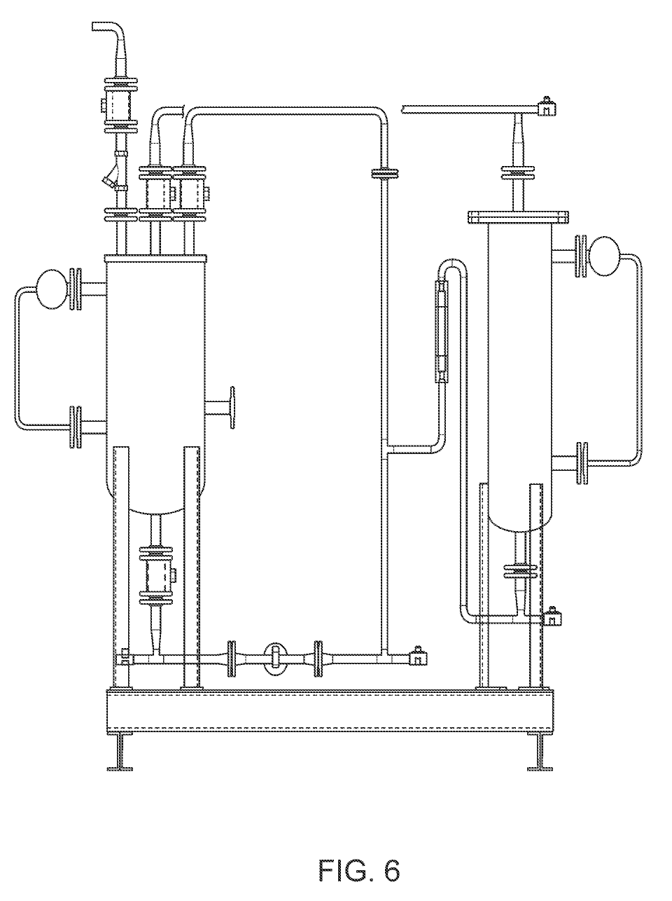

FIG. 6 is a detailed drawing of the pilot scale batch reactor system of FIG.5; wherein the system is capable of delivering controlled flows of fluid from a holding tank to an attached reactor;

The bioactive coated support component may take any form known in the art that is used to increase surface area within a reactor to provide for an improved chemical reaction, mass transfer, or separation process. It is expected that one of skill in the art will recognize that the reactor designs disclosed herein may be modified to operate on a continuous basis and include other unit operations associated with the treatment of fluids. Also, it is expected that one of skill in the art will recognize that the reactor systems and other fluid handling and treatment systems disclosed herein can be scaled-up to handle fluid treatment on an industrial scale.

It has been demonstrated that OP compounds including CWAs hydrolyze (i.e., detoxify) when brought in contact with a bioactive surface of the present invention in the presence of water. It has been demonstrated that both undiluted and diluted organophosphorus compounds may be detoxified in accordance with the present invention.

### EXAMPLE 1

### Preparation of Enzyme Composition Powder (i.e., Powdered Cells expressing the OPd Gene)

The following example describes a preferred procedure for the preparation of an enzyme composition powder for detoxifying an organophosphorous compound, Paraoxon, using DH5 alpha Escherichia coli expressing a mutant opd gene.

Cell Growth

Four (4) fernbach flasks with 1 L of Terrific Broth (“TB”) per flask are prepared and autoclaved to sterilization.

Four (4) culture tubes each are prepared containing 5 ml of LB broth (“LB”) and 5 μl of ampicillin. The culture tubes containing the LB and ampicillin are inoculated with DH5 alpha Escherichia coli cells expressing a mutant opd gene. The inoculated culture tubes tubes are placed in either a roller drum or tube rack to agitate overnight at 37° C.

1 ml of CoCl₂ and 1 ml of ampicillin is added to each fernbach flask. Each fernbach flask is inoculated with the contants of one (1) of the culture tubes that was agitated overnight. The four inoculated ferbach flasks are placed in a shaking incubator heated to 30° C. and set at 4 rpm. The inoculated ferbach flasks are shaken for twelve (12) to fifteen (15) hours. After the twelve (12) to fifteen (15) hours, one milliliter (1 ml) of ampicillin is added to each fernbach flask. The fernbach cultures are spun down after they have been allowed to shake for approximately forty (40) more hours. Growth to saturation has been achieved.

Cell Concentration

After growth to saturation, the cells are concentrated by cetrifugation. A preferred method uses a centrifuge with a swinginging bucket rotor where the cells are concentrated by centrifugation at 7000 rotations per minute (“rpm”) for 10 minutes for example. Alternately, lower rotation rates for a longer time period may be used (e.g., 4000-4500 rpm for 20 minutes). The cells are rinsed clean of any residual media by resuspension in distilled water (1 mL per gram of cells is adequate). Cells are again separated by centrifigation. Multiple rinses may be performed. A cell pellet has been obtained.

Cell Powder Formation

A powder is formed from the concentrated cells (e.g., cell pellet). Alternate methods of cell powder formation are contemplated by the present invention. A first preferred method is to desiccate the cells by resuspension in a volatile organic compound solvent followed by grinding. A second preferred method is to lyophelize (i.e., freeze-dry) the cells. Both methods are described below.

VOC Method

The cell pellet obtained after centrifigation is resuspended in a volatile organic solvent (e.g., acetone) one or multiple times to desiccate the cells and to remove a substantial portion of the water contained in the cell pellet. The pellet may then be ground or milled to a powder form. The obtained powder may be stored frozen or at ambient conditions for future use, or may be added immediately to a coating formulation. When frozen storage is contemplated, the obtained powder may optionally be combined with a cryoprotectant (e.g., cryopreservative).

Lyophelization (Freeze-drying) Method

Alternately, a powder may be formed from the obtained cell pellet by freeze-drying. A preferred method using a commercially available freeze-drying system is as follows.

The concentrated cells are resuspended in I mL of distilled water for every 2 grams of cells. One or more freeze-fast flasks are filled to no more than 20% full with the cell mixture and the open lid of the freeze-fast flask is completely sealed (e.g., tightly rapped paraffin).

A dry ice bath is prepared by mixing crushed dry ice and ethanol in a container large enough to hold the flasks that contain the cell mixture (e.g., metal pan). The dry ice bath is ready for use when it has reached a temperature below freezing.

Each cell-containing flask is laid in the dry ice bath so that the maximum amount of lateral surface area is in contact with the ethanol, while keeping the covered opening just above the ethanol. Each cell-containing flask is rotated at a constant rate to apply a thin and even layer of frozen cells to its inner surface. Rotation is continued until no liquid remains in the flask. Each cell-containing flask is removed from the dry ice bath and its cover is removed.

The freeze-drying system is prepared for use according to its operating instructions. The freeze dry system is allowed to reach a temperature of at least −50 degrees Celsius and a vacuum between 5-50 microns Hg. While preparing the freeze dry system, each cell containing flask is stored in a freezer (−70 to −80°). Once the freeze-dry system has reached the desired temperature and vacuum, the cell-containing flasks are transferred from the freezer and attached to the freeze-drying system. Drying is performed until complete sublimation of the water from the cells is achieved. Drying times may vary, but complete sublimation of water from the cells is indicated when the cells lighten in color and become white to off-white.

The obtained powder may be stored frozen or at ambient conditions for future use, or may be added immediately to a coating formulation. When frozen storage is contemplated, the obtained powder may optionally be combined with a cryoprotectant (e.g., cryopreservative).

### EXAMPLE 2a

### Preparation of a Bioactive Coating

The following demonstrates a first preferred method for preparing a bioactive coating. Cell powder was prepared by lyophilization as described in Example 1. 10.56 grams of the cell powder so produced was then added to 40 mL of a 60% glycerol solution (60% v/v in distilled, deionized water). The glycerol solution plus cell powder was then added to 400 mL of latex acrylic paint (Sherwin-Williams Acrylic Latex paint, S-W serial # B66 W1 136-1500) and mixed thoroughly. The result is a bioactive latex acrylic coating capable of detoxifying organophosphorus compounds. The bioactive coating has a cell powder concentration of 26.4 g of cell powder per liter of latex acrylic paint coating. The cell powder concentration in this case may also be expressed as 24.0 g of cell powder per liter of total coating composition (i.e., the combined volume of latex acrylic coating and glycerol solution.

### EXAMPLE 2b

### Preparation of a Bioactive Coating

The following describes an alternate preferred preparation of a bioactive coating derived from a commercially available latex paint. 3 mg of cell powder was obtained by the volatile organic suspension and milling method (VOC method) described in Example 1. The milled powder was added to 3 ml of 50% glycerol (50% v/v with distilled deionized water). The cell powder and glycerol suspension was then added to 100 ml of Olympic® premium interior flat latex paint (Olympic®, One PPG Place, Pittsburg, Pa. 15272 USA) and mixed thoroughly. The resulting bioactive coating has a cell powder concentration of 0.03 g of cell powder per liter of latex paint coating. The cell powder concentration in this case may also be expressed as 0.029 g of cell powder per liter of total coating composition (i.e., the combined volume of latex coating and glycerol solution.)

### EXAMPLE 3

### Preparation of a Bioactive Support Component

A preferred embodiement of a bioactive support component was constructed as follows. All spray coating was accomplished with a hand sized airless power paint sprayer designed for home use available from a typical hardware store (e.g., Lowe's, Home Depot, Ace.)

A bioactive coating was prepared according to Example 2.a. A sheet of stainless steel 304 mesh (Tex-Mesh™, Amistco) was prepared by first spray coating with a single coat of rust resistant primer. The primer was allowed to air dry. The mesh was then completely spray coated with a single coat of the bioactive coating prepared according to example 2.a. The coating was allowed to air dry. The mesh was then rolled into a compact bundle having an approximate diameter of two (2) inches.

### EXAMPLE 4

### Reactive Column

A single pass gravity flow reactor column, similar to that shown in FIG. 2, has been constructed. The constructed column however has an open top instead of the inlet shown in said figure. The column is designed to contain a bioactive support component prepared as in example 3. The specifications for the reactive column are as follows:
Total Column Volume—640 mL
Internal diameter—2 inches
Material of construction: Glass
The outlet of the column is controlled by a Teflon stopcock
The volume of the coated bioactive support component is 95 mL
The void space of the column when the coated support component is in place is 545 mL.

Because the column operates on gravity flow, the head pressure of the column varies with the amount of fluid in the column. Therefore, the flowrate through the column is faster when the column is more full and begins to slow down as the column empties. The average maximum flowrate for 1000 mL of aqueous fluid (distilled deionized water) through the column, with the support component present was approximately 225 mL per minute.

### EXAMPLE 5

### Treatment of a Fluid Stream Contaminated with Organophosphorus Compound

A fluid stream contaminated with the OP compound Paraoxon was detoxified using the reactive column of Example 4 according to the following method.

1000 mL of “Milli-Q” water (distilled, deionized water that has been additionally filtered through a Milli-Q water treatment system; Millpore, Inc.) was contaminated with 100 mg of Paraoxon. The resulting concentration of the Paraoxon in the water was 100 ppm Paraoxon.

The detoxification of the fluid stream was monitored visually and by specrctral analysis with a spectrophotometer. The hydrolysate products of Paraoxon, a common pesticicde, are para-nitrophenol and diethyl phosphate. The para-nitrophenol is produced in a one to one ratio as the Paraoxon is degraded. The para-nitrophenol is yellow in color provided a visual indicator of the enzymatic activity of the bioactive coating. It should be noted that the coated bioactive component in this experiment is white in color because the boactive coating used a white latex acrylic paint.

Absorbance of a sample of the initial contaminated solution (100 ppm paraoxon) prior to any treatment was recorded.

The contaminated water was poured into the reactive column of Example 4 and allowed to drain freely. As explained above, because the column is gravity fed, the flow rate varies with the head pressure. An approximate maximum flowrate of 225 mL/min was achieved. The total length of time for the column to completely drain was approximately twenty minutes, yielding an average flowrate through the column of 50 mL/min.

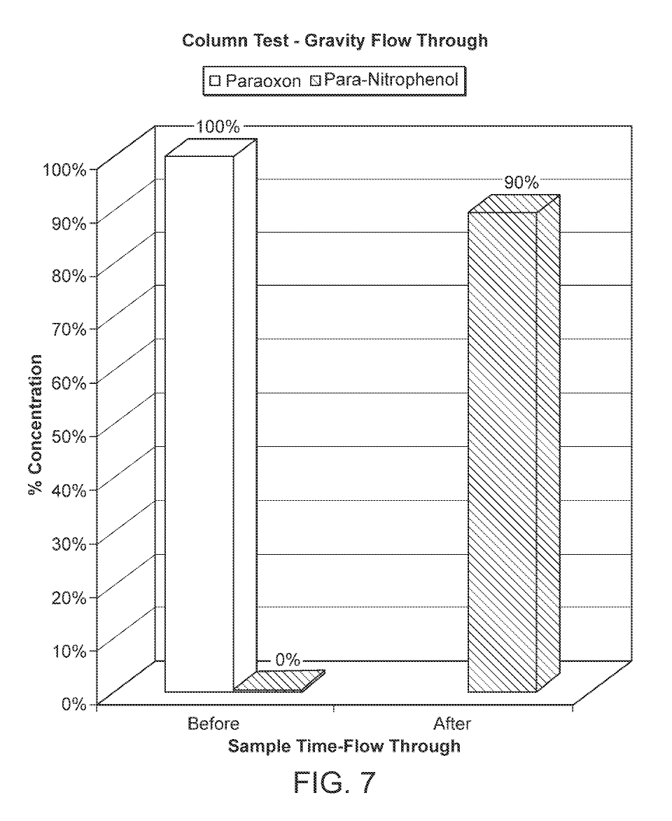

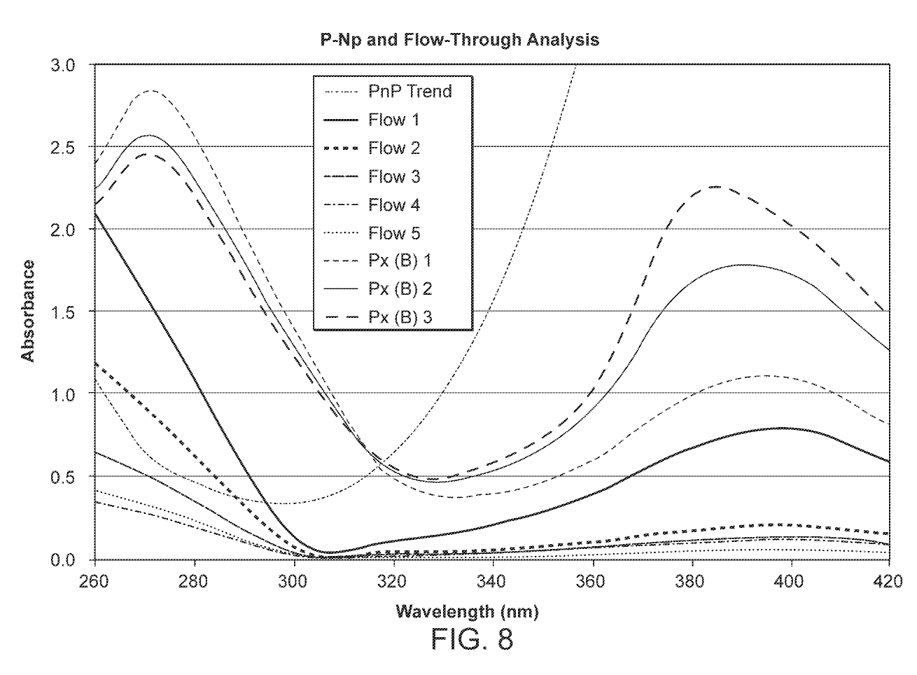

The 100 ppm paraoxon contaminated water was completely clear prior to being introduced through the reactive column. Almost immediately upon contact with the coated bioactive support component, a yellow color was detected by visual inspection. The effluent was yellow in color and was collected in a beaker directly from the column. Periodically during the experiment samples of the effluent were collected and absorbance was measured. When the fluid had completely passed through the column a final sample was taken and the absorbance measured. The results are shown in Tables Y-Z and in FIG. 7.

TABLE Y

Experimental
Concentrations
(mM)

| | [Paraoxon] | [P-Nitrophenol] |
|---|---|---|
| Start | 100% | 0% |
| Finish | 63% | 90% |
| Start | 87% | 0% |
| 4 minutes | 83% | 67% |
| 10 minutes | 60% | 91% |
| 17 minutes | 66% | 96% |
| 17 minutes | 60% | 94% |

TABLE Z

Experimental
Concentrations
(mM)

| | [Paraoxon] | [P-Nitrophenol] |
|---|---|---|
| Start | 0.343 | 0.001 |
| Finish | 0.216 | 0.308 |
| Start | 0.300 | 0.000 |
| 4 minutes | 0.287 | 0.229 |
| 10 minutes | 0.207 | 0.313 |
| 17 minutes | 0.226 | 0.328 |
| 17 minutes | 0.207 | 0.322 |

As shown in FIG. 7, ninety percent (90%) of the Paraoxon present in the fluid was converted to para-nitrophenol on a single pass through the column.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure to aid in the understanding of one or more of the various inventive aspects. This method of disclosure, however, is not to be interpreted as reflecting an intention that the claimed invention requires more features than are expressly recited in each claim. Rather, as the following claims reflect, inventive aspects may lie in less than all features of a single foregoing disclosed embodiment. Thus, the claims following the detailed description are hereby expressly incorporated into this detailed description, with each claim standing on its own as a separate embodiment of this invention.

What is claimed is:

1. A reactor for detoxifying a fluid containing an organophosphorus compound comprising:
a surface coated with a bioactive coating that contacts the fluid.

2. A reactor for detoxifying a fluid containing an organophosphorus compound comprising:
a vessel capable of holding the fluid that has at least one surface for contacting the fluid, wherein at least a portion of the surface of the vessel for contacting the fluid is coated with a bioactive coating.

3. A reactor for detoxifying a fluid containing an organophosphorus agent comprising:
a vessel capable of a holding the fluid, and a bioactive support component, wherein the bioactive support component is disposed inside the vessel so that is contacts the fluid.

4. The reactor of claim 1, wherein the vessel is a column.

5. The reactor of claim 1, wherein the vessel is a packed bed reactor.

6. The reactor of claim 1, wherein the vessel is a fluidized bed reactor.

7. The reactor of claim 1, wherein the vessel is a tubular reactor.

8. The reactor of claim 1, wherein the vessel is a stirred tank reactor.

9. The reactor of claim 1, wherein the vessel is a batch reactor.

10. The reactor of claim 1, wherein the vessel is a continuous reactor.

11. The reactor of claim 2, wherein the vessel is a column.

12. The reactor of claim 2, wherein the vessel is a packed bed reactor.

13. The reactor of claim 2, wherein the vessel is a fluidized bed reactor.

14. The reactor of claim 2, wherein the vessel is a tubular reactor.

15. The reactor of claim 2, wherein the vessel is a stirred tank reactor.

16. The reactor of claim 2, wherein the vessel is a batch reactor.

17. The reactor of claim 2, wherein the vessel is a continuous reactor.

18. The reactor of claim 3, wherein the vessel is a column.

19. The reactor of claim 3, wherein the vessel is a packed bed reactor.

20. The reactor of claim 3, wherein the vessel is a fluidized bed reactor.

21. The reactor of claim 3, wherein the vessel is a tubular reactor.

22. The reactor of claim 3, wherein the vessel is a stirred tank reactor.

23. The reactor of claim 3, wherein the vessel is a batch reactor.

24. The reactor of claim 3, wherein the vessel is a continuous reactor.

25. A column for detoxifying a fluid stream containing an organophosphorus agent comprising:
a surface coated with a bioactive coating, wherein the surface that is coated is a portion of the interior of the column.

26. A bioactive support component for detoxifying a fluid stream containing an organophosphorus agent comprising:
a support component coated with a bioactive coating.

27. The bioactive support component of claim 26, wherein the bioactive support component is rigid, semi-rigid, or flexible.

28. The bioactive support component of claim 26, wherein the support component is selected from the group consisting of metal, wood, glass, or a polymer.

29. A column for detoxifying a fluid stream containing an organophosphorus agent comprising:
a surface coated with a bioactive coating, wherein the surface that is coated is a bioactive support component disposed inside the column.

30. A column for detoxifying a fluid stream containing an organophosphorus compound comprising:
a bioactive support component disposed inside the column, wherein the bioactive support component further comprises a support component coated with a bioactive coating.

31. The column of claim 29, wherein the bioactive support component is rigid, semi-rigid, or flexible.

32. The column of claim 29, wherein the support component is selected from the group consisting of metal, wood, glass, or a polymer.

33. A column for detoxifying a fluid stream containing an organophosphorus agent comprising:
a bioactive support component disposed within the column so that it can contact the fluid stream, wherein the bioactive support component further comprises a support component of stainless steel mesh coated with a bioactive coating comprised of a latex coating and OPH enzyme.

34. A method of detoxifying a fluid containing an organophosphorous compound comprising:
contacting the fluid with a bioactive coating.

35. The method of claim 34 wherein the bioactive coating comprises a phosphoric triester hydrolase.

36. The method of claim 34 wherein the organophosphorus compound is selected from the group consisting of chemical weapons agents, chemical weapons agent analogs, chemical weapons agent surrogates, and pesticides.

37. A method of treating a fluid stream containing an organophosphorous compound comprising the steps of:
a. applying a bioactive coating to a surface;
b. allowing the bioactive coating to cure, wherein this is an optional step; and
c. contacting the fluid stream with the bioactive coating surface for an amount of time sufficient for the organophosphorus compound to detoxify.

38. A method of treating a fluid stream containing an organophosphorous compound comprising the steps of:
a. applying a bioactive coating to a fluid contacting surface of a reactor;
b. curing the bioactive coating, wherein this is an optional step; and
c. contacting the fluid stream with the bioactive coated fluid contacting surface of a reactor for an amount of time sufficient for the organophosphorus compound to detoxify.

39. A method of preparing a bioactive support component for treating a fluid stream containing an organophosphorous compound comprising the steps of:
a. applying a bioactive coating to at least a portion of a support component; and
b. allowing the bioactive coating to cure, wherein this is an optional step.

40. A method of treating a fluid stream containing an organophosphorous compound comprising the steps of:
a. disposing a bioactive support component within a reactor; and
b. contacting the fluid stream with the bioactive support component for an amount of time sufficient for the organophosphorus compound to detoxify.

41. A method of treating a fluid stream containing an organophosphorous compound comprising the steps of:
a. preparing a bioactive support component;
b. disposing the bioactive support component within a reactor; and
c. contacting the fluid stream with the bioactive support component for an amount of time sufficient for the organophosphorus compound to detoxify.

42. A method of treating a fluid stream containing an organophosphorous compound comprising the steps of:
a. preparing a bioactive coating;
b. preparing a bioactive support;
c. disposing the bioactive support within a reactor;
d. contacting the fluid stream with the bioactive coated fluid contacting surface of the reactor for an amount of time sufficient for the organophosphorus compound to detoxify; and
e. collecting at least a portion of the detoxified fluid stream.
